(19) United States
(12) Patent Application Publication
(10) Pub. No.: US 2026/0017506 A1
(43) Pub. Date: Jan. 15, 2026

(54) Neural Processing Core for a Neural Network and Method of Operating Thereof

(71) Applicant: Agency for Science, Technology and Research, Singapore (SG)

(72) Inventors: Wenyu Jiang, Singapore (SG); Piew Yoong Chee, Singapore (SG); Rui Xiao, Singapore (SG)

(21) Appl. No.: 18/994,735

(22) PCT Filed: Jul. 14, 2023
(86) PCT No.: PCT/SG2023/050498

§ 371 Date: Jan. 15, 2025

(30) Foreign Application Priority Data
Jul. 15, 2022 (SG) 10202250490F

(51) Int. Cl. G06N 3/065

(52) U.S. Cl. CPC G06N 3/065

(57) ABSTRACT

A neural processing core for a neural network is provided, which includes: a synaptic memory array including synaptic memory cells arranged in a plurality of memory cell rows and columns; a plurality of first input activation lines connected to the plurality of memory cell rows, respectively, of the synaptic memory array and configured to receive a plurality of first input activation signals, respectively, to the plurality of memory cell rows; and a plurality of first sensing lines connected to the plurality of memory cell columns, respectively, of the synaptic memory array and configured to output a plurality of first analog electrical signals, respectively, from the plurality of memory cell columns. In particular, the neural processing core is configured to control the synaptic memory cells of the synaptic memory array in a column-wise manner. There is also provided a corresponding method of operating the neural processing core for a neural network.

### CROSS-REFERENCE TO RELATED APPLICATION

This application claims the benefit of priority of Singapore patent application Ser. No. 10/202250490F, filed on 15 Jul. 2022, the content of which being hereby incorporated by reference in its entirety for all purposes.

### TECHNICAL FIELD

The present invention generally relates to a neural processing core for a neural network and a method of operating the neural processing core for a neural network.

### BACKGROUND

Deep Neural Networks (DNNs) have seen huge growths in commercial adoption, and with the ever-increasing complexity of DNNs, there have also been active researchers on using customized hardware (in particular, those based on memristive analog computing) to improve the power and energy efficiency requirement in applications such as edge intelligence.

Typically, a building block of a memristive analog computing hardware is a 1T1R array, where each cell comprises an access transistor (i.e., each cell has one access Transistor, hence the abbreviation “1T”) (which may also interchangeably be referred to as a select transistor) and a memristor (e.g., RRAM, PCRAM, and so on) which is in essence a programmable resistor (i.e., each cell has one memristor or programmable Resistor, hence the abbreviation “1R”). Therefore, a synaptic memory array whereby each synaptic memory cell has one access transistor and one memristor (i.e., no further access transistor or memristor in the memory cell) may be referred to as a 1T1R array, and such a memory cell may be referred to as a 1T1R cell. FIG. 1 depicts a schematic drawing of a conventional 1T1R array with an example 2×2 configuration/architecture. As shown in FIG. 1, each word-line (WLᵢ) controls the gate of each 1T1R cell in the same row (i.e., row-wise), and the bit-line (or the input activation line) of each 1T1R cell on a same row is fed by the same voltage (Actᵢ) (i.e., row-wise) which corresponds to the input activation in a DNN. In this regard, since the memristor's conductance behaves like a synaptic weight, then according to Kirchhoff's law, the combined bit-line current of each column that flows through the Source Line (SLᵢ) would correspond to the weighted sum of the corresponding neuron. In this regard, each column corresponds to a neuron. Accordingly, this arrangement of the synaptic memory array may correspond to a matrix in a layer of a neural network, and implements a cross-bar matrix in neural network hardware implementation.

A 2T2R array is another building block of a memristive analog computing hardware, where each cell comprises two access Transistors (i.e., each cell has two access Transistors, hence the abbreviation “2T”) and two memristors (i.e., each cell has two memristors or programmable Resistors, hence the abbreviation “2R”). Therefore, a synaptic memory array whereby each synaptic memory cell has two access transistors and two memristors (i.e., no further access transistors or memristors in the memory cell) may be referred to as a 2T2R array, and such a memory cell may be referred to as a 2T2R cell. FIG. 2 depicts a schematic drawing of a conventional 2T2R array with an example 2×2 configuration/architecture. In this regard, the 2T2R cell may be configured to represent a signed weight. As shown in FIG. 2, each word-line (WLᵢ) controls the gates of the two transistors of each 2T2R cell in the same row (i.e., row-wise). The bit-line of each row comprises a positive part (a positive input activation line for receiving a positive input activation (Act_{i_p})) and a negative part (a negative input activation line for receiving a negative input activation (Act_{i_n})). If the source line (SLᵢ) is biased at a designated virtual ground voltage V_{ref}, (which may be V_{dd}/2 where V_{dd} is the transistor supply voltage), then for a neural network input activation xᵢ, a typical arrangement is that Act_{i_p}=V_{ref}+xᵢ and Act_{i_n}=V_{ref}−xᵢ, whereby xᵢ can be positive or negative, as long as Act_{i_p} and Act_{i_n} are within a feasible voltage range (which may be [0, V_{dd}]), or xᵢ can be scaled with a predetermined constant to ensure Act_{i_p} and Act_{i_n} are within the feasible voltage range. With such a configuration, the source line current of a 2T2R cell is equal to a differential of the positive current (I_{i,j_p}) and the negative current (I_{i,j_n}), which is further proportional to xᵢ×(Gₚₒₛ−G_{neg}), i.e., the product of xᵢ and the differential of conductance between positive weight memristor (Gₚₒₛ) and negative weight memristor (G_{neg}). Therefore, the 2T2R configuration/structure is able to natively support analog current subtraction and hence signed synaptic weight and signed input activation without dedicated current subtraction circuit. The 2T2R configuration also reduces the impact of IR drop on the source line (SLᵢ), as the source line only needs to carry the differential current which is much smaller.

Accordingly, the above-mentioned example conventional synaptic memory arrays (the conventional 1T1R or 2T2R array) are each able to compute all columns (neurons) thereof simultaneously by draining the currents on all columns simultaneously, which leads to a very high throughput. However, various embodiments of the present invention identified a number of drawbacks/problems associated with such conventional synaptic memory arrays. A first problem is that the peak power (due to the simultaneous draining of currents on all columns of the conventional synaptic memory array), although likely lower than pure-digital DNN hardware, is still significantly high. A second problem is that the simultaneous computing nature requires each column to have its dedicated peripheral sensing circuit, which usually includes a TIA (trans-impedance amplifier) (in the case of current mode sensing) and an ADC (analog-to-digital converter), both of which have a significant chip area or footprint. For example, the second problem may lead to a situation whereby the conventional synaptic memory array (e.g., conventional 1T1R or 2T2R array) may have a small footprint but the associated peripheral sensing circuits (e.g., per-column TIA and ADC) would have a significantly large footprint, leading to a huge chip (due to huge neural processing cores) yet with uncompetitive capacity. This is because most of the chip area would be occupied by peripheral sensing circuits, instead of the synaptic memory array providing memory storage capacity. In addition, various embodiments of the present invention note that edge intelligence applications usually do not demand very high computing throughput, and thus, it may be advantageous to provide a more compact (hence lower cost) neural processing core (which may form part of a DNN chip) that also has lower power and energy requirement.

A need therefore exists to provide a neural processing core for a neural network and a method of operating the neural processing core that seek to overcome, or at least ameliorate, one or more of deficiencies associated with conventional neural processing cores (e.g., having the above-mentioned example conventional synaptic memory arrays), and more particularly, a neural processing core that is compact or has minimized footprint (e.g., a smaller or reduced footprint or chip area) as well as being power and energy efficient. It is against this background that the present invention has been developed.

### SUMMARY

According to a first aspect of the present invention, there is provided a neural processing core for a neural network, the neural processing core comprising:
a synaptic memory array comprising synaptic memory cells arranged in a plurality of memory cell rows and columns;
a plurality of first input activation lines connected to the plurality of memory cell rows, respectively, of the synaptic memory array and configured to receive a plurality of first input activation signals, respectively, to the plurality of memory cell rows; and
a plurality of first sensing lines connected to the plurality of memory cell columns, respectively, of the synaptic memory array and configured to output a plurality of first analog electrical signals, respectively, from the plurality of memory cell columns,
wherein the neural processing core is configured to control the synaptic memory cells of the synaptic memory array in a column-wise manner.

According to a second aspect of the present invention, there is provided a method of operating a neural processing core (e.g., the neural processing core according to the above-mentioned first aspect of the present invention) for a neural network, the neural processing core comprising:
a synaptic memory array comprising synaptic memory cells arranged in a plurality of memory cell rows and columns;
a plurality of first input activation lines connected to the plurality of memory cell rows, respectively, of the synaptic memory array and configured to receive a plurality of first input activation signals, respectively, to the plurality of memory cell rows; and
a plurality of first sensing lines connected to the plurality of memory cell columns, respectively, of the synaptic memory array and configured to output a plurality of first analog electrical signals, respectively, from the plurality of memory cell columns, wherein
the neural processing core is configured to control the synaptic memory cells of the synaptic memory array in a column-wise manner, and
for each of the plurality of memory cell columns, the synaptic memory cells of the memory cell column are each connected to a control line associated with the memory cell column and the control line is configured to receive a column-wise control signal for the memory cell column for controlling the synaptic memory cells of the memory cell column in the column-wise manner, and
for performing inference on the synaptic memory array, the method comprises:
sending, for each of the plurality of memory cell columns and in turn, a column-wise control signal to the control line associated with the memory cell column for selecting the memory cell column for inference and controlling the synaptic memory cells of the memory cell column in the column-wise manner.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic drawing of a conventional 1T1R array with an example 2×2 architecture;

FIG. 2 depicts a schematic drawing of a conventional 2T2R array with an example 2×2 architecture;

FIG. 3 depicts a schematic drawing of a neural processing core for a neural network, according to various embodiments of the present invention;

FIG. 4 depicts a schematic diagram of a method of operating a neural processing core for a neural network, according to various embodiments of the present invention;

FIG. 5A depicts a schematic drawing of a neural network processor system, according to various embodiments of the present invention;

FIG. 5B depicts a schematic drawing of an example configuration/architecture of a neural processing core, according to various embodiments of the present invention;

FIG. 6 depicts a schematic block diagram of an exemplary computer system in which the neural network processor system, according to various embodiments of the present invention, may be implemented;

FIG. 7A depicts a schematic drawing of an example neural processing core (memristor-based) comprising a synaptic memory array having a 1T1R array architecture, according to various example embodiments of the present invention;

FIG. 7B depicts a schematic drawing of another example neural processing core (memristor-based) comprising a synaptic memory array also having a 1T1R array architecture, according to various example embodiments of the present invention;

FIG. 7C depicts a schematic drawing of an example neural processing core (flash memory-based) comprising a synaptic memory array having a 1T1R array architecture, according to various example embodiments of the present invention;

FIG. 7D depicts a schematic drawing of an example improved neural processing core (flash memory-based) over the example neural processing core shown in FIG. 7C, where an additional access or select transistor is added to each flash memory-based synaptic memory cell, so that synapse programming is more reliable, according to various example embodiments of the present invention;

FIG. 8A depicts a schematic drawing of an example neural processing core (memristor-based) comprising a synaptic memory array having a 2T2R array architecture, according to various example embodiments of the present invention;

FIG. 8B depicts a schematic drawing of an example neural processing core (flash memory-based) comprising a synaptic memory array having a 2T2R array architecture, according to various example embodiments of the present invention

FIG. 9A depicts a schematic drawing of an example neural processing core comprising the synaptic memory array having a 1T1R array architecture as shown in FIG. 7A and an example peripheral sensing circuit (current mode sensing), according to various example embodiments of the present invention;

FIG. 9B depicts a schematic drawing of another example neural processing core comprising the synaptic memory array having a 1T1R array architecture as shown in FIG. 7A and another example peripheral sensing circuit (current mode sensing), according to various example embodiments of the present invention;

FIG. 9C depicts a schematic drawing of an example neural processing core comprising the synaptic memory array having a 1T1R array architecture as shown in FIG. 7A and an example peripheral sensing circuit (voltage mode sensing), according to various example embodiments of the present invention;

FIG. 9D depicts a schematic drawing of another example neural processing core comprising the synaptic memory array having a 1T1R array architecture as shown in FIG. 7A and another example peripheral sensing circuit (voltage mode sensing), according to various example embodiments of the present invention;

FIG. 10 shows a Table (Table 1) showing energy and area estimation comparisons between conventional architectures and present architectures according to various example embodiments for a 256×256 array (1T1R/2T2R) with a 4-bit input;

FIG. 11 shows a Table (Table 2) showing the performance estimation for implementing VGG-16 with the present architecture (256×256 2T2R array and 8-bit ADCs), according to various example embodiments of the present invention;

FIG. 12 shows a Table (Table 3) showing comparisons between the present architecture according to various example embodiments and other conventional architectures;

FIG. 13 shows a Table (Table 4) showing the area, peak power, and latency for various configurations of the VGG-16, according to various example embodiments of the present invention;

FIGS. 14A and 14B depict plots showing trade-off between latency and area (FIG. 14A) and between latency and peak power (FIG. 14B) on the VGG-16, according to various example embodiments of the present invention;

FIG. 15 depicts a schematic drawing of an example neural processing core (current mode sensing) comprising a synaptic memory array having a 1TnR array architecture, according to various example embodiments of the present invention;

FIG. 16 depicts a schematic drawing of an example neural processing core (current mode sensing) comprising a synaptic memory array having the 2T2nR array architecture, according to various example embodiments of the present invention;

FIG. 17 depicts a schematic drawing of an example neural processing core (voltage mode sensing) comprising a synaptic memory array having a 1TnR array architecture, according to various example embodiments of the present invention; and

FIG. 18 depicts a schematic drawing of an example neural processing core (voltage mode sensing) comprising a synaptic memory array having the 2T2nR array architecture, according to various example embodiments of the present invention.

### DETAILED DESCRIPTION

Various embodiments of the present invention provide a neural processing core for a neural network and a method of operating the neural processing core for a neural network.

For example, as discussed in the background, various conventional neural processing cores with conventional synaptic memory arrays (e.g., conventional 1T1R or 2T2R array) suffer from a number of problems, such as but not limited to, significantly high peak power demand (e.g., due to the simultaneous draining of currents on all columns of the conventional synaptic memory array) and significantly large footprint or chip area (e.g., due to the large footprint of the peripheral sensing circuits required in such conventional neural processing cores). Accordingly, various embodiments provide a neural processing core for a neural network and a method of operating the neural processing core that seek to overcome, or at least ameliorate, one or more of deficiencies associated with such conventional neural processing cores, and more particularly, a neural processing core that is compact or has a minimized footprint (e.g., a smaller or reduced footprint or chip area) as well as being power and energy efficient.

FIG. 3 depicts a schematic drawing of a neural processing core 300 for a neural network, according to various embodiments of the present invention. The neural processing core 300 comprises: a synaptic memory array 302 comprising synaptic memory cells 304 arranged in a plurality of memory cell rows 306 and columns 308; a plurality of first input activation lines 316 connected to the plurality of memory cell rows 306, respectively, of the synaptic memory array 302 (e.g., input activation lines may also be referred to as bit-lines of the memory cell rows 306) and configured to receive a plurality of first input activation signals, respectively, to the plurality of memory cell rows 306; and a plurality of first sensing lines 318 connected to the plurality of memory cell columns 308, respectively, of the synaptic memory array 302 (e.g., sensing lines may also be referred to as source lines of the memory cell columns 308) and configured to output a plurality of first analog electrical signals (e.g., analog current signals (in the case of current mode sensing) or analog voltage signals (in the case of voltage mode sensing)), respectively, from the plurality of memory cell columns 308. In particular, the neural processing core 300 is configured to control the synaptic memory cells 304 of the synaptic memory array 302 in a column-wise manner (i.e., synaptic memory cells 304 of the same memory cell column 308 are controlled collectively or simultaneously, that is, on a per column basis).

In various embodiments, the neural processing core 300 further comprises a plurality of control lines 328 connected to the plurality of memory cell columns 308, respectively, of the synaptic memory array 302 (e.g., control lines may also be referred to as select lines of the memory cell columns 308). In this regard, for each of the plurality of memory cell columns 308, the synaptic memory cells 304 of the memory cell column 308 are each connected to the control line 328 of the plurality of control lines 328 associated with the memory cell column 308 and the control line 328 is configured to receive a column-wise control signal for the memory cell column 308 for controlling the synaptic memory cells 304 of the memory cell column 308 in the column-wise manner. Accordingly, the synaptic memory cells 304 of the same memory cell column 308 are controlled collectively or simultaneously by the column-wise control signal fed to the control line 328 associated with the memory cell column 308.

In various embodiments, a neural network layer (or part thereof) may be mapped onto the synaptic memory array 302, whereby each memory cell column 308 of the synaptic memory array 302 corresponds to a neuron of the neural network layer and a plurality of input activations (which may also be referred to as axon inputs) to the neuron may be applied on the plurality of memory cell rows 306, respectively, of the synaptic memory array 302. For example, each synaptic memory cell 304 may be a single-bit (1-bit) cell or a multi-bit cell (e.g., 2-bit cell, 3-bit cell, 4-bit cell, and so on) for representing or storing a synaptic weight for the hardware implementation of the neural network. For example, the neural processing core may also be referred to as a neuromorphic core, or simply as a neural core.

In various embodiments, the plurality of analog electrical signals, respectively, from the plurality of memory cell columns 308 may be a plurality of analog current signals (in the case of current mode sensing) or a plurality of analog voltage signals (in the case of voltage mode sensing). Accordingly, it will be appreciated by a person skilled in the art that the present invention is not limited to a specific type of sensing mode, and the neural processing core 300 may operate, or be configured to operate, in current mode sensing or voltage mode sensing as desired or as appropriate.

In various embodiments, the synaptic memory cell 304 may be memristor-based or flash memory-based. In this regard, it will be appreciated by a person skilled in the art that the present invention is not limited to a specific type of synaptic memory cell, and other types of synaptic memory cell may be employed as desired or as appropriate, as long as the conductance (i.e., conductance state) of the synaptic memory cell can be set accordingly to represent or store a synaptic weight (or a part thereof).

Accordingly, the neural processing core 300 for a neural network according to various embodiments of the present invention is advantageously compact or has minimized footprint as well as being power and energy efficient. In particular, by controlling the synaptic memory cells 304 of the memory cell column 308 in the column-wise manner, time-multiplexing for enabling the sharing of peripheral sensing circuit for processing analog electrical signals from the plurality of memory cell columns 308 of the synaptic memory array 302 can be implemented in a power and energy efficient manner. As a result, the neural processing core 300 for a neural network according to various embodiments of the present invention not only has a minimized or reduced footprint, but is also power and energy efficient. In other words, the neural processing core 300 for a neural network according to various embodiments of the present invention advantageously achieves both reduced footprint and improved power and energy efficiency at the same time. These advantages or technical effects, or other advantages or technical effects, will become more apparent to a person skilled in the art as the neural processing core 300 for a neural network and the method of operating the neural processing core 300 for a neural network are described in more details according to various embodiments and example embodiments of the present invention.

In various embodiments, each of the synaptic memory cells 304 of the synaptic memory array 302 comprises a first access transistor. In this regard, a gate of the first access transistor of the synaptic memory cell 304 is connected to the control line 328 associated with the memory cell column 308 which the synaptic memory cell 304 belongs to for receiving the column-wise control signal for the memory cell column 308 for controlling an operating state (e.g., on or off state) of the first access transistor of the synaptic memory cell 304. In various embodiments, the access transistor(s) of the synaptic memory cell 304 may have a single gate structure (e.g., in the case of the synaptic memory cell 304 being memristor-based) or a dual gate structure (e.g., in the case of the synaptic memory cell 304 being flash memory-based) comprising a control gate and a floating gate.

In various embodiments, for each of the plurality of memory cell rows 306, the synaptic memory cells 304 of the memory cell row 306 are each connected to the first input activation line 316 associated with the memory cell row 306 and the first input activation line 316 is configured to receive the first input activation signal for the synaptic memory cells 304 of the memory cell row 306 in a row-wise manner. In addition, for each of the plurality of memory cell columns 308, the synaptic memory cells 304 of the memory cell column 308 are each connected to the first sensing line 318 associated with the memory cell column 308. Furthermore, for each of the synaptic memory cells 304 of the synaptic memory array 302, the synaptic memory cell 304 further comprises a first memristor connected to and between the first access transistor of the synaptic memory cell 304 and the first sensing line 318 associated with the memory cell column 308 which the synaptic memory cell 304 belongs to or the first input activation line 316 associated with the memory cell row 306 which the synaptic memory cell 304 belongs to. That is, the first memristor may be connected to and between the first access transistor and the first sensing line 318 or may be connected to and between the first access transistor and the first input activation line 316. In various embodiments, each of the synaptic memory cells 304 of the synaptic memory array 302 has one access transistor and one memristor without additional or further access transistor and without additional or further memristor. Therefore, such a synaptic memory array 302 according to various embodiments may thus be referred to as a 1T1R array, and such a synaptic memory cell 304 may thus be referred to as a 1T1R cell. Accordingly, the synaptic memory cells 304 of the synaptic memory array 302 according to various embodiments are memristor-based.

In various embodiments, for each of the synaptic memory cells 304 of the synaptic memory array 302, the synaptic memory cell 304 further comprises one or more additional memristors resulting in each memory cell column of the plurality of memory cell columns comprising a first memristor column of the first memristors and one or more additional memristor columns of the additional memristors. For each memory cell column 308 of the plurality of memory cell columns 308, the first sensing line 318 associated with the memory cell column 308 is connected to the first memristor column of the memory cell column 308. In addition, the neural processing core 300 further comprises one or more additional sensing lines connected to the one or more additional memristor columns of the additional memristors, respectively, of the memory cell column 308 and configured to output one or more additional analog electrical signals, respectively, from the one or more additional memristor columns of the additional memristors. Furthermore, for each of the synaptic memory cells 304 of the synaptic memory array 302, the first memristor of the synaptic memory cell 304 is connected to and between the first access transistor of the synaptic memory cell 304 and the first sensing line 318 associated with the first memristor column of the memory cell column 308 which the first memristor belongs to, and the one or more additional memristors of the synaptic memory cell 304 are each connected to and between the first access transistor of the synaptic memory cell 304 and the additional sensing line associated with the additional memristor column which the additional memristor belongs to. In various embodiments, each of the synaptic memory cells 304 of the synaptic memory array 302 has one access transistor without additional or further access transistor and has multiple memristors (i.e., the above-mentioned first memristor and one or more additional memristors) configured in the manner as described above. Therefore, such a synaptic memory array 302 according to various embodiments may thus be referred to as a 1TnR array, and such a synaptic memory cell 304 may thus be referred to as a 1TnR cell, where ‘n’ denotes the number of memristors in the synaptic memory cell 304.

In various embodiments, the neural processing core 300 further comprises: a plurality of second input activation lines connected to the plurality of memory cell rows 306, respectively, of the synaptic memory array 302 and configured to receive a plurality of second input activation signals, respectively, to the plurality of memory cell rows 306. For each of the plurality of memory cell rows 306, the synaptic memory cells 304 of the memory cell row 306 are each connected to the second input activation line associated with the memory cell row 306. For each of the synaptic memory cells 304 of the synaptic memory array 302, the synaptic memory cell 304 further comprises a second access transistor and a second memristor. In this regard, the first memristor and the second memristor form a first pair of memristors of the synaptic memory cell 304. A gate of the second access transistor of the synaptic memory cell 304 is connected to the control line 328 associated with the memory cell column 308 which the synaptic memory cell 304 belongs to for receiving the column-wise control signal for the memory cell column 308 for controlling an operating state (e.g., on or off state) of the second access transistor. The first memristor of the synaptic memory cell 304 is connected to and between the first access transistor of the synaptic memory cell 304 and the first input activation line 316 associated with the memory cell row 306 which the synaptic memory cell 304 belongs to or the first sensing line 318 associated with the memory cell column 308 which the synaptic memory cell 304 belongs to. Corresponding to the first memristor, the second memristor of the synaptic memory cell 304 is connected to and between the second access transistor of the synaptic memory cell 304 and the second input activation line associated with the memory cell row 306 which the synaptic memory cell 304 belongs to or the first sensing line 318 associated with the memory cell column 308 which the synaptic memory cell 304 belongs to. In various embodiments, the first memristor of the synaptic memory cell 304 is connected to and between the first access transistor of the synaptic memory cell 304 and the first input activation line 316 associated with the memory cell row 306 which the synaptic memory cell 304 belongs to and the second memristor of the synaptic memory cell 304 is connected to and between the second access transistor of the synaptic memory cell 304 and the second input activation line associated with the memory cell row 306 which the synaptic memory cell 304 belongs to. In various embodiments, each of the synaptic memory cells 304 of the synaptic memory array 302 has two access transistors and two memristors without additional or further access transistor and without additional or further memristor. Therefore, such a synaptic memory array 302 according to various embodiments may thus be referred to as a 2T2R array, and such a synaptic memory cell 304 may thus be referred to as a 2T2R cell. In various embodiments, for each of the plurality of memory cell rows 306, the first and second input activation lines connected to the memory cell rows 306 may be a positive input activation line for receiving and feeding a positive input activation (e.g., will be 0 if the signed input activation is negative) and a negative input activation line for receiving and feeding a negative input activation (e.g., will be 0 if the signed input activation is positive). For example, such a synaptic memory cell (i.e., 2T2R cell) 304 may be configured or operated to represent or store a signed synaptic weight.

In various embodiments, the synaptic memory cells 304 of the above-mentioned 1T1R array may also be configured or operated to represent or store signed synaptic weights whereby each pair of memory cell rows 306 of the 1T1R array may be operated in the same or similar manner as a single memory cell row 306 of the 2T2R cell. For example, the first input activation line 316 associated with a first memory cell row of the pair of memory cell rows 306 may be a positive input activation line for receiving and feeding a positive input activation and the first input activation line 316 associated with a second memory cell row of the pair of memory cell rows 306 may be a negative input activation line for receiving and feeding a negative input activation, in a similar manner as the 2T2R array, for the synaptic memory cells 304 of the above-mentioned 1T1R array to represent or store signed synaptic weights.

In various embodiments, for each of the synaptic memory cells 304 of the synaptic memory array 302, the synaptic memory cell 304 further comprises one or more additional pairs of additional memristors, each additional pair of additional memristors comprising a first additional memristor and a second additional memristor, resulting in each memory cell column 308 of the plurality of memory cell columns 308 comprising a first memristor column of the first pair of memristors and one or more additional memristor columns of the additional pairs of additional memristors. For each memory cell column 308 of the plurality of memory cell columns 308, the first sensing line 318 associated with the memory cell column 308 is connected to the first memristor column of the first pair of memristors of the memory cell column 308. The neural processing core 300 further comprises one or more additional sensing lines connected to the one or more additional memristor columns of the additional pairs of additional memristors, respectively, of the memory cell column 308 and configured to output one or more additional analog electrical signals, respectively, from the one or more additional memristor columns of the additional pairs of additional memristors. For each of the synaptic memory cells 304 of the synaptic memory array 302, the first memristor of the first pair of memristors of the synaptic memory cell 304 is connected to and between the first access transistor of the synaptic memory cell 304 and the first sensing line 318 associated with the first memristor column which the first pair of memristors belongs to and the second memristor of the first pair of memristors of the synaptic memory cell 304 is connected to and between the second access transistor of the synaptic memory cell 304 and the first sensing line 318 associated with the first memristor column which the first pair of memristors belongs to. For each of the synaptic memory cells 304 of the synaptic memory array 302 and for each additional pair of additional memristors of the one or more additional pairs of additional memristors of the synaptic memory cell 304, the first additional memristor of the additional pair of additional memristors of the synaptic memory cell 304 is connected to and between the first access transistor of the synaptic memory cell 304 and the additional sensing line associated with the additional memristor column which the additional pair of additional memristors belongs to and the second additional memristor of the additional pair of additional memristors of the synaptic memory cell 304 is connected to and between the second access transistor of the synaptic memory cell 304 and the additional sensing line associated with the additional memristor column which the additional pair of additional memristors belongs to. In various embodiments, each of the synaptic memory cells 304 of the synaptic memory array 302 has two access transistors without additional or further access transistor and has multiple pairs of memristors (i.e., the above-mentioned first pair of memristors and one or more additional pairs of additional memristors) configured in the manner as described above. Therefore, such a synaptic memory array 302 according to various embodiments may thus be referred to as a 2T2nR array, and such a synaptic memory cell 304 may thus be referred to as a 2T2nR cell, where ‘n’ denotes the number of pairs of memristors in the synaptic memory cell 304.

In various embodiments, for each of the plurality of memory cell rows 306, the synaptic memory cells 304 of the memory cell row 306 are each connected to the first input activation line 316 associated with the memory cell row 306 and the first input activation line 316 is configured to receive the first input activation signal for the synaptic memory cells 304 of the memory cell row 306 in a row-wise manner. In addition, for each of the plurality of memory cell columns 308, the synaptic memory cells 304 of the memory cell column 308 are each connected to the first sensing line 318 associated with the memory cell column 308. Furthermore, for each of the synaptic memory cells 304 of the synaptic memory array 302, the above-mentioned gate of the first access transistor of the synaptic memory cell 304 connected to the control line 328 is a control gate and the first access transistor further comprises a floating gate, whereby a source of the first access transistor is connected to the first sensing line 318 associated with the memory cell column 308 which the synaptic memory cell 304 belongs to and a drain of the first access transistor is connected to the first input activation line 316 associated with the memory cell row 306 which the synaptic memory cell 304 belongs to. Accordingly, the synaptic memory cells 304 of the synaptic memory array 302 according to various embodiments are flash memory-based.

In various embodiments, the neural processing core further comprises a plurality of second input activation lines connected to the plurality of memory cell rows 306, respectively, of the synaptic memory array 302 and configured to receive a plurality of second input activation signals, respectively, to the plurality of memory cell rows 306. For each of the plurality of memory cell rows 306, the synaptic memory cells 304 of the memory cell row 306 are each connected to the second input activation line associated with the memory cell row 306. For each of the synaptic memory cells 304 of the synaptic memory array 302, the synaptic memory cell 304 further comprises a second access transistor comprising a control gate and a floating gate, whereby the control gate of the second access transistor is connected to the control line 328 associated with the memory cell column 308 which the synaptic memory cell 304 belongs to for receiving the column-wise control signal for the memory cell column 308 for controlling an operating state of the second access transistor, a source of the second access transistor is connected to the first sensing line 318 associated with the memory cell column 308 which the synaptic memory cell 304 belongs to and a drain of the second access transistor is connected to the second input activation line 316 associated with the memory cell row 306 which the synaptic memory cell 304 belongs to.

In various embodiments, the neural processing core 302 further comprises a peripheral sensing circuit (or a peripheral sensing module) connected to the plurality of first sensing lines 318 and configured to process the plurality of first analog electrical signals from the plurality of memory cell columns 308, respectively, based on time multiplexing. In various embodiments, the peripheral sensing circuit configured to process the plurality of first analog electrical signals based on time multiplexing comprises processing the plurality of first analog electrical signals from the plurality of memory cell columns 308, respectively, in turn (i.e., one column after another).

In various embodiments, the plurality of first analog electrical signals from the plurality of memory cell columns 308 are a plurality of first analog current signals and the peripheral sensing circuit comprises: a current-to-voltage converter configured to convert each of the plurality of first analog currents from the plurality of memory cell columns 308, in turn, to a first analog voltage signal; and an analog-to-digital converter (ADC) connected to the current-to-voltage converter and configured to digitize the first analog voltage signal received from the current-to-voltage converter. In this regard, the current-to-voltage converter and the ADC are each shared amongst the plurality of memory cell columns 308 for processing the plurality of first analog current signals from the plurality of memory cell columns 308, respectively. Note that instead of using a normal ADC which usually takes voltage as input, it may also be possible to use a current-mode ADC which takes current as input, e.g., by first clamping the sensing line to a pre-determined voltage such as ground, then mirroring the sensing line's current out (with scaling as necessary) for the current-mode ADC to output the digitized value of the current. However, the current-mode ADC sensing approach is often more power hungry than a normal ADC. Accordingly, unless explicitly stated or the context requires otherwise, the ADC referred to herein is assumed to be the normal ADC.

In various other embodiments, the plurality of first analog electrical signals from the plurality of memory cell columns 308 are a plurality of first analog current signals and the peripheral sensing circuit comprises: a plurality of current-to-voltage converters, each current-to-voltage converter configured to convert each first analog current from a corresponding group of memory cell columns 308 of the plurality of memory cell columns 308, in turn, to a first analog voltage signal associated with the corresponding group of memory cell columns 308; an analog multiplexer configured to select one output (analog voltage signal) amongst outputs of the plurality of current-to-voltage converters and forward the selected output (selected analog voltage signal); and an ADC connected to the analog multiplexer and configured to digitize the first analog voltage signal from the selected output by the analog multiplexer. In this regard, each of the plurality of current-to-voltage converters is shared amongst the corresponding group of memory cell columns 308 for processing the first analog current signals from the corresponding group of memory cell columns 308, and the ADC is shared amongst the plurality of memory cell columns 308.

In various embodiments, the neural processing core 300 is configured to control the current-to-voltage converter which produced the selected output to continue to operate past a column time-multiplexing cycle period based on the ADC taking longer than the column time-multiplexing cycle period to latch-in the first analog voltage signal from the selected output.

In various embodiments, the plurality of first analog electrical signals from the plurality of memory cell columns 308 are a plurality of first analog voltage signals and the peripheral sensing circuit comprises: an ADC configured to digitize each of the plurality of first analog voltage signals from the plurality of memory cell columns 308, in turn. In this regard, the ADC is shared amongst the plurality of memory cell columns 308 for processing the plurality of first analog voltage signals from the plurality of memory cell columns. In this regard, the ADC receives each of the plurality of first analog voltage signals from the plurality of memory cell columns 308 without via a current-to-voltage converter since the analog electrical signals from the plurality of memory cell columns 308 are already analog voltage signals.

In various other embodiments, the plurality of first analog electrical signals from the plurality of memory cell columns 308 are a plurality of first analog voltage signals and the peripheral sensing circuit comprises: a plurality of first analog multiplexers, each first analog multiplexer configured to select one output (analog voltage signal) of a corresponding group of memory cell columns 308 of the plurality of memory cell columns 308, in turn; a second analog multiplexer configured to select one output (analog voltage signal) amongst outputs of the plurality of first analog multiplexers and forward the selected output (selected analog voltage signal); and an ADC connected to the second analog multiplexer and configured to digitize the first analog voltage signal from the selected output by the second analog multiplexer. In this regard, each of the plurality of first analog multiplexers is shared amongst the corresponding group of memory cell columns 308 for processing the first analog voltage signals from the corresponding group of memory cell columns 308, and the second analog multiplexer and the ADC are each shared amongst the plurality of memory cell columns 308.

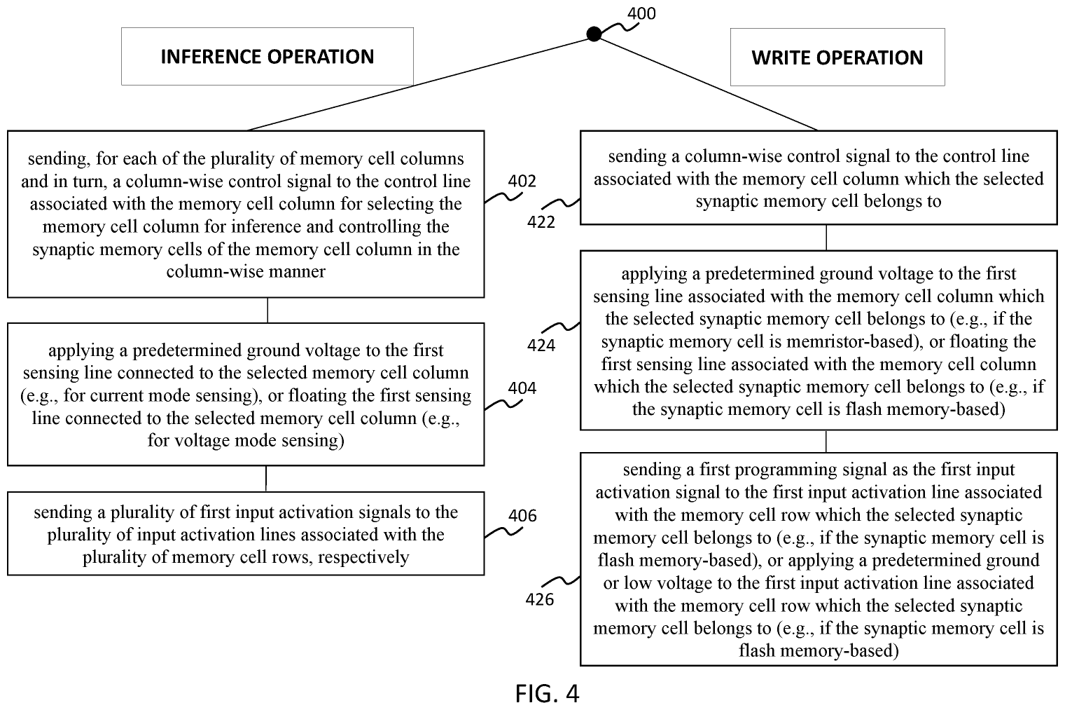

FIG. 4 depicts a schematic diagram of a method 400 of operating a neural processing core 300 for a neural network, according to various embodiments of the present invention, and more particularly, for operating the neural processing core 300 for a neural network as described herein according to various embodiments of the present invention. Therefore, it will be appreciated by a person skilled in the art that various neural network operations may be performed on the neural processing core 300, such as but not limited to, inference operations and write operations (which may also be referred to as learning operations, e.g., SET or RESET operations). Accordingly, various neural network operations may be performed on the neural processing core 300 for various purposes or applications as desired or as appropriate without going beyond the scope of the present invention.

As described hereinbefore according to various embodiments of the present invention, the neural processing core 300 comprises: a synaptic memory array 302 comprising synaptic memory cells 304 arranged in a plurality of memory cell rows 306 and columns 308; a plurality of first input activation lines 316 connected to the plurality of memory cell rows 306, respectively, of the synaptic memory array 302 and configured to receive a plurality of first input activation signals, respectively, to the plurality of memory cell rows 306; and a plurality of first sensing lines 318 connected to the plurality of memory cell columns 308, respectively, of the synaptic memory array 302 and configured to output a plurality of first analog electrical signals (e.g., analog current signals (in the case of current mode sensing) or analog voltage signals (in the case of voltage mode sensing)), respectively, from the plurality of memory cell columns 308. In particular, the neural processing core 300 is configured to control the synaptic memory cells 304 of the synaptic memory array 302 in a column-wise manner. In this regard, according to various embodiments, for performing inference on the synaptic memory array 302, the method 400 comprises: sending (at 402), for each of the plurality of memory cell columns 308 and in turn, a column-wise control signal to the control line 328 associated with the memory cell column 308 for selecting the memory cell column 308 for inference and controlling the synaptic memory cells 304 of the memory cell column 308 in the column-wise manner.

As described hereinbefore according to various embodiments of the present invention, each of the synaptic memory cells 304 of the synaptic memory array 302 comprises a first access transistor. In this regard, a gate of the first access transistor of the synaptic memory cell 304 is connected to the control line 328 associated with the memory cell column 308 which the synaptic memory cell 304 belongs to for receiving the column-wise control signal for the memory cell column 308 for controlling an operating state (e.g., on or off state) of the first access transistor of the synaptic memory cell 304. In this regard, in various embodiments, the above-mentioned sending (at 402) the column-wise control signal to the control line 328 associated with the selected memory cell column 308 comprises controlling the operating state of the first access transistor of each synaptic memory cell 304 of the selected memory cell column 308 in the column-wise manner based on the column-wise control signal.

As described hereinbefore according to various embodiments of the present invention, the synaptic memory array 302 may be a 1T1R array, and each synaptic memory cell 304 thereof may be a 1T1R cell. Furthermore, each synaptic memory cell 304 may be memristor-based. In this regard, according to various embodiments, for the above-mentioned performing inference on the synaptic memory array 302, the method 400 further comprises: applying (at 404) a predetermined ground voltage (e.g., 0V (or at least substantially 0V as will be understood by a person skilled in the art) or a predetermined virtual ground voltage (e.g., V_{dd/2}, where V_{dd} is a core transistor supply voltage to the first sensing line 318 connected to the selected memory cell column 308; and sending (at 406) a plurality of first input activation signals to the plurality of input activation lines 316 associated with the plurality of memory cell rows 306, respectively. According to various embodiments, for performing a write operation on a selected synaptic memory cell 304 of the synaptic memory array 302, the method 400 further comprises: sending (at 422) a column-wise control signal to the control line 328 associated with the memory cell column 308 which the selected synaptic memory cell 304 belongs to; applying (at 424) a predetermined ground voltage (e.g., 0V or a predetermined virtual ground voltage) to the first sensing line 318 associated with the memory cell column 308 which the selected synaptic memory cell 304 belongs to; and sending (at 426) a first programming signal (e.g., an input activation voltage) as the first input activation signal to the first input activation line 316 associated with the memory cell row 306 which the selected synaptic memory cell 304 belongs to.

As described hereinbefore according to various embodiments of the present invention, the synaptic memory array 302 according to various embodiments may be a 1TnR array, and each synaptic memory cell 304 thereof may be a 1TnR cell. Furthermore, each synaptic memory cell 304 may be memristor-based. In this regard, in various embodiments, for the above-mentioned performing inference on the synaptic memory array 302, the method 400 further comprises: applying the predetermined ground voltage (e.g., 0V or a predetermined virtual ground voltage) to the one or more additional sensing lines connected to the one or more additional memristor columns of the additional memristors, respectively, of the selected memory cell column. According to various embodiments, for the above-mentioned performing a write operation on a selected synaptic memory cell 304 of the synaptic memory array 302, the write operation is on a selected memristor amongst the first memristor and the one or more additional memristors of the selected synaptic memory cell 304. In this regard, the above-mentioned applying a predetermined ground voltage is applying the predetermined ground voltage to a sensing line amongst the first sensing line 318 and the one or more additional sensing lines associated with the memristor column amongst the first memristor column and the one or more additional memristor columns which the selected memristor belongs to. Furthermore, the method 400 further comprises applying a non-state changing voltage (i.e., any voltage that does not alter (or does not materially alter) the state of the memristor when applied) or floating each of one or more sensing lines amongst the first sensing line 318 and the one or more additional sensing lines associated with one or more memristor columns amongst the first memristor column and the one or more additional memristor columns which non-selected one or more memristors amongst the first memristor and the one or more additional memristors belong to.

As described hereinbefore according to various embodiments of the present invention, the synaptic memory array 302 may be a 2T2R array, and each synaptic memory cell 304 thereof may be a 2T2R cell. Furthermore, each synaptic memory cell 304 may be memristor-based. In this regard, according to various embodiments, for the above-mentioned performing inference on the synaptic memory array 302, the method 400 further comprises: sending a plurality of second input activation signals to the plurality of second input activation lines associated with the plurality of memory cell rows, respectively. For the above-mentioned performing a write operation on a selected synaptic memory cell 304 of the synaptic memory array 302, the method 400 further comprises: sending a second programming signal (e.g., an input activation voltage) as the second input activation signal to the second input activation line associated with the memory cell row 306 which the selected synaptic memory cell 304 belongs to. In various embodiments, one of the first and second programming signals is a programming signal (an input activation voltage) for setting a conductance state of the corresponding memristor of the first and second memristors of the selected synaptic memory cell 304 and the other one of the first and second programming signals is the predetermined ground voltage (e.g., 0V or a virtual ground voltage) or no signal (e.g., not applied) with the corresponding input activation line (corresponding one of the first and second input activation lines) being floated (i.e., the corresponding input activation line is floated and thus, no signal is needed to be applied thereto), based on a polarity of a synaptic weight value to be stored by the selected synaptic memory cell 304. For example, if the polarity of the synaptic weight value to be stored by the selected synaptic memory cell 304 is positive, the first programming signal is a programming signal (an input activation voltage) for setting a conductance state of the corresponding memristor. On the other hand, if the polarity of the synaptic weight value to be stored by the selected synaptic memory cell 304 is negative, the second programming signal is a programming signal (an input activation voltage) for setting a conductance state of the corresponding memristor.

As described hereinbefore according to various embodiments of the present invention, the synaptic memory array 302 may be a 2T2nR array, and each synaptic memory cell 304 thereof may be a 2T2nR cell. Furthermore, each synaptic memory cell 304 may be memristor-based. In this regard, for the above-mentioned performing inference on the synaptic memory array 302, the method 400 further comprises: applying the predetermined ground voltage to the one or more additional sensing lines connected to the one or more additional memristor columns of the additional pairs of additional memristors, respectively, of the selected memory cell column 308. For the above-mentioned performing a write operation on a selected synaptic memory cell 304 of the synaptic memory array 302, the write operation is on a selected pair of memristors amongst the first pair of memristors and the one or more additional pairs of additional memristors of the selected synaptic memory cell 304. In this regard, the above-mentioned applying a predetermined ground voltage is applying the predetermined ground voltage to a sensing line amongst the first sensing line 318 and the one or more additional sensing lines associated with the memristor column amongst the first memristor column and the one or more additional memristor columns which the selected pair of memristors belongs to. In addition, the method 400 further comprises applying a non-state changing voltage (i.e., any voltage that does not alter (or does not materially alter) the state of the memristor when applied) or floating each of one or more sensing lines amongst the first sensing line 318 and the one or more additional sensing lines associated with one or more memristor columns amongst the first memristor column and the one or more additional memristor columns which non-selected one or more pairs of memristors amongst the first pair of memristors and the one or more additional pairs of additional memristors belong to.

As described hereinbefore according to various embodiments of the present invention, the synaptic memory array 302 may be a 1T1R array, and each synaptic memory cell 304 thereof may be a 1T1R cell. Furthermore, each synaptic memory cell 304 may be flash memory-based. In this regard, according to various embodiments, for the above-mentioned performing inference on the synaptic memory array 302, the method 400 further comprises: applying (at 404) a predetermined ground voltage (e.g., 0V or a predetermined virtual ground voltage (e.g., V_{dd}/2, where V_{dd} is a core transistor supply voltage) to the first sensing line 318 connected to the selected memory cell column 308; and sending (at 408) a plurality of first input activation signals to the plurality of input activation lines 316 associated with the plurality of memory cell rows 306, respectively. According to various embodiments, for performing a write operation on a selected synaptic memory cell 304 of the synaptic memory array 302, the method 400 further comprises: sending (at 422) a column-wise control signal to the control line 328 associated with the memory cell column 308 which the selected synaptic memory cell 304 belongs to; floating (at 424) the first sensing line 318 associated with the memory cell column 308 which the selected synaptic memory cell 304 belongs to; and applying (at 426) a predetermined ground or low voltage (e.g., 0V or close to 0V) to the first input activation line 316 associated with the memory cell row 306 which the selected synaptic memory cell 304 belongs to.

As described hereinbefore according to various embodiments of the present invention, the synaptic memory array 302 may be a 2T2R array, and each synaptic memory cell 304 thereof may be a 2T2R cell. Furthermore, each synaptic memory cell 304 may be flash memory-based. In this regard, according to various embodiments, for the above-mentioned performing inference on the synaptic memory array 302, the method 400 further comprises: sending a plurality of second input activation signals to the plurality of second input activation lines associated with the plurality of memory cell rows, respectively. For the above-mentioned performing a write operation on a selected synaptic memory cell 304 of the synaptic memory array 302, the method 400 further comprises: applying a predetermined ground or low voltage to the second input activation line associated with the memory cell row 306 which the selected synaptic memory cell 304 belongs to.

As described hereinbefore according to various embodiments of the present invention, the synaptic memory array 302 may be a 1T1R array, and each synaptic memory cell 304 thereof may be a 1T1R cell. Furthermore, the neural processing core 300 may be configured to operate in voltage mode sensing. In this regard, according to various embodiments, for the above-mentioned performing inference on the synaptic memory array 304, the method 400 further comprises: floating (at 404) the first sensing line 318 connected to the selected memory cell column 308; and sending (at 406) a plurality of first input activation signals to the plurality of input activation lines 316 associated with the plurality of memory cell rows 306, respectively. According to various embodiments, for performing a write operation on a selected synaptic memory cell 304 of the synaptic memory array 302, the method 400 further comprises: sending (at 422) a column-wise control signal to the control line 328 associated with the memory cell column 308 which the selected synaptic memory cell 304 belongs to; applying (at 424) a predetermined ground voltage to the first sensing line 318 associated with the memory cell column 308 which the selected synaptic memory cell 304 belongs to; and sending (at 426) a first programming signal as the first input activation signal to the first input activation line 316 associated with the memory cell row 306 which the selected synaptic memory cell 304 belongs to. Accordingly, during inference under voltage mode sensing, the voltage (instead of current) is to be sensed at the sensing line (e.g., the ADC of the peripheral sensing circuit may directly sense/receive the voltage output from the sensing line). After ADC conversion, the output can be re-scaled (e.g., in digital domain) to compensate for the scaling factor (which is the sum of the column cells' conductance as will be described in further detail later below according to various example embodiments of the present invention).

As described hereinbefore according to various embodiments of the present invention, the neural processing core 300 further comprises a peripheral sensing circuit connected to the plurality of first sensing lines 318 and configured to process the plurality of first analog electrical signals from the plurality of memory cell columns 308, respectively, based on time multiplexing. In this regard, according to various embodiments, the method 400 further comprises processing, using the peripheral sensing circuit, the plurality of first analog electrical signals from the plurality of memory cell columns 308, respectively, based on time multiplexing.

As described hereinbefore according to various embodiments of the present invention, the plurality of first analog electrical signals from the plurality of memory cell columns 308 are a plurality of first analog current signals (i.e., current mode sensing). In this regard, the peripheral sensing circuit comprises: a current-to-voltage converter configured to convert each of the plurality of first analog currents from the plurality of memory cell columns 308, in turn, to a first analog voltage signal; and an ADC connected to the current-to-voltage converter and configured to digitize the first analog voltage signal received from the current-to-voltage converter. In this regard, the current-to-voltage converter and the ADC are each shared amongst the plurality of memory cell columns 308 for processing the plurality of first analog current signals from the plurality of memory cell columns 308, respectively. In this regard, according to various embodiments, for the above-mentioned performing inference on the synaptic memory array, the method 400 further comprises: converting, using the current-to-voltage converter, each of the plurality of first analog currents from the plurality of memory cell columns 308, in turn, to a first analog voltage signal; and digitizing, using the ADC, the first analog voltage signal received from the current-to-voltage converter.

As described hereinbefore, according to various embodiments of the present invention, the plurality of first analog electrical signals from the plurality of memory cell columns 308 are a plurality of first analog voltage signals (i.e., voltage mode sensing). In this regard, the neural processing core 300 comprises a peripheral sensing circuit connected to the plurality of first sensing lines 318 and configured to process the plurality of first analog voltage signals from the plurality of memory cell columns 308, respectively, based on time multiplexing. In this regard, the peripheral sensing circuit comprises: an ADC configured to digitize each of the plurality of first analog voltage signals from the plurality of memory cell columns 308, in turn. In this regard, the ADC is shared amongst the plurality of memory cell columns 308 for processing the plurality of first analog voltage signals from the plurality of memory cell columns 308. In this regard, for the above-mentioned performing inference on the synaptic memory array 302, the method 400 further comprises: digitizing, using the ADC, each of the plurality of first analog voltage signals from the plurality of memory cell columns 308, in turn. In this regard, the ADC receives each of the plurality of first analog voltage signals from the plurality of memory cell columns 308 without via a current-to-voltage converter since the analog electrical signals from the plurality of memory cell columns 308 are already analog voltage signals.

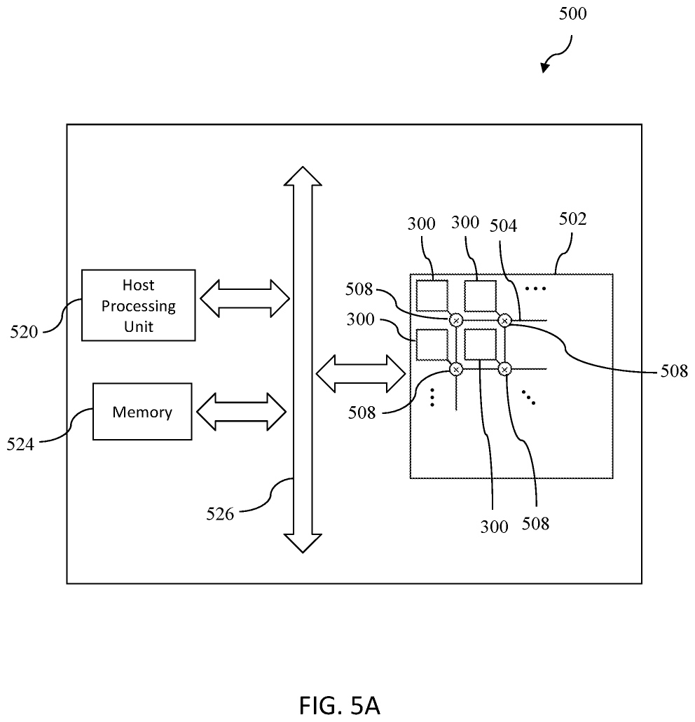

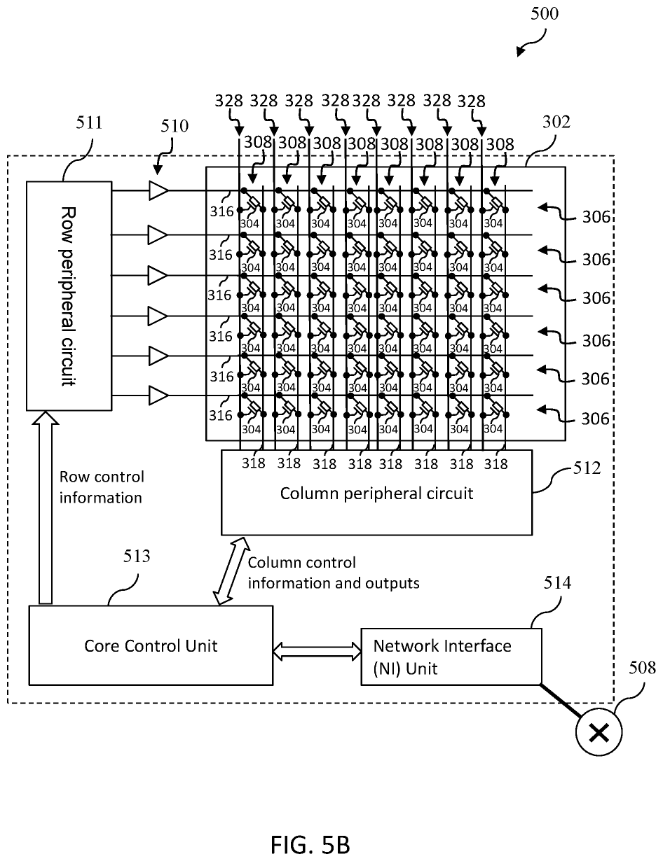

FIG. 5A depicts a schematic drawing of a neural network processor system 500 according to various embodiments of the present invention. The neural network processor system 500 comprises: a neural processing unit 502 comprising a plurality of neural processing cores 300; a router network 504 comprising a plurality of routers 508 communicatively coupled to the plurality of neural processing cores 300, respectively; at least one memory 524; and a host processing unit 520 (comprising at least one processor) communicatively coupled to the at least one memory 524 based on an interconnected bus 526 and to the neural processing unit 502 based on the router network 504. In various embodiments, the neural processing unit 502 is configured to control or coordinate the neural processing unit 502 for performing neural network computations. In this regard, the host processing unit 520 may be configured to send instructions or various signals to control or enable one or more neural processing cores 300 to perform various neural network operations as described herein according to various embodiments of the present invention. Accordingly, the host processing unit 520 may be configured to perform the method 400 of operating one or more neural processing cores 300 for a neural network as described herein according to various embodiments of the present invention. In various embodiments, the neural network processor system 500 may be formed as an integrated neural processing circuit.

For simplicity and clarity, the neural network processor system 500 is illustrated in FIG. 5A with only one neural processing unit (NPU) 502. However, it will be appreciated by a person skilled in the art that the neural network processor system 500 is not limited to only one NPU, and additional one or more NPUs (e.g., configured in the same, similar or corresponding manner as the NPU 502 described herein according to various embodiments) may be included in the neural network processor system 500 and as communicatively coupled to the host processing unit 520 for performing various neural network operations as desired or as appropriate.

In various embodiments, the neural network processor system 500 further comprises a fabric bridge. In this regard, the host processing unit 520 may be communicatively coupled to the neural processing unit 502 (or to each neural processing unit) via the fabric bridge and the router network 504. In particular, the host processing unit 220 may be communicatively coupled to the router network 504 via the fabric bridge.

In various embodiments, in each neural processing unit 502, the plurality of neural processing cores 300 is arranged in a two-dimensional (2D) array (comprising rows and columns) and each neural processing core 300 has an associated unique address based on its position in the 2D array and the neural processing unit 502 which it belongs to. For example, each neural processing core 300 may have an address based on the row and column at which it is located in the 2D array.

FIG. 5B shows a schematic drawing of an example configuration/architecture of a neural processing core 500 according to various embodiments of the present invention. The neural processing core 500 is the same as the neural processing core 300 as described herein according to various embodiments of the present invention but with various additional components/modules/elements shown or described, and various components/modules/elements shown in FIG. 5B which are the same or similar as those components/modules/elements described with reference to FIG. 3 are denoted by the same reference numerals. For simplicity, each synaptic memory cell 304 in FIG. 5B is illustrated as a resistor “capped” with a short line segment (denoting a transistor gate) to represent a memristor-based synaptic memory cell. However, as explained hereinbefore, the present invention is not limited to memristor-based synaptic memory cells and other types of synaptic memory cells may be employed as desired or as appropriate, such as but not limited to, flash memory-based synaptic memory cell. It will be appreciated by a person skilled in the art that FIG. 5B may not show all components/modules/elements of the neural processing core 500 described according to various embodiments of the present invention. For example, the neural processing core 500 may comprise a synaptic memory array 302 (e.g., 1T1R array, 1T1nR array, 2T2R array or 2Tn2R array) as described hereinbefore according to various embodiments of the present invention.

The neural processing core 500 may further comprise a row peripheral circuit or block 511 (e.g., including a row address decoder and an axon buffer), a plurality of line drivers 510, a column peripheral circuit or block 512 (e.g., configured as described herein according to various embodiments and further including various components/modules such as a column address decoder and a neuron circuit), a core control unit or block 513 (e.g., including scheduling, routing and configuration information), and a network interface (NI) unit or block 514. For example, the network interface unit 514 may be configured to forward packets received from its corresponding router 508 to the core control unit 513. The core control unit 513 may send row control information (e.g., axon ID and axon input value) to the row peripheral circuit 511 to control its components (e.g., the row address decoder and the axon buffer), which in turn controls the plurality of line drivers 510. The core control unit 513 may also send column control information and neuron circuit control signal to the column peripheral circuit 512 to control various components thereof. In various embodiments, the column peripheral circuit 512 may generate the column-wise control signals for applying to the plurality of control lines 328 based on the column control information from the core control unit 513 for controlling the plurality of memory cell columns 308 in the column-wise manner as described herein according to various embodiments of the present invention (which may also be referred to as time-multiplexing control signals). For example, the core control unit 513 may send column address information (e.g., 8-bit address for 256-column array, i.e., column control information) to the column peripheral circuit 512 to specify which memory cell column to select, and the column peripheral circuit 512 may then perform address decoding (e.g., 8-bit to 256 column-wise control signals (binary signals) for the plurality of control lines 328 with only 1 out of the 256 column-wise control signals being an On control signal). For example, once the neuron computations are completed for the current time-step, the neuron outputs may then be conveyed back to the core control unit 513 for data packet transmission via the network interface unit 514 and the corresponding router 508.

A computing system, a controller, a microcontroller or any other system providing a processing capability may be presented according to various embodiments in the present disclosure. Such a system may be taken to include one or more processors and one or more computer-readable storage mediums. For example, the neural network processor system 500 described hereinbefore may include a number of processing units (e.g., the host processing unit (e.g., comprising one or more processors) 520 and one or more neural processing units 502) and one or more memories 524 which are for example used in various processes performed as described herein according to various example embodiments of the present invention. A memory (or computer-readable storage medium) 524 used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in various embodiments, a “circuit” may be a hard-wired logic circuit or a programmable logic circuit such as a programmable processor, e.g., a microprocessor (e.g. a Complex Instruction Set Computer (CISC) processor or a Reduced Instruction Set Computer (RISC) processor). A “circuit” may also be a processor executing software, e.g., any kind of computer program, e.g., a computer program using a virtual machine code such as e.g., Java. Any other kind of implementation of the respective functions may also be understood as a “circuit” in accordance with various embodiments.

Some portions of the present disclosure may be explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. It will be understood by a person skilled in the art that various steps/functions of an algorithm require physical manipulations of physical quantities, such as electrical, magnetic or optical signals capable of being stored, transferred, combined, compared, and otherwise manipulated.

The present specification also discloses a system (e.g., which may also be embodied as a device or an apparatus) for performing various operations/functions described herein. Such a system may be specially constructed for the required purposes, or may comprise a general purpose computer or other device selectively activated or reconfigured by a computer program stored in the computer.

In addition, the present specification also at least implicitly discloses computer program(s) or software/functional module(s), in that it would be apparent to the person skilled in the art that various operations, functions or steps described herein may be put into effect by computer code. The computer program(s) is not intended to be limited to any particular programming language and implementation thereof, and it will be appreciated that a variety of programming languages and coding thereof may be used to implement the computer program(s). Moreover, the computer program(s) is not intended to be limited to any particular control flow as there are a variety of programming languages which can use different control flows. It will be appreciated to a person skilled in the art that various modules may be software module(s) realized by computer program(s) or set(s) of instructions executable by a computer processor to perform the required functions as appropriate, or may be hardware module(s) being functional hardware unit(s) designed to perform the required functions as appropriate. It will also be appreciated that a combination of hardware and software modules may be implemented as appropriate.

In various embodiments, there is provided a computer program product, embodied in one or more computer-readable storage mediums (non-transitory computer-readable storage medium), comprising instructions executable by one or more processors (e.g., the host processing unit 520) to control or instruct the neural processing core 300 to perform the method 400 of operating the neural processing core for a neural network as described herein according to various embodiments of the present invention. Accordingly, various computer programs or modules described herein may be stored in a computer program product receivable by, or transferable to, a system (including downable from a server) for execution by at least one processor of the system (e.g., the neural network processor system 500) to perform various functions.

Various software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that various software or functional module(s) described herein may also be implemented as a combination of hardware and software modules.

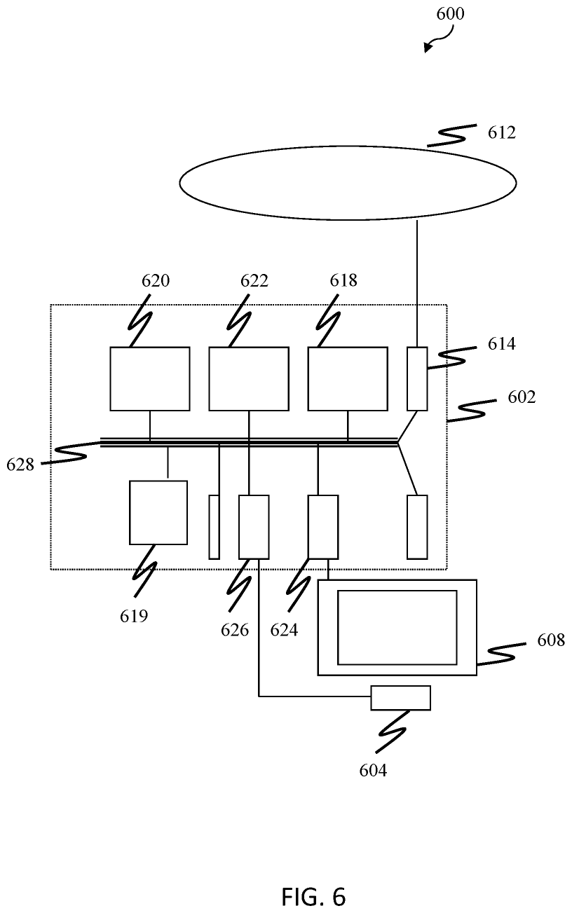

In various embodiments, the neural network processor system 500 may be realized by or embodied as a computer system (e.g., portable or desktop computer system, such as tablet computers, laptop computers, mobile communications devices (e.g., smart phones), and so on) including the host processing unit 520 and the neural processing unit(s) 502 configured as described herein according to various embodiments, such as a computer system 600 as schematically shown in FIG. 6 as an example only and without limitation. Various methods/steps or functional modules may be implemented as software, such as a computer program (e.g., one or more neural network applications) being executed within the computer system 600, and instructing the computer system 600 (in particular, the host processing unit 520) to conduct various methods/operations of various embodiments described herein. The computer system 600 may comprise a system unit 602, input device(s) (e.g., a keyboard/touchscreen/mouse) 604 and output device(s) (e.g., a display device 608). The system unit 602 may be connected to a computer network 612 via a suitable transceiver device 614, to enable access to, e.g., the Internet or other network systems such as Local Area Network (LAN) or Wide Area Network (WAN). The system unit 602 in the example may include a processor 618 (e.g., corresponding to the host processing unit 520 of the neural network processor system 500 as described herein according to various embodiments) for executing various instructions (e.g., neural network application(s)), a neural network processor 619 (e.g., corresponding to the neural processing unit 502 of the neural network processor system 500 as described herein according to various embodiments), a Random Access Memory (RAM) 620 and a Read Only Memory (ROM) 622. The neural network processor 619 may be coupled to the interconnected bus (system bus) 628 via one or more fabric bridges. The system unit 602 may also include a number of Input/Output (I/O) interfaces, for example I/O interface 624 to the display device 608, and I/O interface 626 to the input device 604. The components of the system unit 602 typically communicate via an interconnected bus 628 and in a manner known to the person skilled in the relevant art.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. Furthermore, it will be appreciated by a person skilled in the art that the term “and/or” refers to any one or more of the stated items, including any combination thereof.

Any reference to an element or a feature herein using a designation such as “first”, “second” and so forth does not necessarily limit the quantity or order of such elements or features, unless stated or the context requires otherwise. For example, such designations may be used herein as a convenient way of distinguishing between two or more elements or instances of an element. Thus, a reference to first and second elements does not necessarily mean that only two elements can be employed, or that the first element must precede the second element. In addition, a phrase referring to “at least one of” a list of items refers to any single item therein or any combination of two or more items therein.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

Various example embodiments provide an effective implementation of analog neuromorphic computing for neural networks, and more particularly, an energy-efficient time multiplexing neural processing core for analog computing (e.g., memristor-based or flash memory-based).

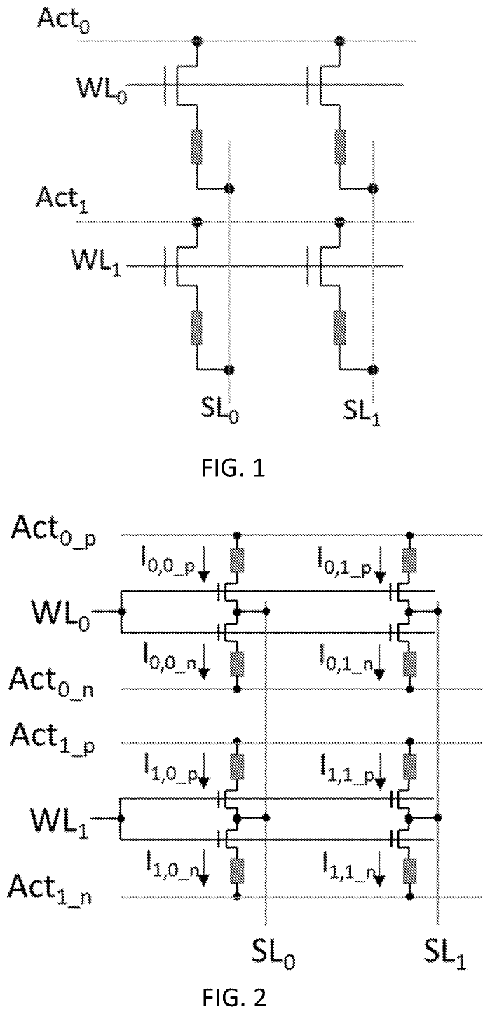

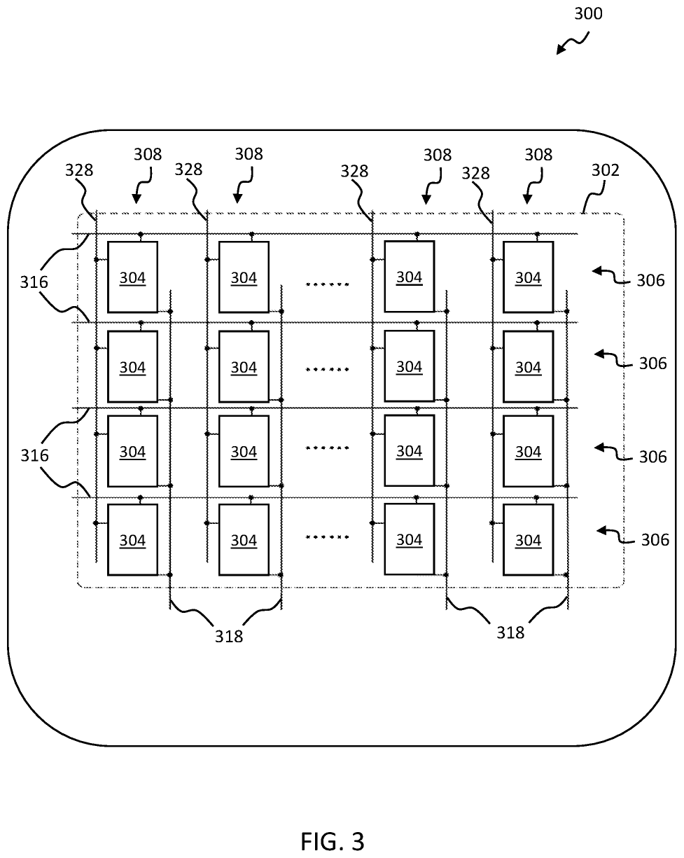

As described in the background, various conventional synaptic memory arrays (e.g., the conventional 1T1R array and 2T2R array shown in FIGS. 1 and 2) are each able to compute all columns (neurons) thereof simultaneously by draining the currents on all columns simultaneously, which leads to a very high throughput. However, various embodiments of the present invention identified a number of drawbacks/problems associated with such conventional synaptic memory arrays. A first problem is that the peak power (due to the simultaneous draining of currents on all columns of the conventional synaptic memory array), although likely lower than pure-digital DNN hardware, is still significantly high. A second problem is that the simultaneous computing nature requires each column to have its dedicated peripheral sensing circuit, which usually includes a TIA (trans-impedance amplifier) and an ADC (analog-to-digital converter), both of which have a significant chip area or footprint. For example, the second problem may lead to a situation whereby the conventional synaptic memory array (e.g., conventional 1T1R or 2T2R array) may have a small footprint but the associated peripheral sensing circuits (e.g., per-column TIA and ADC) would have a significantly large footprint, leading to a huge chip (due to huge neural processing cores) yet with uncompetitive capacity. This is because most of the chip area would be occupied by peripheral sensing circuits, instead of the synaptic memory array providing memory storage capacity. In addition, various embodiments of the present invention note that edge intelligence applications usually do not demand very high computing throughput, and thus, it may be advantageous to provide a more compact (hence lower cost) neural processing core (which may form part of a DNN chip) that also has lower power and energy requirement.

Various example embodiments note that one way to reduce the area overhead or footprint of peripheral circuits (e.g., the peripheral sensing circuit, which may also be referred to as the column peripheral circuit) is to share them (e.g., amongst a plurality of memory cell columns) via time-multiplexing (e.g., using an analog multiplexer (mux) and process one memory cell column at a time). However, various example embodiments found that applying time-multiplexing to conventional 1T1R/2T2R array architecture (e.g., the conventional 1T1R array and 2T2R array shown in FIGS. 1 and 2) for processing current from memory cell columns would lead to a significant problem, namely, the leaking of current on non-selected memory cell columns (i.e., memory cell columns not currently selected by the analog multiplexer for processing). Various example embodiments note that such a leaking of current occurs because even when certain memory cell columns are not selected by the analog multiplexer, for access transistors in such non-selected memory cell columns but in memory cell rows turned on by corresponding word-lines (WLᵢ), current would still flow through each of such access transistors from the corresponding input activation line to the corresponding source line (which may also be referred to as sensing line).

As an illustrative example, if a conventional 1T1R cell on average draws 1 uW (e.g., average 2 uA at average 0.5V read voltage) during inference, then for a conventional 256×256 1T1R array, each memory cell column would draw 256×1 uW=0.256 mW, and the entire 1T1R array would draw 0.256 mW×256=65.536 mW average peak power. Assuming that it takes 10 ns to sense the output of a memory cell column (e.g., for the bit-line current and the TIA output to stabilize), the 1T1R cells of each memory cell column would consume 0.256 mW×10 ns=2.56 pJ. If the peripheral sensing circuit (e.g., a TIA and an ADC) consumes 12 pJ, then the memory cell column together with the peripheral sensing circuit together would consume 14.56 pJ per column. Accordingly, if time-multiplexing is employed for such a conventional 1T1R array, because non-selected memory cell columns continue to drain current and as it would take 256 cycles to sense all 256 memory cell columns, the total energy consumed on the conventional 1T1R array would be 256×65.536 mW×10 ns+256×12 pJ=170,844.16 pJ, or 170,844.16 pJ/256=667.36 pJ per column, which is 45.8 times of 14.56 pJ with per-column sensing circuit.

For a conventional 256×256 2T2R array, the total energy consumed may be similar to the conventional 256×256 1T1R array by noticing that only 1 out of 2 memristive devices in a conventional 2T2R cell is actively used at a time. For example, for a positive input activation value, the negative weight memristive device need not consume power because its input activation line can be fed with a virtual ground voltage which is the same as the source line voltage. Therefore, the power consumption for a conventional 2T2R cell may be the same or similar to that of the conventional 1T1R cell.

Therefore, applying time-multiplexing to conventional 1T1R/2T2R array architecture for processing current from memory cell columns would lead to a significant problem, namely, the leaking of current on non-selected memory cell columns resulting in the consumption of significantly more energy than without time-multiplexing. Accordingly, various example embodiments provide a neural processing core for a neural network that is compact or has a minimized footprint (e.g., a smaller or reduced footprint or chip area) as well as being power and energy efficient, that is achieving both reduced footprint and improved power/energy efficiency at the same time, thereby resulting in an energy-efficient time multiplexing neural processing core for analog computing (e.g., memristor-based or flash memory-based).

Accordingly, various example embodiments provide an energy-efficient time-multiplexing architecture for analog computing, whereby the neural processing core is advantageously configured to avoid wasting power/energy on non-selected memory cell columns (i.e., memory cell columns not currently selected by an analog multiplexer for processing). In this regard, according to various example embodiments, the neural processing core is configured to control the synaptic memory cells of the synaptic memory array in a column-wise manner (i.e., synaptic memory cells of the same memory cell column are controlled collectively or simultaneously, that is, on a per column basis). In particular, the gate(s) of the access transistor(s) of the synaptic memory cell is connected to the control line associated with the memory cell column which the synaptic memory cell belongs to for receiving a column-wise control signal for the memory cell column for controlling an operating state (e.g., on or off state) of the access transistor(s) of the synaptic memory cell. As a result, memory cell columns that are not being selected by an analog multiplexer for processing can be controlled column-wise to be in an off state (or non-operating state) such that synaptic memory cells in such non-selected memory cell columns will not be in an on state (or not in an operating state). Therefore, current will not be able to flow through such synaptic memory cells in non-selected memory cell columns and the technical problem of current leakage on non-selected memory cell columns associated with conventional synaptic memory array is advantageously addressed or resolved, thereby enabling the neural processing core according to various example embodiments to achieve both reduced footprint and improved power and energy efficiency at the same time.

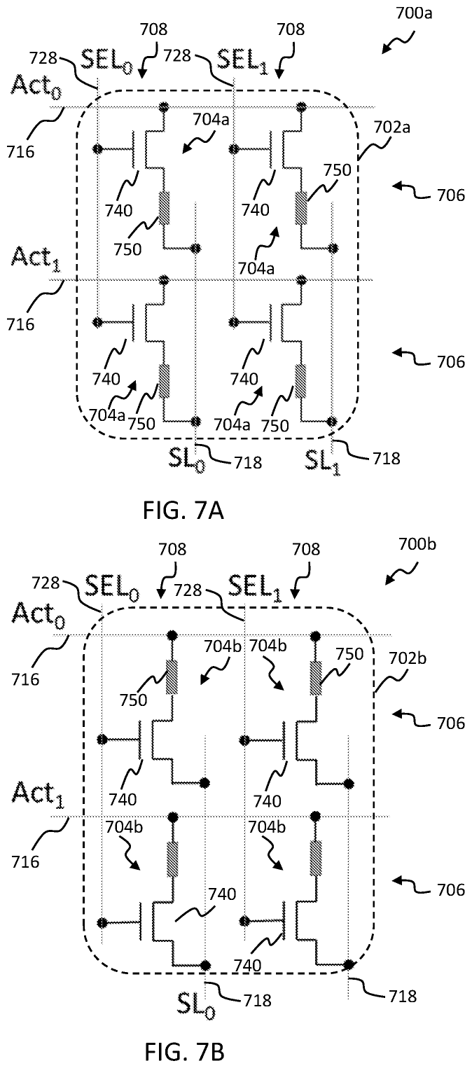

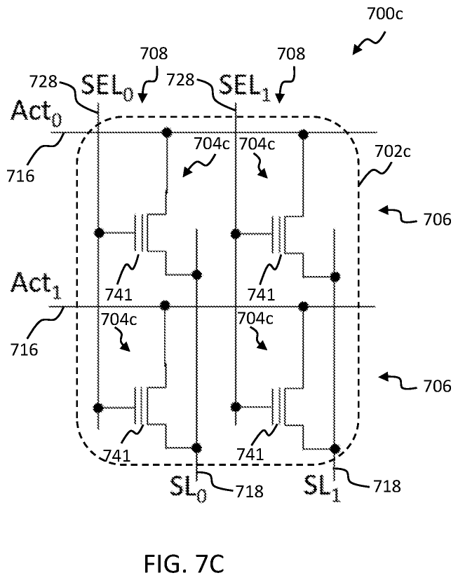

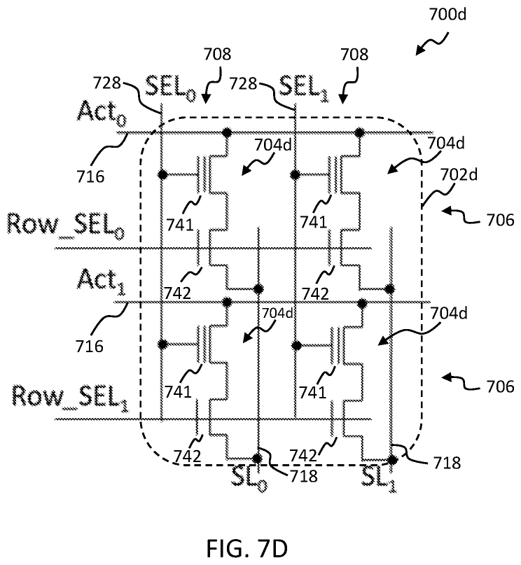

For illustration purposes and for better understanding, various example configurations/architectures of the neural processing core according to various example embodiments will now be described according to various example embodiments of the present invention. It will be appreciated by a person skilled in the art that the present invention is not limited to these example configurations/architectures described and that other configurations/architectures may be implemented as desired or as appropriate as long as the neural processing core is configured to control the synaptic memory cells of the synaptic memory array in a column-wise manner. In various example embodiments, various components/elements of the neural processing core are connected to each other as shown in the schematic drawings of FIGS. 7A, 7B, 7C, 7D, 8A, 8B, 9A, 9B, 9C, 9D, 15, 16, 17 and 18. Furthermore, it will also be appreciated by a person skilled in the art that various components/elements of the neural processing core may be directly connected to each other as shown in the above-mentioned figures or indirectly connected with each other as appropriate, without going beyond the scope of the present invention.

### 1T1R Array Architecture

FIG. 7A depicts a schematic drawing of an example neural processing core 700a comprising a synaptic memory array 702a having a 1T1R array architecture, according to various example embodiments of the present invention. It will be appreciated by a person skilled in the art that for simplicity and clarity, the 1T1R array structure is illustrated in FIG. 7A simply as having a dimension of 2×2. However, it will be appreciated by a person skilled in the art that the 1T1R array structure may have any dimension as desired or as appropriate. The neural processing core 700a comprises: a synaptic memory array 702a comprising synaptic memory cells 704a arranged in a plurality of memory cell rows 706 and columns 708; a plurality of input activation lines 716 connected to the plurality of memory cell rows 706, respectively, of the synaptic memory array 702a (e.g., input activation lines may also be referred to as bit-lines of the memory cell rows 706) and configured to receive a plurality of input activation signals, respectively, to the plurality of memory cell rows 706; and a plurality of sensing lines 718 connected to the plurality of memory cell columns 708, respectively, of the synaptic memory array 702a (e.g., sensing lines may also be referred to as source lines of the memory cell columns 708) and configured to output a plurality of analog electrical signals, respectively, from the plurality of memory cell columns 708. In particular, the neural processing core 700a is configured to control the synaptic memory cells 704a of the synaptic memory array 702a in a column-wise manner (i.e., synaptic memory cells 704a of the same memory cell column 708 are controlled collectively or simultaneously, that is, on a per column basis).

As shown in FIG. 7A, the neural processing core 700a further comprises a plurality of control lines 728 connected to the plurality of memory cell columns 708, respectively, of the synaptic memory array 702a (e.g., control lines may also be referred to as select lines of the memory cell columns 708 and the SELᵢ denotes the column-wise control signal (voltage) for selecting (e.g., turning on) the corresponding memory cell column 708). In this regard, for each of the plurality of memory cell columns 708, the synaptic memory cells 704a of the memory cell column 708 are each connected to the control line 728 of the plurality of control lines 728 associated with the memory cell column 708 and the control line 728 is configured to receive a column-wise control signal for the memory cell column 708 for controlling the synaptic memory cells 704a of the memory cell column 708 in the column-wise manner.

Each of the synaptic memory cells 704a of the synaptic memory array 702a comprises an access transistor 740. In this regard, as shown, a gate of the access transistor 420 of the synaptic memory cell 704a is connected to the control line 728 associated with the memory cell column 708 which the synaptic memory cell 704a belongs to for receiving the column-wise control signal for the memory cell column 708 for controlling an operating state (e.g., on or off state) of the access transistor 740 of the synaptic memory cell 704a. For each of the plurality of memory cell rows 706, the synaptic memory cells 704a of the memory cell row 706 are each connected to the input activation line 716 associated with the memory cell row 706 and the input activation line 716 is configured to receive the input activation signal for the synaptic memory cells 704a of the memory cell row 706 in a row-wise manner. In addition, for each of the plurality of memory cell columns 708, the synaptic memory cells 704a of the memory cell column 708 are each connected to the sensing line 718 associated with the memory cell column 708. Furthermore, for each of the synaptic memory cells 704a of the synaptic memory array 702a, the synaptic memory cell 704a further comprises a memristor 750 connected to and between the access transistor 740 of the synaptic memory cell 704a (to the source side of the access transistor 740) and the sensing line 718 associated with the memory cell column 708 which the synaptic memory cell 704a belongs to. Accordingly, the synaptic memory cells 704a of the synaptic memory array 702a according to various embodiments are memristor-based.

Various example operations that may be performed by the example neural processing core 700a comprising the synaptic memory array 702a having the 1T1R array architecture will now be described according to various example embodiments of the present invention, including inference operations and write operations (e.g., SET or RESET operations).

For performing inference on the synaptic memory array 702a, in various example embodiments, for each of the plurality of memory cell columns 708 and in turn, a column-wise control signal may be sent (or fed) to the control line 728 associated with the memory cell column 708 for selecting the memory cell column 708 for inference and controlling the synaptic memory cells 704a of the memory cell column 708 in the column-wise manner. In this regard, the column-wise control signal is sent to the control line 728 associated with the selected memory cell column 708 for controlling the operating state of the access transistor 740 of each synaptic memory cell 704a of the selected memory cell column 708 in the column-wise manner. In addition, a predetermined ground voltage (e.g., 0V or a predetermined virtual ground voltage (e.g., V_{dd}/2, where V_{dd} is a core transistor supply voltage)) may be applied to the sensing line 718 connected to the selected memory cell column 708, and a plurality of input activation signals may be sent to the plurality of input activation lines 716 associated with the plurality of memory cell rows 706, respectively. For example, during inference, all input activation lines 716 may be fed with voltages that correspond to input activations of a neural network (e.g., a deep neural network (DNN)), while ensuring that these voltages are not too high to cause unintended alterations/changes in the state of the synaptic memory cells 704a. For example, if the memristor's standard programming voltage (between two ends of the memristor) is +1.5V for SET and −1.5V for RESET operations respectively, then during inference the input activation signal may be constrained to a maximum of +0.5V for positive inputs and to a minimum of −0.5V for negative inputs when ground is 0V, or constrained to a maximum of 1V for positive inputs and to a minimum of 0V for negative inputs when ground is virtual ground of V_{dd}/2=0.5V and V_{dd}=1V. Such constrained voltages are far below the memristor's standard programming voltage, and thus will have practically no unintended programming effects when applied to the memristor.

For programming or performing a write operation on a selected synaptic memory cell 704a of the synaptic memory array 702a, in various example embodiments, a column-wise control signal may be sent (or fed) to the control line 728 associated with the memory cell column 708 which the selected synaptic memory cell 704a belongs to. In addition, a predetermined ground voltage (e.g., 0V or a virtual ground voltage) may be applied to the sensing line 718 associated with the memory cell column 708 which the selected synaptic memory cell 704a belongs to, and a programming or write signal (e.g., an input activation voltage) may be applied as the input activation signal to the input activation line 716 associated with the memory cell row 706 which the selected synaptic memory cell 704a belongs to.

For example, to program a selected synaptic memory cell 704a in a memory cell column j 708, the gate of the selected synaptic memory cell 704a in the memory cell column j 708 are turned on with an On voltage (SELⱼ) (the column-wise control signal) applied to the control line 728 associated with the selected memory cell column j 708. For a SET operation (e.g., to a high conductance state), the input activation line (Actᵢ) 716 associated with the memory cell row i 706 which the selected synaptic memory cell 704a belongs to may be set to a high voltage (e.g., V_{prog}) and the source line (SLⱼ) 718 associated with the memory cell column j 708 may be set to a low voltage (e.g., 0V). For a RESET operation (e.g., a low conductance state), the source line (SLⱼ) 718 associated with the memory cell column j 708 may be set to a high voltage (e.g., V_{prog}) and the input activation line (Actᵢ) 716 may be set to a low voltage (e.g., 0V). For example, the above-mentioned high voltage (V_{prog}) may have different values depending on the target or intended state (i.e., target or intended conductance value) of the selected synaptic memory cell 704a.

For example, to program selected multiple synaptic memory cells 704a in a memory cell column j 708 simultaneously, the input activation lines 716 associated with the memory cell rows 706 which the selected multiple synaptic memory cells 704a belong to may each be applied with an appropriate input activation signal in the same or similar manner as described above for the selected synaptic memory cell 704a. In this regard, since the synaptic memory cells 704a of the synaptic memory array 702a are controlled in a column-wise manner, the same write operation (e.g., SET or RESET operation) would need to be performed on these multiple synaptic memory cells 704a. For example, when performing multiple RESET operations on multiple synaptic memory cells 704a in the same memory cell column j 708, there can only be one voltage (e.g., V_{prog}) for the corresponding source line (SLⱼ) 718, while different low voltages may be applied to the input activation lines 716 associated with the memory cell rows 706 which the multiple synaptic memory cells 704a belong to, to facilitate programming to various RESET states if desired. Furthermore, for the non-selected memory cell rows 706, the corresponding input activation lines 716 may be set to floating so as not to alter the states of the non-selected synaptic memory cells 704a in the non-selected memory cell rows 706. For the non-selected memory cell columns 708, the corresponding source lines 718 may be set to any voltage that does not alter the states of the non-selected synaptic memory cells 704a in the non-selected memory cell columns 708. For example, if the memristor's standard programming voltage (between two ends of the memristor) is +1.5V for SET and −1.5V for RESET operations respectively, and if during inference a range of [−0.5V, +0.5V] where ground is 0V (or a range of [0V, 1V] where ground is virtual ground of V_{dd}/2=0.5V and V_{dd}=1V) for the input activation signal is deemed safe enough to avoid unintended programming effects on the memristor, then any voltage within such a range may also be applied on the corresponding source lines 718 for those memory cell columns 708 that are not selected for programming.

FIG. 7B depicts a schematic drawing of an example neural processing core 700b comprising a synaptic memory array 702b also having a 1T1R array architecture, according to various example embodiments of the present invention. In particular, the example neural processing core 700b is the same as the example neural processing core 700a except that the memristor 750 is connected to and between the access transistor 740 of the synaptic memory cell 704b (to the drain side of the access transistor 740) and the input activation line 716 associated with the memory cell row 706 which the synaptic memory cell 704b belongs to, instead of the sensing line 718 associated with the memory cell column 708 which the synaptic memory cell belongs to. For example, it may be preferable to place the resistive element (i.e., the memristor) 750 at the drain side of the access transistor 740 of the synaptic memory cell 704b. Accordingly, various components/modules/elements of the example neural processing core 700b are the same or similar as those described above for the example neural processing core 700a with reference to FIG. 7A and are denoted by the same reference numerals in FIG. 7B. Furthermore, various operations (e.g., inference operations and write operations (e.g., SET or RESET operations)) may be performed on the example neural processing core 700b in the same or similar manner as described above for the example neural processing core 700a with reference to FIG. 7A and need not be repeated for clarity and conciseness.

For example, the write operations (e.g., SET and RESET operations) on the synaptic memory cells 704b may be performed in the same or similar manner as described above for the example neural processing core 700a with reference to FIG. 7A. However, various example embodiments note that for the synaptic memory array 702a, during a SET operation, the gate voltage may need to be greater than V_{prog}+Vₜₕ due to source degeneration, whereas the synaptic memory array 702b does not suffer from such a source degeneration issue since the memristor 750 is arranged at the drain side of the access transistor 740. Therefore, advantageously for the synaptic memory array 702b, the gate voltage may not need to be as high as for the synaptic memory array 702a (and/or the transistor channel width need not be as wide hence saving on transistor size) since the synaptic memory array 702b does not suffer from the source degeneration issue during the SET operation. On the other hand, during the RESET operation, source degeneration may occur for the synaptic memory array 702b and the source line (SLᵢ) 718, and the access transistor 740 may thus require a higher gate voltage (V_{prog}+Vₜₕ).

In various example embodiments, to represent signed synaptic weight, two 1T1R arrays may be used, with a first synaptic memory array representing the positive portion of the synaptic weight and a second synaptic memory array representing the negative portion of the synaptic weight. The difference of the corresponding neurons (i.e., corresponding columns' currents) of the two synaptic memory arrays may then represent the weighted sum. For example, such a difference can be obtained either by analog current subtraction (which requires a current subtraction circuit) or by digital subtraction by first digitizing the currents from both synaptic memory arrays (e.g., using an ADC) and then subtracting the digitized currents in the digital domain.

According to various example embodiments, if the number of memory cell rows (which correspond to the number of inputs to the synaptic memory array) is smaller than the number of inputs for a given neural network layer, then multiple synaptic memory arrays may be used to implement the said neural network layer, and the number of inputs for the neural network layer may be partitioned into multiple groups, each group of inputs to be processed by a corresponding one of the multiple synaptic memory arrays, and the partial weighted sums produced by each synaptic memory array may then be summed together to obtain the final weighted sum.

FIG. 7C depicts a schematic drawing of an example neural processing core 700c comprising a synaptic memory array 702c having a 1T1R array architecture, according to various example embodiments of the present invention. The example neural processing core 700c is the same as the example neural processing core 700a or 700b except that the neural processing core 700c is flash memory-based instead of memristor-based (i.e., the synaptic memory cells 704c are flash memory cells (which may simply be referred to as flash cells)). Accordingly, various components/modules/elements of the example neural processing core 700c are the same or similar as those described above for the example neural processing core 700a or 700b with reference to FIG. 7A or FIG. 7B and are denoted by the same reference numerals in FIG. 7C. Functionally, flash cells can be considered as being equivalent or similar to RRAM-based cells, with the main difference being that there is no direct physical presence of a resistive element in a flash cell, and the memristor functionality is instead implicitly represented by the amount of static charge stored on the floating gate (denoted as an extra line segment in the access transistor 741) inside the access transistor 741, which will thus affect the conductance of the flash cell (e.g., the access transistor 741) and thus capable of representing or storing a synaptic weight (or a part thereof).

In particular, for each of the plurality of memory cell rows 706, the synaptic memory cells 704c of the memory cell row 706 are each connected to the first input activation line 716 associated with the memory cell row 706 and the first input activation line 716 is configured to receive the first input activation signal for the synaptic memory cells 704c of the memory cell row 706 in a row-wise manner. In addition, for each of the plurality of memory cell columns 708, the synaptic memory cells 704 of the memory cell column 708 are each connected to the first sensing line 718 associated with the memory cell column 708. Furthermore, for each of the synaptic memory cells 704c of the synaptic memory array 702c, the first access transistor 741 of the synaptic memory cell 704c connected to the control line 728 comprises a control gate and a floating gate, whereby a source of the first access transistor 741 is connected to the first sensing line 718 associated with the memory cell column 708 which the synaptic memory cell 704c belongs to and a drain of the first access transistor 741 is connected to the first input activation line 716 associated with the memory cell row 706 which the synaptic memory cell 704c belongs to.

It will be appreciated by a person skilled in the art that various operations (e.g., inference operations and write operations (e.g., SET or RESET operations)) may be performed on the example neural processing core 700c in the same or similar manner as described above for the example neural processing core 700a with reference to FIG. 7A and need not be repeated for clarity and conciseness. For example, flash memory-based synaptic memory arrays can function similarly to RRAM-based or other memristor-based synaptic memory cells, particularly during neural network inference.

For performing inference on the synaptic memory array 702c, in various example embodiments, a predetermined ground voltage (e.g., 0V or a predetermined virtual ground voltage (e.g., V_{dd}/2, where V_{dd} is a core transistor supply voltage)) may be applied to the first sensing line 718 connected to the selected memory cell column 708; and a plurality of first input activation signals may be sent or applied to the plurality of input activation lines 716 associated with the plurality of memory cell rows 306, respectively.

For programming or performing a write operation on a selected synaptic memory cell 704c of the synaptic memory array 702c, in various example embodiments, a column-wise control signal may be sent to the control line 728 associated with the memory cell column 708 which the selected synaptic memory cell 704c belongs to; the first sensing line 718 associated with the memory cell column 708 which the selected synaptic memory cell 704c belongs to may be floated; and a predetermined ground or low voltage may be applied to the first input activation line 716 associated with the memory cell row 706 which the selected synaptic memory cell 704c belongs to.

For example, according to the column-based control architecture according to various example embodiments, to program a synaptic memory cell 704c, its corresponding memory cell column 708 may be provided with a high voltage, and its corresponding input activation line 716 (which is at the drain side) may be provided with a ground or a low voltage, and its corresponding sensing line (e.g., source line) 718 may be floated. On the other hand, the non-selected row's input activation line 716 may be provided with a medium voltage. The non-selected memory cell column 708 may be grounded or at a low voltage. In this example manner, only the selected synaptic memory cell 704c is supposed to strong enough electrical field between the control gate and the synaptic memory cell's channel, and thus will result in a transfer of charge to the floating gate due to quantum tunneling effect, and thus implement programming.

Accordingly, the flash cell programming operations may be considered SET operations, where the flash cell's conductance essentially increases. The erase operation in the flash cells may be considered RESET operations, where the flash cell's conductance essentially decreases to a low value. With the column-based control architecture according to various example embodiments, the flash-based erase operation can be performed with ease, and more particular, based on a column-based erase signal voltage for performing the erase operation on a column-wise basis.

FIG. 7D depicts a schematic drawing of an example improved neural processing core 700d (flash memory-based) over the example neural processing core 700c shown in FIG. 7C, according to various example embodiments of the present invention. In particular, various example embodiments note that, for the example neural processing core 700c shown in FIG. 7C, when programming the flash memory-based synaptic memory cell 704c, because the control gates of the selected memory cell column 708 are connected to the column-wise control signal which is usually a high voltage (e.g., about 10V), this may cause the flash memory cell transistor's channel to be highly conductive, and hence may cause high current to flow amongst the flash memory cells 704c on the selected memory cell column 708. To address this potential issue, various example embodiments provide an improved neural processing core 700d as shown in FIG. 7D. Compared to the neural processing core 700c shown in FIG. 7C, the improved neural processing core 700d further comprises, for each synaptic memory cell 704d, an additional access or select transistor (a normal or standard transistor 742 (i.e., not of the flash memory type)) may be added to the source side of the flash memory transistor 741 of the synaptic memory cell 704d. The additional access or select transistors 742 of the synaptic memory cells 704d are controlled in a row-based (row-wise) manner instead of a column-based (column-wise) manner. In various example embodiments, when programming a synaptic memory cell 704d on a selected memory cell column 708, the gates of all the additional access or select transistors 742 of the synaptic memory cells 704d in the synaptic memory array 702d are applied with a sufficiently low voltage (e.g., via Row_SEL₀ or Row_SEL₁ in FIG. 7D) that will turn off these transistors (e.g. about 0V or even lower). Then, this will advantageously prevent static current flowing in any of the synaptic memory cells 704d in the synaptic memory array 702d, and reduce power consumption during programming. This will also ensure that the source side of all synaptic memory cells 704d in the synaptic memory array 702d will be kept in properly floating state instead of being influenced by the unintended current flowing amongst synaptic memory cells 704d on the same memory cell column 708. Therefore, the selected synaptic memory cell 704d will experience adequate electrical field for tunnelling based programming, while the non-selected synaptic memory cells 704d will not experience adequate electrical field for tunnelling based programming. During inference mode, the gates of all of the additional access or select transistors 742 of the synaptic memory cells 704d in the synaptic memory array 702d are applied with an On voltage (e.g., via Row_SEL₀ or Row_SEL₁ in FIG. 7D), so that the additional access or select transistors are turned on and adequately conductive. Although FIG. 7D shows a 1T1R memory array structure, it will be appreciated by a person skilled in the art that the above modification (i.e., addition of access or select transistors 742) may also be applied to other memory array structure described herein in the same or similar manner, such as but not limited to, 2T2R memory array structure. For example, a 2T2R memory array may be implemented by a 1T1R memory array by pairing every two memory cell rows and applying suitable first and second input activation voltages as described herein according to various example embodiments of the present invention.

As described hereinbefore, according to various embodiments of the present invention, neural processing core may be configured to operate in voltage mode sensing as an alternative to current mode sensing. For example, in various embodiments, the synaptic memory array 702a, 702b, 702c, 702d may operate in voltage mode sensing instead of current mode sensing described above. For example, in various example embodiments, for performing inference on the synaptic memory array 702a, the first sensing line 718 connected to the selected memory cell column 708 may be floated; and a plurality of first input activation signals may be sent or applied to the plurality of input activation lines 716 associated with the plurality of memory cell rows 706, respectively. In various example embodiments, for performing a write operation on a selected synaptic memory cell 704a of the synaptic memory array 702a, a column-wise control signal may be sent to the control line 728 associated with the memory cell column 708 which the selected synaptic memory cell 704a belongs to; a predetermined ground voltage may be applied to the first sensing line 718 associated with the memory cell column 708 which the selected synaptic memory cell 704a belongs to; and a first programming signal (as the first input activation signal) may be sent to the first input activation line 716 associated with the memory cell row 706 which the selected synaptic memory cell 704a belongs to.

For voltage mode sensing, instead of biasing the sensing line (e.g., source line) at ground or virtual ground (which is usually achieved through use of TIA) as performed in current mode sensing, the sensing line (e.g., source line) is kept floating. Upon stabilization, the output voltage at the sensing line can also represent the weighted sum of a neural network layer, but is further scaled down by the sum of conductance of the synaptic memory cells on the corresponding memory cell column. More specifically, the output voltage at the sensing line may be expressed as

$${V}_{out} = \frac{{\sum }_{i} {V}_{i} {G}_{ij}}{{\sum }_{i} {G}_{ij}} ,$$

where Vᵢ is input activation voltage for row i, and Gᵢⱼ is the conductance of memristor at i^{th} row and j^{th} column representing synaptic weight of the corresponding position of the weight matrix, and the division scaling factor is Li Gᵢⱼ. In various example embodiments, this scaling factor may be compensated for after ADC conversion, in the digital domain, by multiplying with a pre-stored sum of the conductance (ΣᵢGᵢⱼ) of the synaptic memory cells of the memory cell column's from a digital storage (instead of analog memory).

### 2T2R Array Architecture

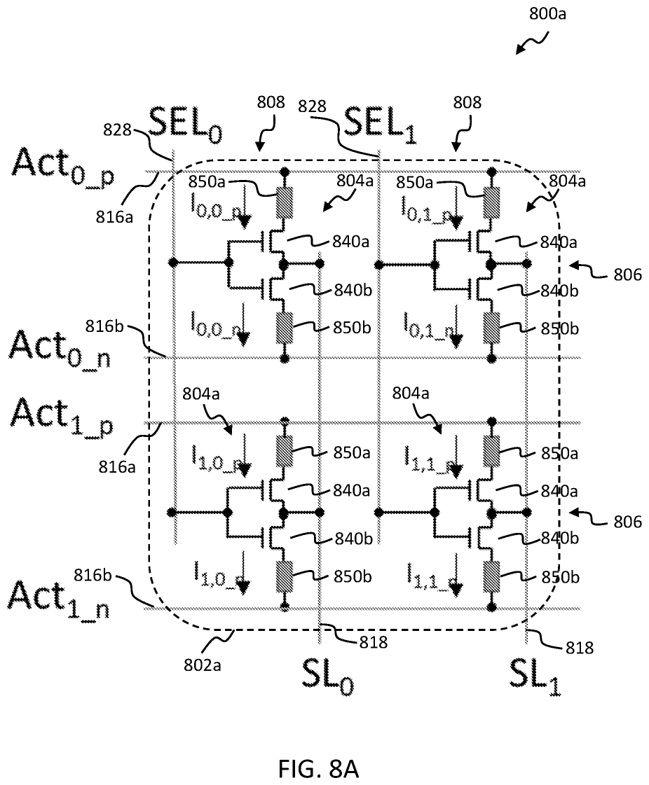

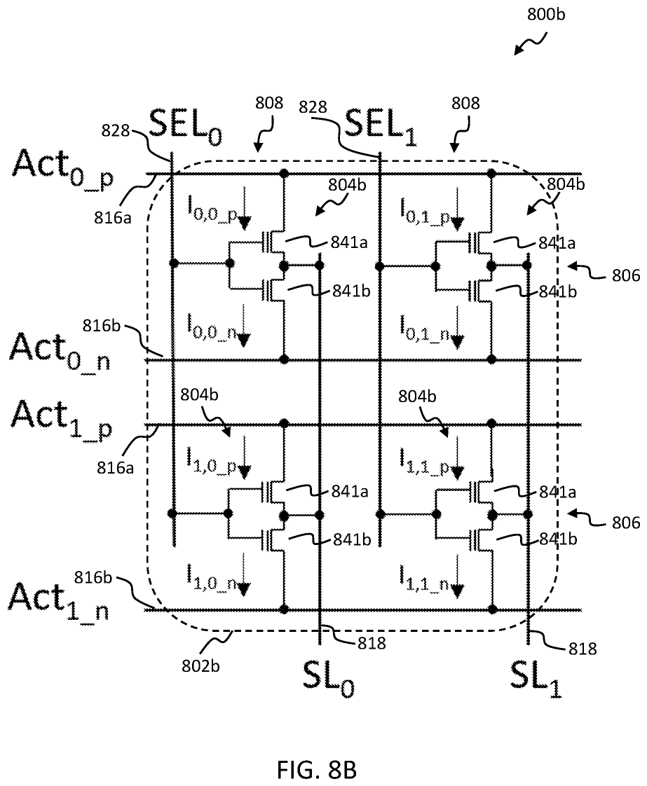

FIG. 8A depicts a schematic drawing of an example neural processing core 800a comprising a synaptic memory array 802a having a 2T2R array architecture, according to various example embodiments of the present invention. It will be appreciated by a person skilled in the art that for simplicity and clarity, the 2T2R array structure is illustrated in FIG. 8A simply as having a dimension of 2×2. However, it will be appreciated by a person skilled in the art that the 2T2R array structure may have any dimension as desired or as appropriate. The example neural processing core 800a is the same or similar as the example neural processing core 700b except that the neural processing core 800a further comprises a plurality of second input activation lines 816b connected to the plurality of memory cell rows 806, respectively, of the synaptic memory array 802a and configured to receive a plurality of second input activation signals, respectively, to the plurality of memory cell rows 806, and that for each of the synaptic memory cells 804a of the synaptic memory array 802a, the synaptic memory cell 804a further comprises a second access transistor 840b and a second memristor 850b. Accordingly, the above-mentioned plurality of input activation lines 716, the above-mentioned access transistor 740 and the above-mentioned memristor 750 described above for the 1T1R array architecture may thus correspond to a plurality of first input activation lines 816a, a first access transistor 840a and a first memristor 850a, respectively, with respect to the example neural processing core 800a shown in FIG. 8A.

As shown in FIG. 8A, for each of the plurality of memory cell rows 806, the synaptic memory cells 804a of the memory cell row 806 are each connected to the second input activation line 816b associated with the memory cell row 806. Furthermore, the first memristor 850a and the second memristor 850b form a first pair of memristors of the synaptic memory cell 804a.

As shown in FIG. 8A, in the same manner as the first access transistor 840a, a gate of the second access transistor 840b of the synaptic memory cell 804a is connected to the control line 828 associated with the memory cell column 808 which the synaptic memory cell 804a belongs to for receiving the column-wise control signal for the memory cell column 808 for controlling an operating state (e.g., on or off state) of the second access transistor 840b. In this regard, the gates of the first and second access transistors 840a, 840b may thus form a common node connected to the control line 828. The first memristor 850a of the synaptic memory cell 804a is connected to and between the first access transistor 840a of the synaptic memory cell 804a (to the drain side of the first access transistor 840a) and the first input activation line 816a associated with the memory cell row 806 which the synaptic memory cell 804a belongs to. The second memristor 850b of the synaptic memory cell 804a is connected to and between the second access transistor 840b of the synaptic memory cell 804a (to the drain side of the second access transistor 840b) and the second input activation line 816b associated with the memory cell row 806 which the synaptic memory cell 804a belongs to.

In various example embodiments, for each of the plurality of memory cell rows 806, the first and second input activation lines 816a, 816b connected to the memory cell rows 806 may be a positive input activation line 816a for receiving and feeding a positive input activation and a negative input activation line 816b for receiving and feeding a negative input activation, respectively. For example, such a synaptic memory cell (i.e., 2T2R cell) 804a may be configured to represent or store a signed synaptic weight.

Various example operations that may be performed by the example neural processing core 800a comprising the synaptic memory array 802a having the 2T2R array architecture will now be described according to various example embodiments of the present invention, including inference operations and write operations (e.g., SET or RESET operations). In this regard, various example operations that may be performed by the example neural processing core 800a may be the same or similar as those described above for the example neural processing core 700a/700b except that the same or corresponding operations may also be performed on the plurality of second input activation lines 816b, the second access transistor 840b and the second memristor 850b.

For performing inference on the synaptic memory array 802a, in various example embodiments, corresponding to the plurality of first input activation signals 816a that may be sent to the plurality of first input activation lines 816a associated with the plurality of memory cell rows 806, respectively, a plurality of second input activation signals may also be sent to the plurality of second input activation lines 816b associated with the plurality of memory cell rows 806, respectively. For example, during inference, all input activation lines 816a, 816b may be fed with voltages that correspond to input activations of a neural network (e.g., a DNN). For example, when operating on a memory cell column j 808, only the control line 828 associated with the memory cell column j 808 may be fed with a column-wise control signal (On voltage (SELⱼ)) for turning on all synaptic memory cells 804a in the memory cell column j 808. In addition, during inference, a virtual ground voltage (V_{SL}) may be applied to the corresponding source line (SLⱼ) 818, which for example may be 0.5V for 1V V_{dd} or 0V (but may require negative input activation to be physically negative voltage accordingly).

In various example embodiments, for improving operation during inference, the source line 818 may be biased at a designated virtual ground level instead of 0V (e.g., the virtual ground voltage may be set to V_{dd}/2, where V_{dd} is the core transistor supply voltage). If so, the positive and negative activation voltages (Act_{i_p} and Act_{i_p}) may then be referenced against this virtual ground level (V_{dd}/2) instead of 0V. It is also possible to set the virtual ground level as 0V. However, if so, the negative input activation voltages (Act_{i_n}) would have to be significantly negative with respect to 0V for proper operation during inference.

For programming or performing a write operation on a selected synaptic memory cell 804a of the synaptic memory array 802a, in various example embodiments, a column-wise control signal may be sent (or fed) to the control line 828 associated with the memory cell column 808 which the selected synaptic memory cell 804a belongs to. In addition, a predetermined ground voltage (e.g., 0V or a virtual ground voltage) may be applied to the sensing line 818 associated with the memory cell column 808 which the selected synaptic memory cell 804a belongs to. Furthermore, a first programming signal may be applied as the first input activation signal to the first input activation line 816a associated with the memory cell row 806 which the selected synaptic memory cell 804a belongs to, and a second programming signal may be applied as the second input activation signal to the second input activation line 816b associated with the memory cell row 806 which the selected synaptic memory cell 804a belongs to. In this regard, in various example embodiments, one of the first and second programming signals is a programming signal (an input activation voltage) for setting a conductance state of the corresponding memristor of the first and second memristors of the selected synaptic memory cell 804a and the other one of the first and second programming signals is a predetermined ground voltage (e.g., 0V or a virtual ground voltage) or no signal (e.g., not applied) with the corresponding input activation line being floated (i.e. the corresponding input activation line is floated and thus, no signal is needed to be applied thereto), based on a polarity of a synaptic weight value to be stored by the selected synaptic memory cell 804a. For example, if the polarity of the synaptic weight value to be stored by the selected synaptic memory cell 804a is positive, the first programming signal is a programming signal (an input activation voltage) for setting a conductance state of the corresponding memristor. On the other hand, if the polarity of the synaptic weight value to be stored by the selected synaptic memory cell 804a is negative, the second programming signal is a programming signal (an input activation voltage) for setting a conductance state of the corresponding memristor.

For example, in various example embodiments, to program a selected synaptic memory cell 804a in a memory cell column j 808, the gate of the selected synaptic memory cell 804a in the memory cell column j 808 are turned on with an On voltage (SELⱼ) (the column-wise control signal) applied to the control line 828 associated with the selected memory cell column j 808. For a SET operation, the input activation line associated with the memory cell row i 806 which the selected synaptic memory cell 804a belongs to and that corresponds to the polarity of the input activation signal for setting the conductance state of the corresponding memristor may be set to a high voltage (e.g., V_{prog}) (e.g., if synaptic weight is positive, the first memristor 850a for positive portion is set (e.g., based on V_{prog}) while the memristor 850b for negative portion may not be set so as to minimize power consumption), and the source line (SLⱼ) 818 associated with the memory cell column j 808 may be set to a low voltage (e.g., 0V). For the SET operation, since the memristors are each connected to the drain side of the respective access transistor, no source degeneration occurs. For a RESET operation, the source line (SLⱼ) 818 associated with the memory cell column j 808 may be set to a high voltage (e.g., V_{prog}) and the input activation lines 816a, 816b may be set to a low voltage (e.g., 0V). For the RESET operation, since the memristors are each connected to the drain side of the respective access transistor, source degeneration may occur and may thus require a higher gate voltage as described hereinbefore according to various example embodiments.

For the non-selected memory cell rows 806, the input activation lines 816a, 816b associated with the non-selected memory cell rows may be set to floating so as not to alter the states of the corresponding non-selected cells. For the non-selected memory cell columns 808, the corresponding source lines 818 may be set to any voltage that does not alter the states of the non-selected synaptic memory cells 804a.

In various example embodiments, when verifying the write operations (e.g., SET or RESET operations), the input activation lines of non-selected memory cell rows are set to floating rather than 0V. In this regard, various example embodiments note that with the column-wise control signals (i.e., column-wise control of the synaptic memory cells of the synaptic memory array), a memory cell column is entirely turned on or off. For example, if the voltage of the input activation lines (Actᵢ) of non-selected memory cell rows deviate even just slightly, cumulatively this may inject sufficient unwanted current from the synaptic memory cells in the same selected memory cell column but in the non-selected memory cell rows (i.e., non-selected synaptic memory cells in the same memory cell column as the selected synaptic memory cell), while reading the current of the selected synaptic memory cell. For example, if Actᵢ of non-selected memory cell rows is meant to be set to 0V instead of floating, and if a read/verify operation on a selected memory cell row requires its Actᵢ to be 0V, but in reality all the non-selected rows deviate from their intended Actᵢ (i.e., 0V) systematically by just 0.001V, then assuming similar weight values on the same memory cell column, on average, this very slight voltage deviation would introduce 256×0.001V/1V=25.6% deviation in output current for reading on a 256×256 array.

FIG. 8B depicts a schematic drawing of an example neural processing core 800b comprising a synaptic memory array 802b having a 2T2R array architecture, according to various example embodiments of the present invention. The example neural processing core 800b is the same or similar as the example neural processing core 700c except that the neural processing core 800b further comprises a plurality of second input activation lines 816b connected to the plurality of memory cell rows 806, respectively, of the synaptic memory array 802b and configured to receive a plurality of second input activation signals, respectively, to the plurality of memory cell rows 806, and that for each of the synaptic memory cells 804b of the synaptic memory array 802b, the synaptic memory cell 804b further comprises a second access transistor 841b. Accordingly, the above-mentioned plurality of input activation lines 716 and the above-mentioned access transistor 741 described above for the 1T1R array architecture may thus correspond to a plurality of first input activation lines 816a and a first access transistor 841a, respectively, with respect to the example neural processing core 800b shown in FIG. 8B. The neural processing core 800b is also the same as the example neural processing core 800a except that the neural processing core 800b is flash memory-based instead of memristor-based (i.e., the synaptic memory cells 804b are flash memory cells (which may simply be referred to as flash cells)).

As shown in FIG. 8B, for each of the plurality of memory cell rows 806, the synaptic memory cells 804b of the memory cell row 806 are each connected to the second input activation line 816b associated with the memory cell row 806. For each of the synaptic memory cells 804b of the synaptic memory array 802b, the synaptic memory cell 804b further comprises a second access transistor 841b comprising a control gate and a floating gate, whereby the control gate of the second access transistor 841b is connected to the control line 828 associated with the memory cell column 808 which the synaptic memory cell 804b belongs to for receiving the column-wise control signal for the memory cell column 808 for controlling an operating state (e.g., on or off state) of the second access transistor, a source of the second access transistor 841b is connected to the first sensing line 818 associated with the memory cell column 808 which the synaptic memory cell 804b belongs to and a drain of the second access transistor 841b is connected to the first input activation line 816 associated with the memory cell row 806 which the synaptic memory cell 804b belongs to. Accordingly, the first access transistor 841a and the second access transistor 841b form a first pair of access transistors of the synaptic memory cell 804b and the control gates of the first and second access transistors 841a, 841b may thus form a common node connected to the control line 828.

It will be appreciated by a person skilled in the art that various operations (e.g., inference operations and write operations (e.g., SET or RESET operations)) may be performed on the example neural processing core 800b in the same or similar manner as described above for the example neural processing core 700c, 800a and thus need not be repeated for clarity and conciseness.

For voltage mode sensing for 2T2R cell, although the sensing line may be kept floating, the input activation line may still be driven using an encoding similar to the current sensing mode, where Act_{i_p}=V_{ref}+xᵢ, and Act_{i_n}=V_{ref}−xᵢ, where xᵢ is the input activation or its constant scaled version to ensure that activation voltages fall within feasible operating range. In this regard, the output voltage at the sensing line may be expressed as

$${V}_{out} = \frac{{\sum }_{i} ( {Act}_{i \_ p} {G}_{ij \_ pos} + {Act}_{i \_ n} {G}_{ij \_ neg} )}{{\sum }_{i} ( {G}_{ij \_ pos} + {G}_{ij \_ neg} )} = {V}_{ref} + \frac{{\sum }_{i} ( {x}_{i} {W}_{ij} )}{{\sum }_{i} ( sgn ( {W}_{ij} ) {W}_{ij} + 2 {G}_{ref} )} ,$$

where Wᵢⱼ is the synaptic weight (or its properly constant scaled version to ensure cell conductance falls within feasible operating range) of the weight matrix at i-th row and j-th column, and G_{ref} is the reference (usually minimum) conductance in the memristor. Therefore, with respect to V_{ref}, the output voltage at sensing line is still proportional to the weighted sum Σᵢ(xᵢWᵢⱼ), and with a division scaling factor of Σᵢ(sgn(Wᵢⱼ) Wᵢⱼ+2G_{ref}), where sgn( ) denotes the sign function. If different reference conductance G_{ref,i} is used for row i within a column, then the division scaling factor will instead become Σᵢ(sgn(Wᵢⱼ) Wᵢⱼ+2G_{ref,i}). If the weight matrix is too large to fit on a single synaptic memory array of a neural processing core, then the memory cell columns can be partitioned and assigned to different neural processing cores in a straight-forward manner, whereas the memory cell rows can be partitioned and assigned to different neural processing cores also, but each neural processing core must compute a partial weighted sum by multiplying the division scaling factor Σᵢ(sgn(Wᵢⱼ)Wᵢⱼ+2G_{ref}) for those weights on the corresponding neural processing core, and then all the partial weighted sums can be aggregated together to derive the final weighted sum.

The voltage mode sensing does not require a TIA, for example, because the need to keep the sensing line at ground or virtual ground is avoided. Accordingly, by implementing the column-wise control according to various example embodiments of the present invention, leaking current can be avoided or minimized and energy-efficient column-based time-multiplexing can also be achieved for voltage mode sensing, with the added benefit of avoiding the overhead (both area and power/energy) of TIA(s) in the peripheral sensing circuit, which may thus be more energy efficient than the current mode sensing.

### Peripheral Sensing Circuit

Typically, high-resolution ADC may be required for memristive analog computing since using a low-resolution ADC would lead to loss of information, which significantly constrains the accuracy of the neural network hardware implementation. For example, for a simple 784-100-10 network on MNIST dataset (modified national institute of standards and technology database), the accuracy of the network drops significantly when the ADC resolution is less than 4-bit. On the other hand, conventional high-resolution architectures would consume a significantly large chip area. For example, assuming conventional 1T1R cells use 65 nm CMOS and analog ReRAM, the area for each synaptic memory cell may be 0.169 um², the peak power may be 1 uW, and the latency may be 10 ns. Now assuming that the chip area and power consumption for a bit-serial (i.e., single slope or S/S in abbreviation) ADC are 3000 um² and 0.2 mW, respectively, however, its latency is as long as 200 ns. Therefore, in conventional neural processing cores with conventional synaptic memory arrays (e.g., the conventional 1T1R array and 2T2R array shown in FIGS. 1 and 2), it is commonly/conventionally understood that the ADC is employed without time-multiplexing.

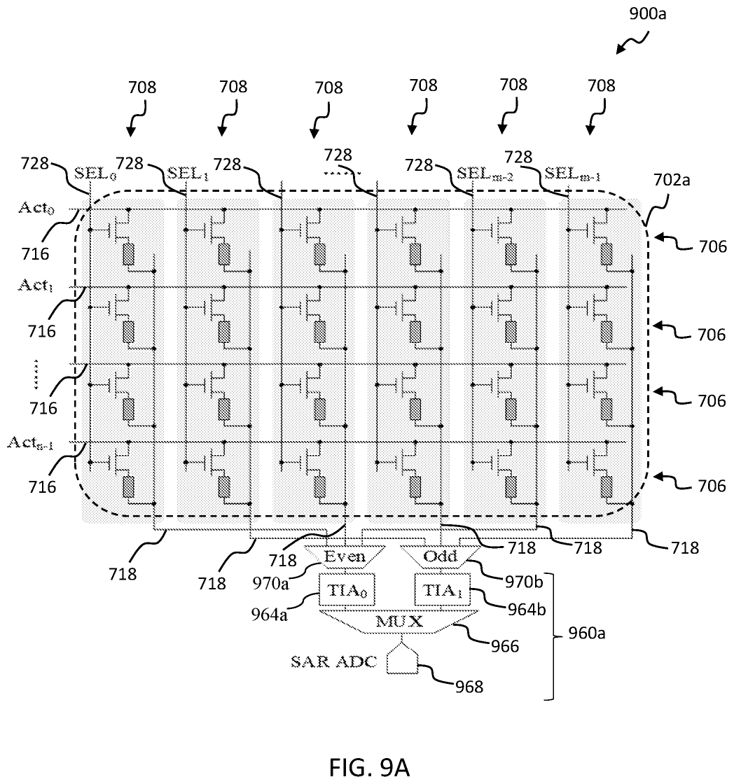

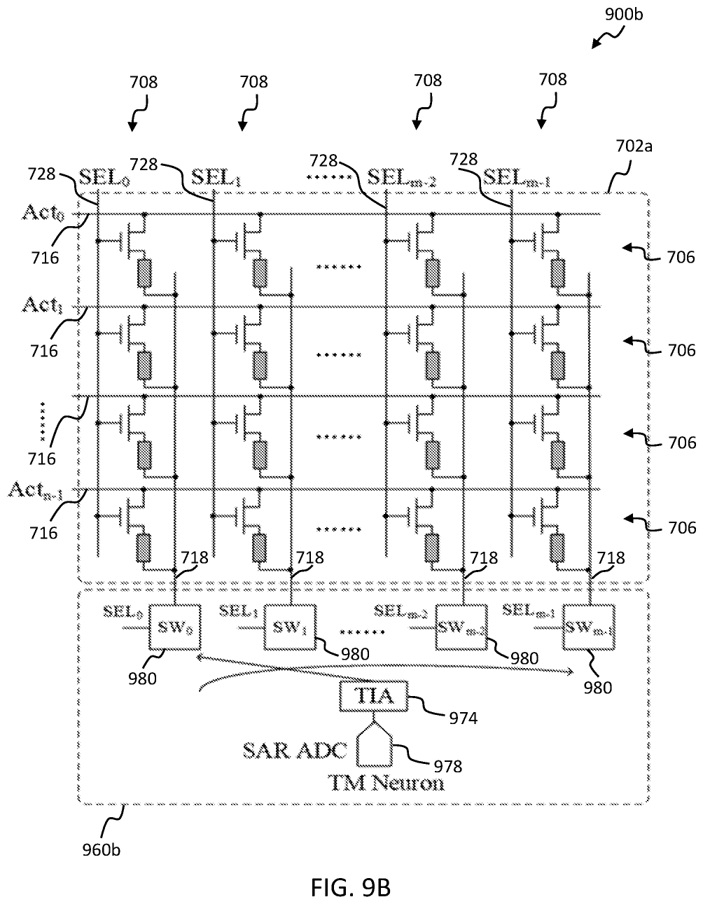

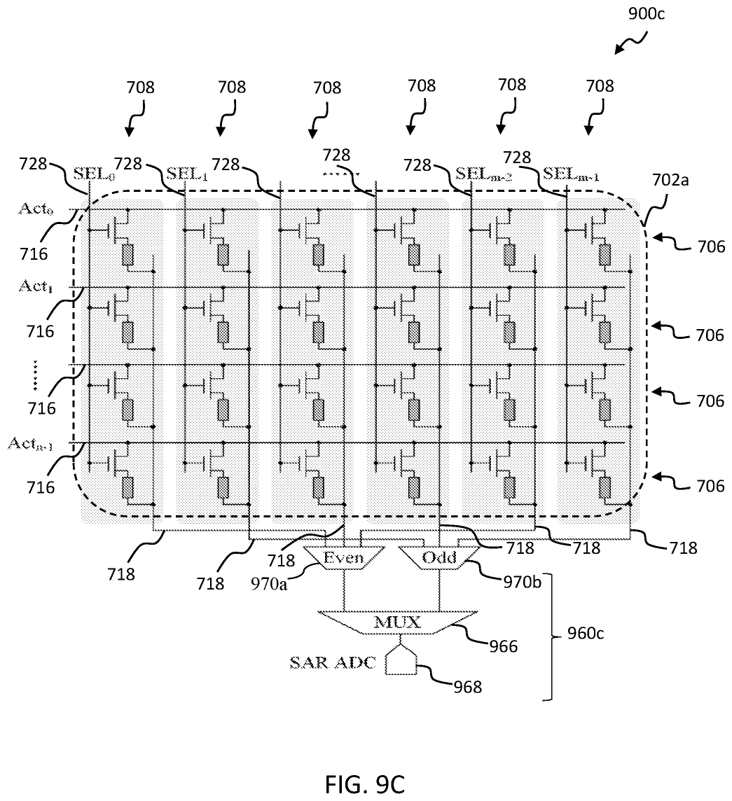

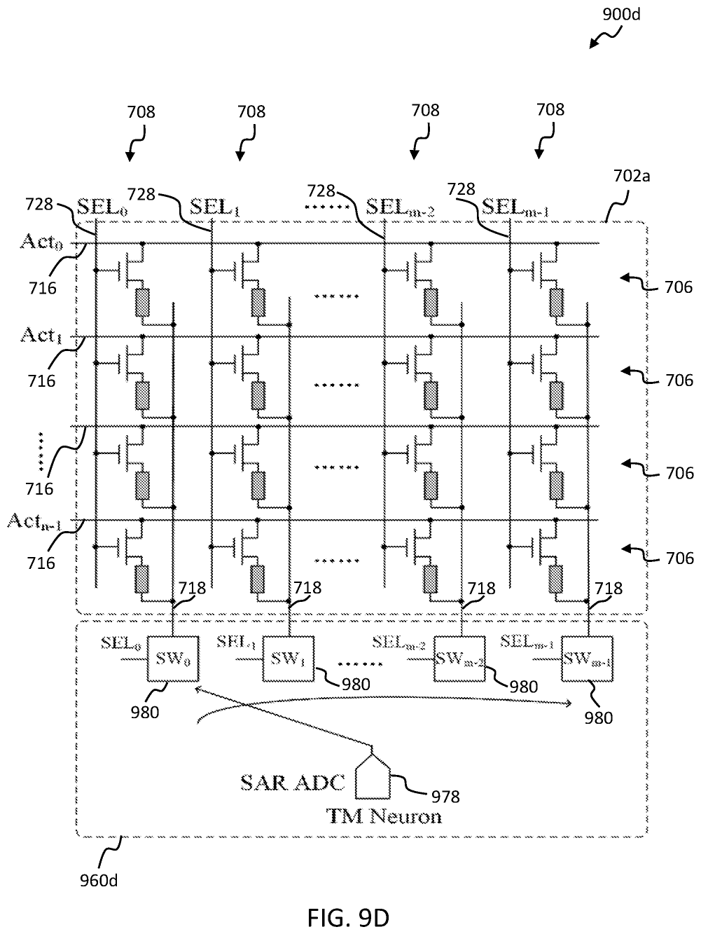

FIG. 9A depicts a schematic drawing of an example neural processing core 900a comprising the synaptic memory array 702a having a 1T1R array architecture as described hereinbefore with reference to FIG. 7A according to various example embodiments, but with an example peripheral sensing circuit 960a shown, according to various example embodiments of the present invention. It will be appreciated by a person skilled in the art that the peripheral sensing circuit 960a is not limited to being employed with the synaptic memory array 702a having the 1T1R array architecture, but may also be employed with synaptic memory arrays having other array architectures (e.g., synaptic memory array 702b, 702c, 702d, 802a, 802b and so on) as desired or as appropriate without going beyond the scope of the present invention.

The neural processing core 900a further comprises a peripheral sensing circuit 960a connected to the plurality of sensing lines 718 and configured to process the plurality of analog current signals from the plurality of memory cell columns 708, respectively, based on time multiplexing. In various embodiments, the peripheral sensing circuit 960a configured to process the plurality of analog current signals based on time multiplexing comprises processing the plurality of analog current signals from the plurality of memory cell columns 708, respectively, in turn (i.e., one column after another). Accordingly, the plurality of analog current signals from the plurality of memory cell columns 708, respectively, are processed by the peripheral sensing circuit 960a based on time multiplexing.

In various example embodiments, the peripheral sensing circuit 906a comprises: a plurality of current-to-voltage converters (e.g., transimpedance amplifiers (TIAs)) 964a, 964b (e.g., collectively or generally may be referred to as 964), each current-to-voltage converter 964 configured to convert each analog current from a corresponding group of memory cell columns 708 of the plurality of memory cell columns 708, in turn, to an analog voltage signal associated with the corresponding group of memory cell columns 708; an analog multiplexer 966 configured to select one output amongst outputs of the plurality of current-to-voltage converters 964 and forward the selected output; and an ADC 968 connected to the analog multiplexer 964 and configured to digitize the analog voltage signal from the selected output by the analog multiplexer 966. In this regard, each of the plurality of current-to-voltage converters 964 is shared amongst the corresponding group of memory cell columns 708 for processing the analog current signals from the corresponding group of memory cell columns 708, and the ADC 968 is thus shared amongst the plurality of memory cell columns 708.

In various example embodiments, the neural processing core 900a is configured to control the current-to-voltage converter 964 which produced the selected output to continue to operate past a column time-multiplexing cycle period based on the ADC 968 taking longer than the column time-multiplexing cycle period to latch-in the analog voltage signal from the selected output.

Accordingly, for example, the peripheral sensing circuit 906a shown in FIG. 9A is a time-multiplexing peripheral sensing circuit with time-multiplexing TIAs 964 and ADC 968. For example, in various example embodiments, the plurality of groups of memory cell columns 708 may include a first or even group and a second or odd group of memory cell columns 708, where two TIAs 964a, 964b (e.g., for the first/even group and the second/odd group, respectively) may be employed along with a 2:1 MUX 966. In various example embodiments, a plurality of TIAs 964 may be employed when the TIA output voltage latch-in to the ADC 968 takes longer than the desired or predetermined column time-multiplexing cycle time.

By way of an illustrative example and without limitation, a 9-bit 100 MS/s SAR ADC whose area and power consumption are 13,000 um² and 1.2 mW may be used to implement the ADC 968. Furthermore, TIAs each with 2000 um² and 0.5 mW may be used to implement the TIAs 964 to provide input to the ADC, and the latency of the TIA is 10 ns. In this regard, to enhance/reduce the latency of the neural processing core 900a, as shown in FIG. 9 according to various example embodiments, each ADC 968 may share two TIAs 964a, 964b, a pair of multiplexers (e.g., even MUX 970a and odd MUX 970b) (e.g., collectively or generally may be referred to as 970), and a 2:1 multiplexer 966. The area of the multiplexers associated with the synaptic memory array 702a (e.g., with a dimension of 256×256) is assumed to be 3000 um².

By way of an illustrative example and without limitation, during an example computing process, in the first 10 ns, the even MUX 970a is turned on, SEL₀ is turned on and the first (0th) memory cell column 728 generates results as a current signal, which is passed by the even MUX 970a to TIA₀ 964a which then converts the current signal received to a voltage signal. The 2:1 MUX 966 is controlled to select the output of TIA₀ 964a to feed to the ADC 968, and at the end of the first 10 ns, the ADC 968 latches the output voltage from TIA₀ 964a to start the analog to digital (A/D) conversion. In the second 10 ns, the odd MUX 970b is turned on, SEL₁ is turned on, and TIA₁ 964b converts the current signal received to a voltage signal. The 2:1 MUX 966 now selects the output voltage from the TIA₁ 964b to feed to the ADC 968, and at the end of the second 10 ns, the ADC 968 latches the output voltage from TIA₁ 964b to start the A/D conversion. In the third 10 ns, the even multiplexer 970a is turned on, SEL₂ is turned on, the 2:1 MUX 966 selects the output voltage from TIA₀ 964a and at the end of the third 10 ns, the ADC 968 latches the output voltage from TIA₀ 964a, which is from the third memory cell column shown in FIG. 9A (i.e., column ‘2’ counting from column ‘0’) and begins the A/D conversion. The 2:1 MUX 966 then switches over to TIA₁ 964b which starts to convert the current signal from the fourth memory cell column (column ‘3’) to a voltage signal, and so forth. For example, it may be assumed that the memory cell column current stabilization and the TIA output voltage stabilization occur within the same 10 ns. Therefore, for an array having ‘m’ number of memory cell columns and one ADC, the latency of such an array would be (m+1)×10 ns.

Accordingly, the even/odd TIA arrangement/configuration shown in FIG. 9A is particularly useful if the ADC 968 takes a relatively long time to latch-in the voltage from the TIA 964. Therefore, in various example embodiments, if the latch-in cannot be completed by the end of a 10 ns cycle, the TIA (e.g., the even TIA 964a) whose output is still being latched can continue to operate for slightly past 10 ns, while the other TIA (e.g., the odd TIA 964b) can start with its column sensing immediately after the end of the previous 10 ns cycle. Once the latching of the output of the even TIA 964a into the ADC 968 is completed, the even TIA 964a may then be turned off to save power. At the next cycle, the same process/procedure is then applied for the odd TIA 964b, and so forth (e.g., repeatedly alternating between the even and old TIAs 964a, 964b). In this regard, during the overlapping time when both the even and odd TIAs 964a, 964b are on, power consumption will be slightly higher, as two memory cell columns and two TIAs are on. It will be appreciated by a person skilled in the art that the group of plurality of groups of memory cell columns 708 is not limited to being arranged/partitioned into even and old groups of memory cell columns, and that more than two groups of memory cell columns 708 (along with more than two corresponding TIAs) may be arranged/partitioned as desired or as appropriate, for example, based on the processing speed of the ADC. For example, more groups of memory cell columns 708 may be configured if the ADC 968 is very fast, while the TIA stabilization time is comparatively long, although at the expense of occupying more chip area and higher peak power with more number of TIAs per array.

In various example embodiments, if the latch-in process is fast enough and can complete within a desired or predetermined cycle (e.g., by the end of every 10 ns in the above example), then a single TIA for the synaptic memory array 702a may be employed instead of having multiple (e.g., even/odd TIAs) as described above with reference to FIG. 9A. In this regard, FIG. 9B depicts a schematic drawing of an example neural processing core 900b comprising the synaptic memory array 702a having a 1T1R array architecture as described hereinbefore with reference to FIG. 7A according to various example embodiments. In particular, the neural processing core 900b is the same or similar as the neural processing core 900a described above with reference to FIG. 9A except that the example peripheral sensing circuit 960a of FIG. 9A is replaced with an example peripheral sensing circuit 960b according to various example embodiments of the present invention. Similarly, it will be appreciated by a person skilled in the art that the peripheral sensing circuit 960b is not limited to being employed with the synaptic memory array 702a having the 1T1R array architecture, but may also be employed with synaptic memory arrays having other array architectures (e.g., synaptic memory array 702b, 702c, 702d, 802a, 802b and so on) as desired or as appropriate without going beyond the scope of the present invention.

In various example embodiments, the peripheral sensing circuit 960b comprises: a current-to-voltage converter (e.g., transimpedance amplifiers (TIAs)) 974 configured to convert each of the plurality of analog currents from the plurality of memory cell columns 708, in turn, to an analog voltage signal; and an ADC 978 connected to the current-to-voltage converter 974 and configured to digitize the analog voltage signal received from the current-to-voltage converter 974. In this regard, the current-to-voltage converter 974 and the ADC 978 are each shared amongst the plurality of memory cell columns 708 for processing the plurality of analog current signals from the plurality of memory cell columns 708, respectively. In this regard, according to various example embodiments, each of the plurality of analog currents from the plurality of memory cell columns 708 may be converted, in turn, by the current-to-voltage converter 974 to an analog voltage signal, and the analog voltage signal received from the current-to-voltage converter 974 may then be digitized using the ADC 978 into a digitized voltage signal. In FIG. 9B, the switches (SW₀ to SWₘ₋₁) 980 illustrate an example of how the function of an analog multiplexer may be implemented as a collection of single line analog switches, whose output is disconnected from its input if and only if its control signal SELᵢ is Off. For example, the control or select (SEL) signals may be generated by a decoder circuit (such as 256-output decoder for an 8-bit address input). In various example embodiments, the single-line switch 980 may be implemented as a transmission gate.

As described above, in various example embodiments, if the latch-in process is fast enough and can complete within a desired or predetermined cycle (e.g., by the end of every 10 ns in the above example), then a single TIA 974 for the synaptic memory array 702a may be employed for processing the analog currents from the plurality of memory cell columns 708 as shown in FIG. 9B. With the peripheral sensing circuit 960b, the latch-in process may start earlier than the very end of every 10 ns, to allow the TIA output stabilization and the ADC latch-in to occur at the same time and thus save in overall elapsed time needed to complete each memory cell column sensing. Accordingly, for the neural processing core 900b, only 1 TIA 974 may be employed if the TIA output voltage latch-in process to the ADC 978 is fast enough to meet the desired or predetermined column time-multiplexing cycle time, thereby significantly reducing the chip area required.

The example peripheral sensing circuits 960a, 960b shown in FIGS. 9A and 9B, respectively, have been described above with respect to current mode sensing. As explained hereinbefore, the present invention is not limited to a specific type of sensing mode, and the neural processing core may operate, or be configured to operate, in current mode sensing or voltage mode sensing as desired or as appropriate. For example, FIGS. 9C and 9D depict schematic drawings of example neural processing cores 900c, 900d comprising example peripheral sensing circuits 960c, 960d, respectively, configured for voltage mode sensing. Accordingly, the neural processing cores 900c, 900d are the same as the neural processing cores 900a, 900b, respectively, except for the peripheral sensing circuits 960c, 960d. Accordingly, various components/modules/elements of the example neural processing cores 900c, 900d are the same or similar as those described above for the example neural processing core 900a, 900b, respectively, and are denoted by the same reference numerals in FIGS. 9C and 9D. Accordingly, the plurality of analog electrical signals from the plurality of memory cell columns 708 are a plurality of analog voltage signals.

For the neural processing cores 900c, as shown in FIG. 9C, the neural processing core 900c comprises a peripheral sensing circuit 960c connected to the plurality of sensing lines 718 and configured to process the plurality of analog voltage signals from the plurality of memory cell columns 708, respectively, based on time multiplexing. In this regard, the peripheral sensing circuit 960c comprises: a plurality of first analog multiplexers 970a, 970b, each first analog multiplexer configured to select one output (analog voltage signal) of a corresponding group of memory cell columns 708 of the plurality of memory cell columns 708, in turn; a second analog multiplexer 966 configured to select one output (analog voltage signal) amongst outputs of the plurality of first analog multiplexers 970a, 970b and forward the selected output (selected analog voltage signal); and an ADC 968 connected to the second analog multiplexer 966 and configured to digitize the analog voltage signal from the selected output by the second analog multiplexer 966. In this regard, each of the plurality of first analog multiplexers 970a, 970b is shared amongst the corresponding group of memory cell columns 708 for processing the analog current signals from the corresponding group of memory cell columns 708, and the second analog multiplexer 966 and the ADC 968 are each shared amongst the plurality of memory cell columns 708.

For the neural processing cores 900d, as shown in FIG. 9D, the neural processing core 900d comprises a peripheral sensing circuit 960d connected to the plurality of sensing lines 718 and configured to process the plurality of analog voltage signals from the plurality of memory cell columns 708, respectively, based on time multiplexing. In this regard, the peripheral sensing circuit 960d comprises an ADC 978 configured to digitize each of the plurality of analog voltage signals from the plurality of memory cell columns 708, in turn. In this regard, the ADC 978 is shared amongst the plurality of memory cell columns 708 for processing the plurality of analog voltage signals from the plurality of memory cell columns 708. Accordingly, for performing inference on the synaptic memory array 900d, each of the plurality of analog voltage signals from the plurality of memory cell columns 708 is digitized, using the ADC 978, in turn. In this regard, the ADC 978 receives each of the plurality of analog voltage signals from the plurality of memory cell columns 708 without via a current-to-voltage converter (e.g., without the current-to-voltage converter 974 of the peripheral sensing circuit 960b shown in FIG. 9B) since the analog electrical signals from the plurality of memory cell columns 708 are already analog voltage signals.

Unlike Spiking Neural Network (SNN) where the input activation is binary, in a DNN the input activation is generally either floating-point or multi-bit, the latter corresponding to quantized activations. To support multi-bit input activations, a multi-bit DAC (Digital-to-Analog Converter) may be used, where each DAC may feed one input activation line or one memory cell row. However, DACs are also power and area hungry components. For example, for memristor-based neural processing cores, as each DAC in the conventional approach/architecture needs to drive an entire row of memristive cells, according to the literature, a 6-bit 100 MS/s DAC (including OP-AMP based voltage buffer) capable of driving 256 cells may consume 60 mW and occupy around 390.6 um², which results in a power consumption of 60 mW×10 ns=600 pJ per 256 cells, or 2.344 pJ/cell, in contrast to the cell power consumption which may be estimated as 1 uW×10 ns=10 fJ/cell. That is, a very high 234.4:1 power consumption overhead of the memory cell row with respective to the cell power consumption.

In contrast, with the column-wise energy-efficient time-multiplexing approach according to various example embodiments of the present invention, for example, for memristor-based neural processing cores, the DAC and associated OP-AMP voltage buffer can be streamlined or configured to drive only one cell at a time, greatly reducing the above power consumption overhead compared to the above-mentioned conventional approach/architecture. For example, when input activation is aggressively quantized, as in the case of quantization-aware training, for example, if 4-bit input activation is sufficient to support a small accuracy drop in the DNN, then 24=16 statically configured DACs may be used, and a 16:1 analog multiplexer (mux) can be used at each row to select one of the 16 DAC outputs and then feed to the OP-AMP voltage buffer. Hence, for an example 4-bit input activation and an example 256×256 crossbar array, the DAC saving for both area and power can be 256/16=16-fold compared to having a dedicated DAC per row. It will be appreciated by a person skilled in the art that the present invention is not limited to using a 4-bit DAC and other multi-bit DAC may be employed, such as but not limited to an example 6-bit DAC. For example, the example 6-bit DAC (with its two least significant bits set to 0) may be used because various example embodiments note that in quantization-aware training, the quantized activations are precise and have no error other than quantization error, whereas a DAC's resistor ladder is not 100% precise, so adding a number of more bits but using only the top or most significant bits has advantageously been found to reduce errors in input activation voltage.

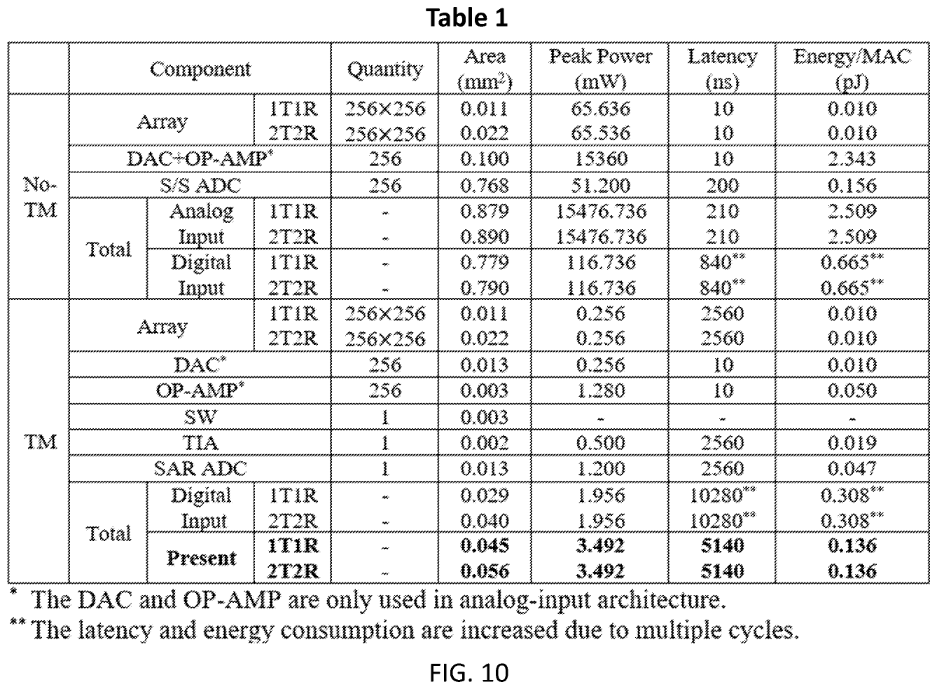

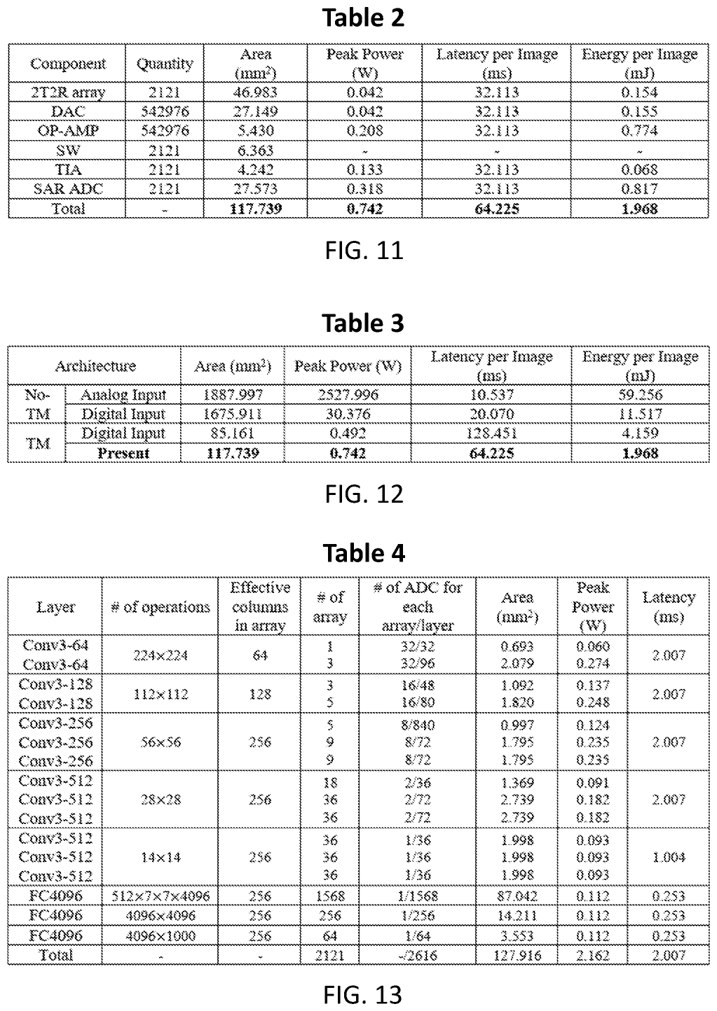

In various example embodiments, the OP-AMP voltage buffer may also be streamlined or configured to support only one cell at a time. However, due to the need to cater to the highest cell power, e.g., when the cell is in the Low Resistance State (LRS), the OP-AMP voltage buffer's power consumption has to match the highest cell power instead of the average cell power. As an illustrative example, in the time-multiplexing architecture according to various example embodiments, the DAC (excluding the OP-AMP voltage buffer) is assumed to be 100 MS/s and consume 1 uW and occupy 50 um² (per row), and the OP-AMP voltage buffer is assumed to consume 5 uW and occupy 10 um² (per row), while the ADC is assumed to be 100 MS/s and consume 1.2 mW power and occupy 13000 um², and the TIA is assumed to be 100 MS/s and consume 0.5 mW power and occupy 2000 um². In comparison, in the conventional architecture, the DAC (including the OP-AMP voltage buffer) is assumed to be 100 MS/s and consume 60 mW and occupy 390.6 um² (per row), and a smaller but slower single-slope (S/S) ADC (including the TIA) is assumed to be used and consume 0.2 mW with 200 ns or 5 MS/s speed and occupy 3000 um² (per column). These illustrative assumptions are used in Tables 1 and 2 shown in FIGS. 10 and 11, respectively.

FIG. 10 shows a Table (Table 1) showing energy and area estimation comparisons between conventional architectures and present architectures according to various example embodiments for a 256×256 array (1T1R/2T2R) with a 4-bit input. For example, as can be seen in Table 1, since the conventional analog-input, no time-multiplexing (no-TM) architecture (1T1R/2T2R) computes all memory columns simultaneously, the analog input circuits would consume significantly large power (15,360 mW) and energy (2.343 pJ per inference), which is extremely impractical for edge intelligence implementations. Analog input refers to using a DAC to generate analog input activation voltage, whereas digital input refers to the input activation line using a binary voltage hence avoiding the power-hungry DAC. In contrast, the input circuit of the present architecture (1T1R/2T2R) only consume 3.492 mW and 0.136 pJ per inference. The conventional digital-input architecture removes the DACs to avoid the substantial power consumption of the input circuits. However, multiple cycles are required to high-precision inputs, resulting in additional energy consumption and latency. For 4-bit input activations, the energy consumption for each MAC of the conventional architecture with analog input and no time-multiplexing is 2.509 pJ, for the conventional architecture with digital input and no time-multiplexing is 0.665 pJ, for the time-multiplexing architecture with digital input (a combination that may be plausible based on state-of-art literature but is rarely seen in practice) is 0.308 pJ, and for the present architecture is only 0.136 pJ. Therefore, it can be seen that the present architecture shows the best energy efficiency compared with other conventional architectures.

Moreover, per-column ADCs in no time-multiplexing architectures would consume substantial chip area. Take the conventional 1T1R analog-input, no time-multiplexing architecture as an example, there are more than 98.7% and 98.5% chip area consumed by the peripheral circuits with analog input and digital input, respectively, which will lead to overall a huge chip yet with uncompetitive memory storage capacity. Therefore, the chip area consumed by TIAs and ADCs can be saved significantly by sharing them with multiple columns in time-multiplexing architecture according to various example embodiments of the present invention. For example, in the present architecture according to various example embodiments, the DAC and OP-AMP can be designed with low power and occupy a small area since only one memory cell column may be computed or processed at a time. Moreover, for example, if every 256 columns share one ADC, the area consumed by peripheral circuits can be reduced significantly even though a single SAR ADC typically consumes more area. In the present architecture according to various example embodiments, the 1T1R architecture may have a total area of only 0.045 mm², thus saving around 19.53 times compared to the corresponding conventional architecture. Similarly, the total area of the 2T2R architecture according to various example embodiments is 0.056 mm², which is 15.89 times less than the corresponding conventional architecture with analog input.

Because the DAC and op-amp in the time-multiplexing architecture are tuned for driving one device only at 100 MS/s (i.e., 10 ns) in examples, and yet during row initialization (before column time-multiplexing starts), they may observe parasitic capacitance of a whole memory cell row of access transistors (e.g., 256 transistors), various example embodiments further assume that the initialization may take as long as multiplexing all 256 columns, which is 2570 ns. Hence, the latency of the present architecture according to various example embodiments may be determined as 2570×2=5140 ns, which is satisfactory for edge intelligence. Moreover, the latency can be reduced by increasing the number of ADCs for each synaptic memory array, taking into account the trade-off strategy (e.g., latency vs chip area).

FIG. 11 shows a Table (Table 2) showing the performance estimation for implementing VGG-16 with the present architecture (256×256 2T2R array and 8-bit ADCs), according to various example embodiments of the present invention. FIG. 12 shows a Table (Table 3) showing comparisons between the present architecture according to various example embodiments and other conventional architectures. It is assumed that the arrays used to implement the same layer can be computed in parallel. For the conventional analog-input architecture without time-multiplexing, the total area is 1887.997 mm², despite assuming a smaller but slower single-slope (S/S) ADC, while the array areas are only 46.983 mm². Accordingly, the total chip area is very large, most of which is consumed by the peripheral circuits. For example, due to size constraints of photomasks, a chip occupying the entire mask is usually limited to around 800 mm² (exemplified by some of the biggest GPU dies). For the conventional architecture with digital input and no time-multiplexing, the total area is reduced to 1675.911 mm². The time-multiplexing architecture with digital input (which as mentioned before is a combination that may be plausible based on state-of-art literature but is rarely seen in practice) has a minimum area of 85.161 mm². However, the multiple-cycle computing leads to additional latency and energy consumption. In the present architecture according to various example embodiments, if every 256 columns share one ADC, the area consumed by peripheral circuits can be reduced significantly even though a single faster ADC consumes more area. For example, the peripheral circuits consume 70.757 mm², the synaptic memory array consumes 46.983 mm², and the total area is 117.739 mm². Accordingly, compared with the conventional architecture with analog input, the area saving is more than 16 times and the chip area occupied by synaptic memory array and peripheral circuits is in the same order of magnitude.

In the conventional architectures with no time-multiplexing, whether analog input or digital input is used, up to 256 columns in each 256×256 array are computed at a time (i.e., simultaneously). Therefore, the peak power will be significantly high, especially for input circuits. As shown in Table 3 in FIG. 12, the total peak power of the conventional architecture with analog input and no time-multiplexing is as high as 2527.996 W which is impractical. Note that this estimation is already significantly reduced by considering that the Fully Connected (FC) layers can be calculated gradually instead of all at once. The conventional architecture with digital input may reduce the peak power significantly with increasing energy consumption, which is not ideal for edge intelligence. In contrast, with the present architecture according to various example embodiments, the synaptic memory cells of the synaptic memory array are controlled in a column-wise manner, e.g., only one memory cell column may be turned on in each synaptic memory array at a time. Therefore, the peak power can be efficiently reduced to 0.742 W. Furthermore, since the non-selected memory cell columns can be totally turned off, the present time-multiplexing architecture would not consume extra energy on non-selected memory cell columns. The latency in the present time-multiplexing architecture is acceptable since in this illustrative example, an SAR ADC with higher speed was adopted by sacrificing area moderately.

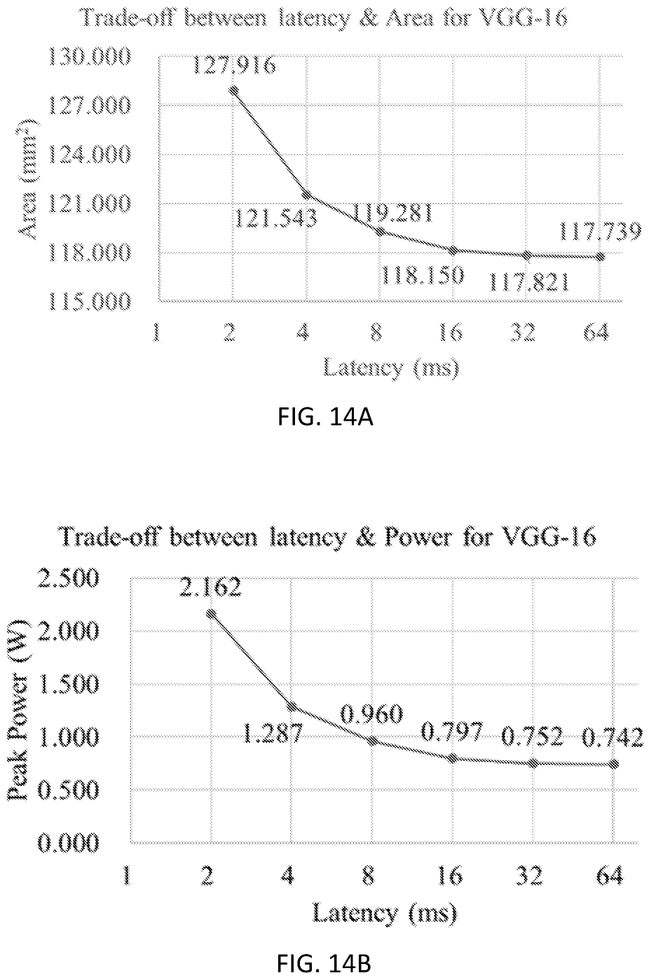

In various example embodiments, the latency can be reduced by increasing the number of ADCs. For example, in VGG-16, the latency is determined by the first two convolutional layers. Since the first two layers only consume 4 arrays, as an example, various example embodiments may adopt two ADCs in each of these 4 arrays. Therefore, these arrays may compute two columns simultaneously, and the latency can then be reduced in half with minimal area increase. FIG. 13 shows a Table (Table 4) showing the area, peak power, and latency for various configurations of the VGG-16, according to various example embodiments of the present invention. As shown in Table 4, to minimize the latency of VGG-16, 32 ADCs may be adopted in the first two convolution layers, and in the subsequent layers, the number of TIAs and ADCs may be scaled. The minimum latency is 2.007 ms along with the area consumption of 127.916 mm². However, obtaining a minimal latency may not be practical according to various example embodiments. For example, increasing the number of ADCs in each synaptic memory array requires the input circuits to drive more devices, which results in a significant increase in peak power and area overhead. Therefore, according to various example embodiments, a trade-off between the area, peak power, and latency is evaluated and implemented. In this regard, FIGS. 14A and 14B depict plots showing trade-off between latency and area (FIG. 14A) and between latency and peak power (FIG. 14B) on the VGG-16, according to various example embodiments of the present invention. For example, as shown, the latency can be reduced to 16.056 ms (¼ of the embodiment in Table 3, i.e., not adding TIA and ADC overhead) by only increasing the area of 0.411 mm² (0.35%) and peak power of 0.055 W (7.41%).

Note that 1T1R SNN (Spiking Neural Network) array does not suffer from the current leaking column problem, because its input activation is only binary, and is controlled by the word-lines instead of feeding the specific activation voltages via the bit-lines. Therefore, all synaptic memory cells on the same memory cell column can share the same bit-line voltage and this voltage can be turned off (e.g., to 0V) when the column is non-selected (or unselected), and this will avoid the leaking of bit-line current. In general, SNN may be more effective at processing temporal-based inputs (e.g., videos, especially those produced by event-based vision sensor), whereas ANN may be more effective at inputs without a temporal aspect (such as an image).

For ANN analog computing, in various example embodiments, 1-bit (i.e., digital) input processing may be used, where n-bit input activations are processed over n cycles, 1-bit per cycle, and the partial sums from each cycle are accumulated using shift-and-add, either in digital domain (after ADC conversion), or in analog domain (Analog Shift-and-Add). Because each cycle of 1-bit input processing is similar to SNN processing, it can also avoid the current leaking column problem by using time-multiplexing, but at the expense of additional cycle time and energy. Compared to analog (i.e., DAC-based) input (whether in conventional or present architecture), digital input can use much simpler and smaller driver circuit with almost no energy overhead (i.e., nearly all the power/energy is delivered to the synaptic memory cells (or memristor cells)), but it will require n cycles for n-bit input activations. Note that this combination of digital input and time-multiplexing may be plausible based on state-of-art literature but is rarely seen in practice. In this regard, Table 3 in FIG. 12 shows an example of the energy spent per image by the digital input mode vs the conventional architecture and the present energy-efficient time-multiplexing architecture, whereby the present architecture is still the most efficient.

### Further Example Neural Processing Core Architectures

Big neural networks have a large number of synapses, and to support higher synaptic density so that the whole neural network can fit onto one chip, 3D scaling may be employed. In this regard, one approach is a 1TnR array architecture that was initially intended for 2D RRAM (or other memristor technology) scaling, but later adapted for 3D RRAM scaling. For example, because most semiconductor manufacturing process require high temperature when making the transistors, more transistors cannot be made on top of the bottom layer transistors, as high temperature would destroy the bottom layer transistors. The 1TnR array structure avoids this problem because RRAM fabrication typically does not require high temperature and thus would not destroy the bottom layer transistors (i.e., the 1T), and ‘n’ layers of RRAM would form the 1TnR array structure.

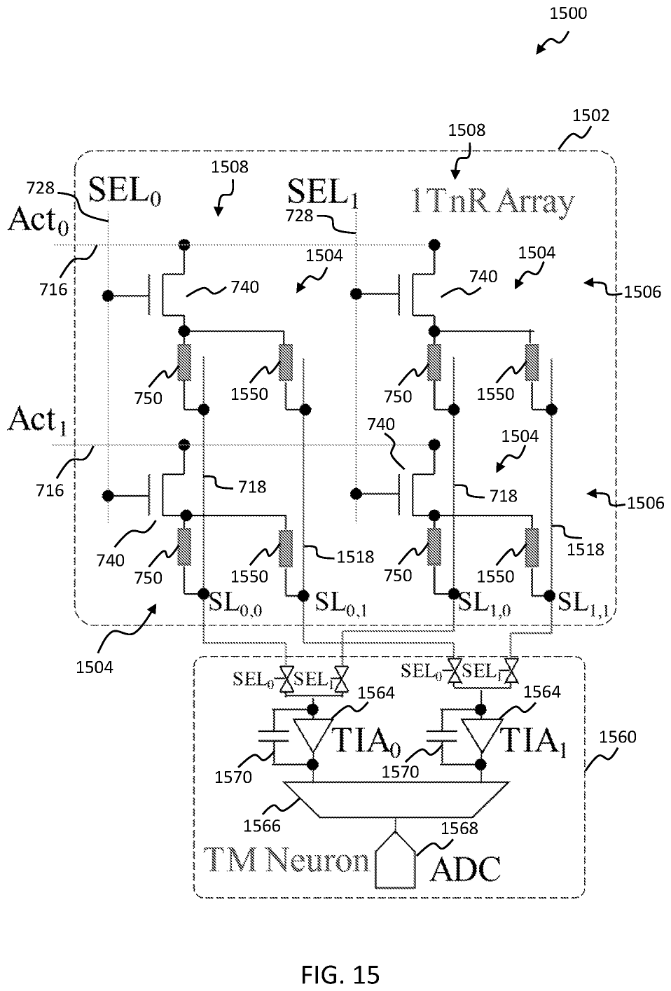

In various example embodiments, the energy-efficient time-multiplexing architecture is extended to 1TnR cell structure. FIG. 15 depicts a schematic drawing of an example neural processing core 1500 comprising a synaptic memory array 1502 having a 1TnR array architecture, according to various example embodiments of the present invention. It will be appreciated by a person skilled in the art that for simplicity and clarity, the 1TnR array structure is illustrated in FIG. 15 simply as having a dimension of 2×2. However, it will be appreciated by a person skilled in the art that the 1TnR array structure may have any dimension as desired or as appropriate. Accordingly, compared to the 1T1R array structure as described hereinbefore with reference to FIG. 7A, each synaptic memory cell 1504 further comprises one or more additional memristors and the neural processing core 1500 further comprises one or more additional sensing lines.

In particular, for each of the synaptic memory cells 1504 of the synaptic memory array 1502, the synaptic memory cell 1504 further comprises one or more additional memristors 1550 resulting in each memory cell column 1508 of the plurality of memory cell columns 1508 comprising a first memristor column of the first memristors 750 and one or more additional memristor columns of the additional memristors 1550 (only one additional memristor column shown in FIG. 15 for simplicity and clarity). For each memory cell column 1508 of the plurality of memory cell columns 1508, the first sensing line 718 associated with the memory cell column 1508 is connected to the first memristor column of the memory cell column 1508. In addition, the neural processing core 1500 further comprises one or more additional sensing lines 1518 connected to the one or more additional memristor columns of the additional memristors 1550, respectively, of the memory cell column 1508 (only one additional sensing line 1518 shown in FIG. 15 for simplicity and clarity) and configured to output one or more additional analog current signals, respectively, from the one or more additional memristor columns of the additional memristors 1550. Furthermore, for each of the synaptic memory cells 1504 of the synaptic memory array 1502, the first memristor 750 of the synaptic memory cell 1504 is connected to and between the access transistor 740 of the synaptic memory cell 1504 (to the source side of the access transistor 740) and the first sensing line 718 associated with the first memristor column of the memory cell column 1508 which the first memristor 750 belongs to, and the one or more additional memristors 1550 of the synaptic memory cell 1504 are each connected to and between the access transistor 740 of the synaptic memory cell 1504 (to the source side of the access transistor 740) and the additional sensing line 1518 associated with the additional memristor column which the additional memristor 1550 belongs to.

The neural processing core 1500 further comprises a peripheral sensing circuit 1560 comprises: a plurality of current-to-voltage converters (e.g., TIAs) 1564 (e.g., the number of current-to-voltage converters 1564 corresponds to the number of memristor columns in each memory cell column 1508), each current-to-voltage converter 1564 configured to convert analog current from the corresponding memristor column of each memory cell column 1508, in turn, to an analog voltage signal; an analog multiplexer 1566 configured to select one output amongst outputs of the plurality of current-to-voltage converters 1564 and forward the selected output; and an ADC 1568 connected to the analog multiplexer 1566 and configured to digitize the analog voltage signal from the selected output by the analog multiplexer 1566.

Various operations may be performed by the neural processing core 1500 comprising the synaptic memory array 1502 having the 1TnR array architecture, including inference operations and write operations (e.g., SET or RESET operations), in a similar or corresponding manner as described hereinbefore with respect to the neural processing core 700a comprising the synaptic memory array 702a having the 1T1R array architecture.

For example, in various example embodiments, compared with performing inference on the synaptic memory array 702a, for performing inference on the synaptic memory array 1502, the predetermined ground voltage (e.g., 0V or a virtual ground voltage) may also be applied to the one or more additional sensing lines 1518 connected to the one or more additional memristor columns of the additional memristors 1550, respectively, of the selected memory cell column 1508.

For example, in various example embodiments, compared with performing a write operation on a selected synaptic memory cell 704a of the synaptic memory array 702a, the write operation is on a selected memristor amongst the first memristor 750 and the one or more additional memristors 1550 of the selected synaptic memory cell 1504. In this regard, the predetermined ground voltage may be applied to a sensing line amongst the first sensing line 718 and the one or more additional sensing lines 1518 associated with the memristor column amongst the first memristor column and the one or more additional memristor columns which the selected memristor belongs to. Furthermore, a non-state changing voltage (i.e., any voltage that does not alter (or does not materially alter) the state of the memristor when applied) may be applied to each of one or more sensing lines amongst the first sensing line 718 and the one or more additional sensing lines 1518 associated with one or more memristor columns amongst the first memristor column and the one or more additional memristor columns which non-selected one or more memristors amongst the first memristor 750 and the one or more additional memristors 1550 belong to, or the above-mentioned each of one or more sensing lines and the one or more additional sensing lines 1518 may be floated.

In various example embodiments, because turning on the access transistor 740 in a 1TnR cell 1504 would allow current to flow in all ‘n’ memristors in the 1TnR cell 1504, ‘n’ number of TIAs are provided in the peripheral sensing circuit 1560 along with ‘n’ S&H (sample & hold) circuits 1570 to avoid leaking current, and subsequently the outputs from the ‘n’ S&H circuits 1570 may then be time-multiplexed and converted by the ADC 1568 (e.g., in the same or similar manner as described hereinbefore according to various example embodiments). For example, FIG. 15 illustrates the use of ‘n’ TIAs 1564, each having a capacitor configured around the TIA 1564 (i.e., coupled to the input and output of the TIA 1564) which functions as the S&H circuit 1570 for holding the output voltage of the TIA 1564. In various example embodiments, additional control circuits (e.g., transistors) (not shown) are provided to isolate the S&H capacitors 1570 from the associated TIA 1564 before turning off the associated memory cell column 1508 and the TIA 1564 so that the S&H values (e.g., in the form of capacitor charges) do not get cleared or distorted.

For the 1TnR array structure, according to various example embodiments, the memristors 750, 1550 are arranged to be located at the source side of the access transistor 740 because otherwise the ‘n’ memristors 750, 1550 would appear as one synapse instead of ‘n’ synapses due to sensing being at the source line 718, 1518.

In various example embodiments, the 1TnR array structure with time-multiplexing architecture as described herein according to various example embodiments is extended to combine the 2T2R array structure as described herein according to various example embodiments with the 1TnR array structure to form a 2T2nR array structure with time-multiplexing architecture according to various example embodiments of the present invention. For the 2T2nR array structure, the memristors are also arranged to be located at the source side of the access transistor.

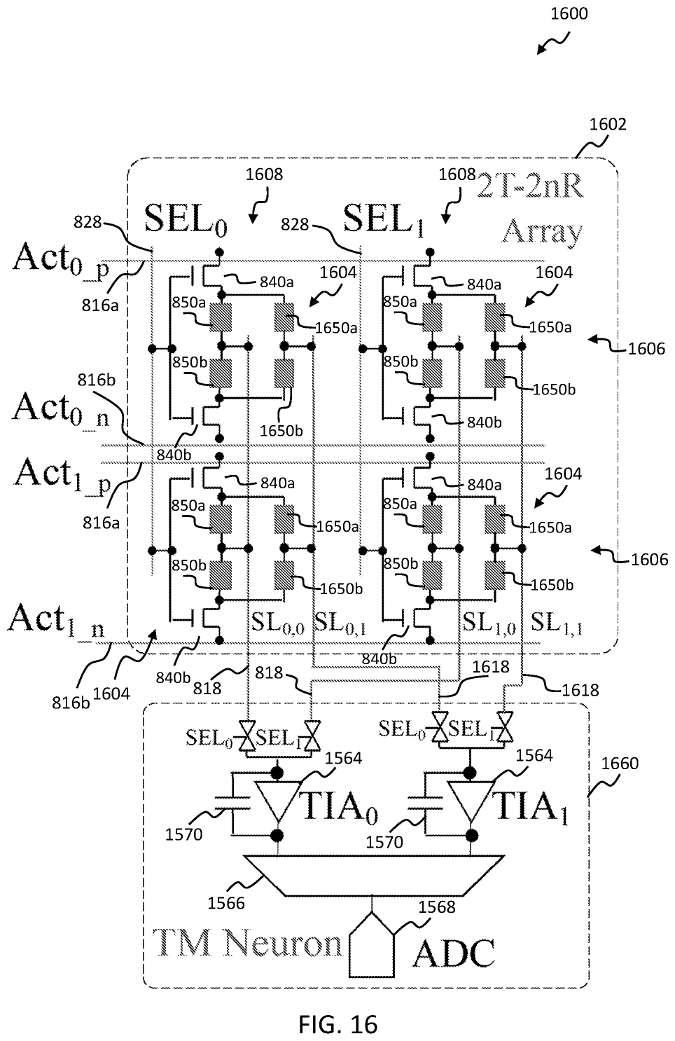

FIG. 16 depicts a schematic drawing of an example neural processing core 1600 comprising a synaptic memory array 1602 having the 2T2nR array architecture, according to various example embodiments of the present invention. It will be appreciated by a person skilled in the art that for simplicity and clarity, the 2T2nR array structure is illustrated in FIG. 16 simply as having a dimension of 2×2. However, it will be appreciated by a person skilled in the art that the 2T2nR array structure may have any dimension as desired or as appropriate. Accordingly, compared to the 2T2R array structure as described hereinbefore with reference to FIG. 8A, each synaptic memory cell 1604 further comprises one or more additional pairs of memristors and the neural processing core 1600 further comprises one or more additional sensing lines.

In particular, for each of the synaptic memory cells 1604 of the synaptic memory array 1602, the synaptic memory cell 1604 further comprises one or more additional pairs of additional memristors 1650a, 1650b (only one additional pair shown in FIG. 16 for simplicity and clarity), each additional pair of additional memristors 1650a, 1650b comprising a first additional memristor 1650a and a second additional memristor 1650b, resulting in each memory cell column 1608 of the plurality of memory cell columns 1608 comprising a first memristor column of the first pair of memristors 850a, 850b and one or more additional memristor columns of the additional pairs of additional memristors 1650a, 1650b (only one additional memristor column shown in FIG. 16 for simplicity and clarity). For each memory cell column 1608 of the plurality of memory cell columns 1608, the first sensing line 818 associated with the memory cell column 1608 is connected to the first memristor column of the first pair of memristors 850a, 850b of the memory cell column 1608. The neural processing core 1600 further comprises one or more additional sensing lines 1618 connected to the one or more additional memristor columns of the additional pairs of additional memristors 1650a, 1650b, respectively, of the memory cell column 308 (only one additional sensing line shown in FIG. 16 for simplicity and clarity) and configured to output one or more additional analog current signals, respectively, from the one or more additional memristor columns of the additional pairs of additional memristors 1650a, 1650b.

For each of the synaptic memory cells 1604 of the synaptic memory array 1602, the first memristor 850a of the first pair of memristors of the synaptic memory cell 1604 is connected to and between the first access transistor 840a of the synaptic memory cell 1604 (to the source side of the first access transistor 840a) and the first sensing line 818 associated with the first memristor column which the first pair of memristors 850a, 850b belongs to, and the second memristor 840b of the first pair of memristors of the synaptic memory cell 1604 is connected to and between the second access transistor 840b of the synaptic memory cell 1604 (to the source side of the second access transistor 840b) and the first sensing line 818 associated with the first memristor column which the first pair of memristors 850a, 850b belongs to. Similarly, for each of the synaptic memory cells 1604 of the synaptic memory array 1602 and for each additional pair of additional memristors 1650a, 1650b of the one or more additional pairs of additional memristors 1650a, 1650b of the synaptic memory cell 1604, the first additional memristor 1650a of the additional pair of additional memristors 1650a, 1650b of the synaptic memory cell 1604 is connected to and between the first access transistor 840a of the synaptic memory cell 1604 (to the source side of the first access transistor 840a) and the additional sensing line 1618 associated with the additional memristor column which the additional pair of additional memristors 1650a, 1650b belongs to, and the second additional memristor 1650b of the additional pair of additional memristors 1650a, 1650b of the synaptic memory cell 1604 is connected to and between the second access transistor 840b of the synaptic memory cell 1604 (to the source side of the second access transistor 840b) and the additional sensing line 1618 associated with the additional memristor column which the additional pair of additional memristors 1650a, 1650b belongs to.

It will be appreciated by a person skilled in the art that if the transistor type is changed, e.g., to p-channel, or the operating direction is changed, e.g., from source line sensing to bit-line (drain side) sensing, then the memristor location may also be changed accordingly or correspondingly, such as in a way that conforms to the sensing mechanism while also preserving the ‘n’ (or ‘2n’) memristors as ‘n’ (or ‘2n’) distinctive synapses. In other words, it will be appreciated by a person skilled in the art that the present invention is not limited to the particular type (e.g., n-type or p-type) of transistor.

Various operations may be performed by the neural processing core 1600 comprising the synaptic memory array 1602 having the 2T2nR array architecture, including inference operations and write operations (e.g., SET or RESET operations), in a similar or corresponding manner as described hereinbefore with respect to the neural processing core 800a comprising the synaptic memory array 802a having the 2T2R array architecture.

For example, in various example embodiments, compared with performing inference on the synaptic memory array 802a, for performing inference on the synaptic memory array 1602, the predetermined ground voltage (e.g., 0V or a virtual ground voltage) may also be applied to the one or more additional sensing lines 1618 connected to the one or more additional memristor columns of the additional pairs of additional memristors 1650a, 1650b, respectively, of the selected memory cell column 1608.

For example, in various example embodiments, compared with performing a write operation on a selected synaptic memory cell 804a of the synaptic memory array 802a, the write operation is on a selected pair of additional memristors amongst the first pair of memristors 850a, 850b and the one or more additional pairs of additional memristors 1650a, 1650b of the selected synaptic memory cell 1604. In this regard, the predetermined ground voltage may be applied to a sensing line amongst the first sensing line 818 and the one or more additional sensing lines 1618 associated with the memristor column amongst the first memristor column and the one or more additional memristor columns which the selected pair of memristors belongs to. In addition, a non-state changing voltage (i.e., any voltage that does not alter (or does not materially alter) the state of the memristor when applied) may be applied to each of one or more sensing lines amongst the first sensing line 818 and the one or more additional sensing lines 1618 associated with one or more memristor columns amongst the first memristor column and the one or more additional memristor columns which non-selected one or more pairs of memristors amongst the first pair of memristors 850a, 850b and the one or more additional pairs of additional memristors 1650a, 1650b belong to, or the above-mentioned each of one or more sensing lines and the one or more additional sensing lines 1618 may be floated.

Accordingly, in various example embodiments, when programming cells in the 1TnR or 2T2nR time-multiplexing architecture, similar programming methods as in 1T1R or 2T2R may be used, with a distinction that there may be provided ‘n’ independently controlled sensing lines (e.g., source lines) per column of 1TnR or 2T2nR cells for both the 1TnR structure and 2T2nR structure. Furthermore, for those memristor(s) not intended to be programmed, their corresponding sensing line(s) (e.g., source line(s)) is set to a voltage that does not induce unintended programming. For example, for the SET operation, the input activation line on selected memory cell row is applied with V_{prog}, and the non-selected source lines is set to be at either V_{prog} or floating. For the RESET operation, since the memristors inside the 1TnR or 2T2nR structure is sharing the same input activation voltage(s) which would be 0V, the selected source line(s) is set to V_{prog}, but non-selected source line(s) is set to either 0V or floating. Furthermore, for the RESET operation in the 2T2nR structure, the non-selected row's activation line is set to be at either V_{prog} or floating.

It will be appreciated by a person skilled in the art that 0V need not be the earth ground voltage, and that it can be any voltage that is meant to be the electrical ground suitable for the circuit in the intended application.

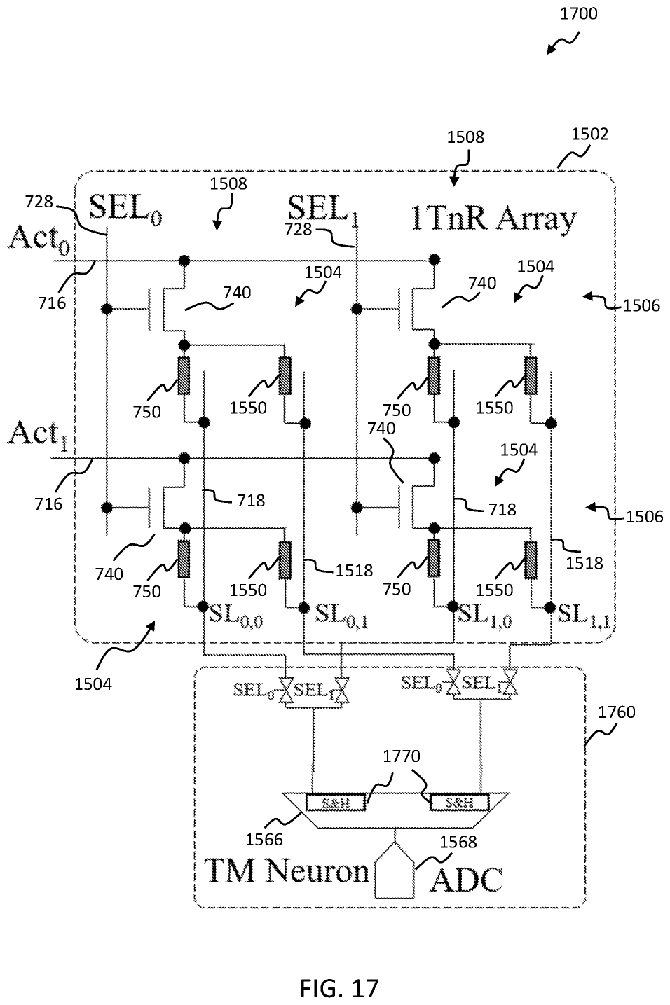

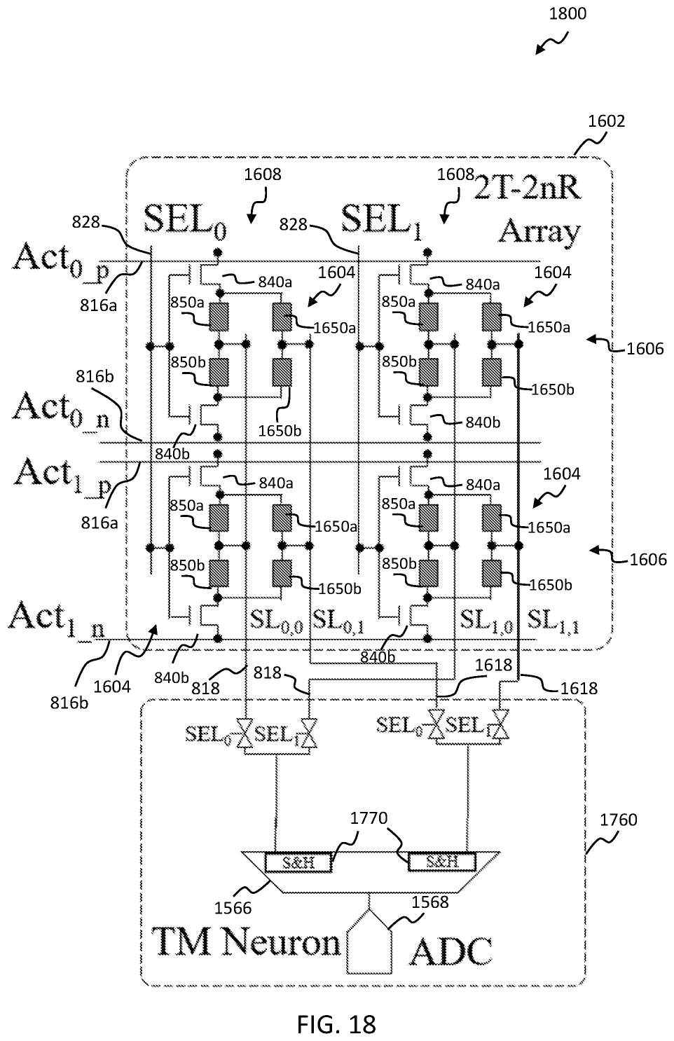

The example neural processing cores 1500 and 1600 shown in FIGS. 15 and 16, respectively, have been described above with respect to current mode sensing. As explained hereinbefore, the present invention is not limited to a specific type of sensing mode, and the neural processing core may operate, or be configured to operate, in current mode sensing or voltage mode sensing as desired or as appropriate. For example, FIGS. 17 and 18 depict schematic drawings of example neural processing cores 1700, 1800 comprising example peripheral sensing circuit 1760 configured for voltage mode sensing. Accordingly, the neural processing cores 1700, 1800 are the same as the neural processing cores 1500, 1600, respectively, except that the peripheral sensing circuit 1760 is configured to operate in voltage mode sensing. Accordingly, various components/modules/elements of the example neural processing cores 1700, 1800 are the same or similar as those described above for the example neural processing core 1500, 1600, respectively, and are denoted by the same reference numerals in FIGS. 17 and 18. Accordingly, the plurality of analog electrical signals from the plurality of memory cell columns 1508, 1608 are a plurality of analog voltage signals.

The peripheral sensing circuit 1760 is the same or similar as the peripheral sensing circuit 1560 shown in FIG. 15, except that the peripheral sensing circuit 1760 is without the plurality of current-to-voltage converters (e.g., TIAs) 1564. In particular, as shown in FIGS. 17 and 18, the peripheral sensing circuit 1760 comprises: an analog multiplexer 1566 configured to select one output (analog voltage signal) amongst outputs of the plurality of groups of memristor columns and forward the selected output (analog voltage signal); and an ADC 1568 connected to the analog multiplexer 1566 and configured to digitize the analog voltage signal from the selected output by the analog multiplexer 1566. In this regard, each group of memristor columns may comprise corresponding memristor columns in each memory cell column 1508/1608. In various example embodiments, the analog multiplexer 1566 may comprise, for each group of memristor columns, a respective sample and hold circuits (S&H) circuit 1770 for holding/buffering the output voltage from a currently selected memristor column. For example, a plurality of S&H circuits 1770 may be provided at a plurality of input ports, respectively, of the analog multiplexer 1566. For example, such buffering is advantageous because once a memristor column is selected, each memristor belonging to the selected memristor column will be drained. Therefore, in various example embodiments, parallel processing in 1 sensing cycle is performed and then buffer the outputs received and then disable that memristor column, as opposed to keeping the selected memristor column on for a plurality of sensing cycles.

Accordingly, with column-wise control for voltage mode sensing, the synaptic memory array structure may be kept the same as provided for current mode sensing. The neural processing core structure for voltage mode sensing may also be the same as that provided for the current sensing mode, except that the current-to-voltage converters (e.g., TIAs) are removed since the analog electrical signals from the memory cell columns are already analog voltage signals. Furthermore, it will be appreciated by a person skilled in the art that flash memory-based synaptic memory array with column-wise control may also employ voltage mode sensing.

In various example embodiments, there is provided a method of operating a memristive array for purpose of implementing a neural network, whereby:
said array corresponds to at least a portion of a given layer of said neural network,
each of some or all of the columns of said array corresponds to a neuron of said layer,
each of some or all of the memristive cells of said column corresponds to a synapse of said neuron, and the conductance of each said cell corresponds to at least one polarity component of the weight of said synapse, and
all said cells of said column are to be turned on by a common signal via common wiring to the gates of transistors of said cells.

In various example embodiments, during inference:
apply voltages to activation lines of said array, where said voltages correspond to input activations to said layer,
said columns are enumerated in a time-multiplexing manner, by turning on only the common signal(s) associated with the currently enumerated column(s),
feed the electrical signal of each said enumerated column via said column's sensing line (e.g., source line) to the time-multiplexing shared peripheral sensing circuit for digitization, and
the digitized value of said electrical signal is scaled as needed and then interpreted as said neuron's weighted sum (or partial weighted sum if said layer is larger than said array and requires multiple arrays to be implemented).

In the aforementioned method, in various example embodiments, said memristive cell is a 1T1R cell, with the following inference and programming steps:
during inference, maintain 0V at sensing line (e.g., source line) of each said enumerated column if said electrical signal is electrical current, or float the sensing line (e.g., source line) of each said enumerated column if said electrical signal is electrical voltage;
during SET programming, apply required high programming voltage(s) to the activation line(s) of selected row(s) and apply 0V or float the activation lines of non-selected rows, and apply 0V to the source line of selected column; and
during RESET programming, apply 0V to the activation line(s) of selected row(s) and apply either required high programming voltage(s) or float the activation lines of non-selected rows, and apply required high programming voltage to the source line of selected column.

In the aforementioned method, in various example embodiments, said memristive cell is a 2T2R cell with differential inputs and differential encoding of signed synaptic weight, with the following inference and programming steps:
during inference, maintain a virtual ground voltage at sensing line (e.g., source line) of each said enumerated column, and said voltages on said activation lines are to be referenced against said virtual ground instead of 0V if said electrical signal is electrical current, or float the sensing line (e.g., source line) of each said enumerated column if said electrical signal is electrical voltage;
during SET programing, apply required high programming voltage(s) to the activation line(s) of the selected polarity of selected row(s) and apply 0V or float the activation lines of non-selected rows or non-select polarity of selected rows, and apply 0V to the source line of selected column; and
during RESET programing, apply 0V to the activation line(s) of the selected polarity of selected row(s) and apply either required high programming voltage(s) or float the activation lines of non-selected rows or non-select polarity of selected rows, and apply required high programming voltage to the source line of selected column.

In the aforementioned method, in various example embodiments, said memristive cell is a 1TnR cell, with the following inference and programming steps:
during inference, maintain 0V at sensing line (e.g., source line) of each said enumerated column if said electrical signal is electrical current, or float the sensing line (e.g., source line) of each said enumerated column if said electrical signal is electrical voltage;
during SET programing, apply required high programming voltage(s) to the activation line(s) of selected row(s) and apply 0V or float the activation lines of non-selected rows, and apply 0V to the source line(s) which is/are on both selected column and selected memristor(s) within the said 1TnR cell, and apply either the said high programming voltage(s) to or float the source line(s) which is/are on selected column but is not on selected memristor(s) within the said 1TnR cell; and
during RESET programing, apply 0V to the activation line(s) of selected row(s) and apply either required high programming voltage(s) or float the activation lines of non-selected rows, and apply required high programming voltage(s) to the source line(s) which is/are on both selected column and selected memristor(s) within the said 1TnR cell, and apply either the said 0V to or float the source line(s) which is/are on selected column but is not on selected memristor(s) within the said 1TnR cell.

In the aforementioned method, in various example embodiments, said memristive cell is a 2T2nR cell with differential inputs and differential encoding of signed synaptic weight, with the following inference and programming steps:
during inference, maintain a virtual ground voltage at sensing line (e.g., source line) of each said enumerated column, and said voltages on said activation lines are to be referenced against said virtual ground instead of 0V if said electrical signal is electrical current, or float the sensing line (e.g., source line) of each said enumerated column if said electrical signal is electrical voltage;
during SET programing, apply required high programming voltage(s) to the activation line(s) of the selected polarity of selected row(s) and apply 0V or float the activation lines of non-selected rows or non-select polarity of selected rows, and apply 0V to the source line(s) which is/are on both selected column and selected memristor(s) within the said 2T2nR cell, and apply either the said high programming voltage(s) to or float the source line(s) which is/are on selected column but is not on selected memristor(s) within the said 2T2nR cell; and
during RESET programing, apply 0V to the activation line(s) of the selected polarity of selected row(s) and apply either required high programming voltage(s) or float the activation lines of non-selected rows or non-select polarity of selected rows, and apply required high programming voltage(s) to the source line(s) which is/are on selected column and selected memristor(s) within the said 2T2nR cell, and apply either 0V to or float the source line(s) which is/are on selected column but is not on selected memristor(s) within the said 2T2nR cell.

In various example embodiments, said virtual ground voltage is V_{dd}/2, where V_{dd} is the core transistor supply voltage.

In various example embodiments, two arrays are used in a differential notation to encode signed synaptic weight.

In various example embodiments, during programming, when verifying the actual written state of a cell, float the activation lines of non-selected rows.

In various example embodiments, said memristive cell is a 1TnR or 2T2nR cell, during inference, ‘n’ TIAs and ‘n’ Sample & Hold circuits are used to sense the ‘n’ or ‘n’ pairs of memristors and hold the analog outputs simultaneously to avoid leaking current during time-multiplexing.

Accordingly, various example embodiments of the present invention advantageously provide an energy-efficient time-multiplexing memristive analog computing architecture, which can save on both chip area as well as avoid wasting energy on non-selected memory cell columns, making it well-suited to, but not limited to, edge intelligence applications. The energy-efficient time-multiplexing analog computing architecture comprises as building blocks a synaptic memory array (e.g., memristive array) whose on/off cell control signal is arranged in a column-wise manner, such that the array's cells are turned on or off on a column-by-column basis, instead of the row-by-row basis as in conventional analog computing architecture. In various example embodiments, the “on/off” control mechanism of a cell is an access transistor (which may also be referred to as a select transistor), which is employed to form various cell architectures, such as but not limited to, a 1T1R cell, 2T2R cell, 1TnR cell, 2T2nR cell, and so on. For example, the gate terminals of a memory cell column can be wired together and controlled by a column-wise voltage-based control signal. For example, the access transistor may be an n-channel transistor (e.g., nMOSFET), but other types of access transistor may also be employed, such as p-channel transistor, and use the appropriate voltages for on/off control for the relevant transistor type. Each column may then be turned on sequentially, and in various example embodiments, only one column (or a predetermined number of columns) may remain on during the course of enumerating all memory cell columns of the synaptic memory array. Various neural network operations configured to be compatible with a number of column-wise array structures/architectures according to various example embodiments have also be described herein.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

1. A neural processing core for a neural network, the neural processing core comprising:
a synaptic memory array comprising synaptic memory cells arranged in a plurality of memory cell rows and columns;
a plurality of first input activation lines connected to the plurality of memory cell rows, respectively, of the synaptic memory array and configured to receive a plurality of first input activation signals, respectively, to the plurality of memory cell rows; and
a plurality of first sensing lines connected to the plurality of memory cell columns, respectively, of the synaptic memory array and configured to output a plurality of first analog electrical signals, respectively, from the plurality of memory cell columns,
wherein the neural processing core is configured to control the synaptic memory cells of the synaptic memory array in a column-wise manner.

2. The neural processing core according to claim 1, further comprising a plurality of control lines connected to the plurality of memory cell columns, respectively, of the synaptic memory array,
wherein for each of the plurality of memory cell columns, the synaptic memory cells of the memory cell column are each connected to the control line of the plurality of control lines associated with the memory cell column and the control line is configured to receive a column-wise control signal for the memory cell column for controlling the synaptic memory cells of the memory cell column in the column-wise manner.

3. The neural processing core according to claim 2, wherein each of the synaptic memory cells of the synaptic memory array comprises a first access transistor, wherein a gate of the first access transistor of the synaptic memory cell is connected to the control line associated with the memory cell column which the synaptic memory cell belongs to for receiving the column-wise control signal for the memory cell column for controlling an operating state of the first access transistor of the synaptic memory cell.

4. The neural processing core according to claim 3, wherein
for each of the plurality of memory cell rows, the synaptic memory cells of the memory cell row are each connected to the first input activation line associated with the memory cell row and the first input activation line is configured to receive the first input activation signal for the synaptic memory cells of the memory cell row in a row-wise manner,
for each of the plurality of memory cell columns, the synaptic memory cells of the memory cell column are each connected to the first sensing line associated with the memory cell column, and
for each of the synaptic memory cells of the synaptic memory array, the synaptic memory cell further comprises a first memristor connected to and between the first access transistor of the synaptic memory cell and the first sensing line associated with the memory cell column which the synaptic memory cell belongs to or the first input activation line associated with the memory cell row which the synaptic memory cell belongs to.

5. The neural processing core according to claim 4, wherein
for each of the synaptic memory cells of the synaptic memory array, the synaptic memory cell further comprises one or more additional memristors resulting in each memory cell column of the plurality of memory cell columns comprising a first memristor column of the first memristors and one or more additional memristor columns of the additional memristors,
for each memory cell column of the plurality of memory cell columns, the first sensing line associated with the memory cell column is connected to the first memristor column of the memory cell column and the neural processing core further comprises one or more additional sensing lines connected to the one or more additional memristor columns of the additional memristors, respectively, of the memory cell column and configured to output one or more additional analog electrical signals, respectively, from the one or more additional memristor columns of the additional memristors, and
for each of the synaptic memory cells of the synaptic memory array, the first memristor of the synaptic memory cell is connected to and between the first access transistor of the synaptic memory cell and the first sensing line associated with the first memristor column of the memory cell column which the first memristor belongs to, and the one or more additional memristors of the synaptic memory cell are each connected to and between the first access transistor of the synaptic memory cell and the additional sensing line associated with the additional memristor column which the additional memristor belongs to.

6. The neural processing core according to claim 4, further comprising:
a plurality of second input activation lines connected to the plurality of memory cell rows, respectively, of the synaptic memory array and configured to receive a plurality of second input activation signals, respectively, to the plurality of memory cell rows, wherein
for each of the plurality of memory cell rows, the synaptic memory cells of the memory cell row are each connected to the second input activation line associated with the memory cell row,
for each of the synaptic memory cells of the synaptic memory array, the synaptic memory cell further comprises a second access transistor and a second memristor, the first memristor and the second memristor forming a first pair of memristors of the synaptic memory cell,
a gate of the second access transistor of the synaptic memory cell is connected to the control line associated with the memory cell column which the synaptic memory cell belongs to for receiving the column-wise control signal for the memory cell column for controlling an operating state of the second access transistor,
the first memristor of the synaptic memory cell is connected to and between the first access transistor of the synaptic memory cell and the first input activation line associated with the memory cell row which the synaptic memory cell belongs to or the first sensing line associated with the memory cell column which the synaptic memory cell belongs to, and
the second memristor of the synaptic memory cell is connected to and between the second access transistor of the synaptic memory cell and the second input activation line associated with the memory cell row which the synaptic memory cell belongs to or the first sensing line associated with the memory cell column which the synaptic memory cell belongs to.

7. The neural processing core according to claim 6, wherein
for each of the synaptic memory cells of the synaptic memory array, the synaptic memory cell further comprises one or more additional pairs of additional memristors, each additional pair of additional memristors comprising a first additional memristor and a second additional memristor, resulting in each memory cell column of the plurality of memory cell columns comprising a first memristor column of the first pair of memristors and one or more additional memristor columns of the additional pairs of additional memristors,
for each memory cell column of the plurality of memory cell columns, the first sensing line associated with the memory cell column is connected to the first memristor column of the first pair of memristors of the memory cell column and the neural processing core further comprises one or more additional sensing lines connected to the one or more additional memristor columns of the additional pairs of additional memristors, respectively, of the memory cell column and configured to output one or more additional analog electrical signals, respectively, from the one or more additional memristor columns of the additional pairs of additional memristors,
for each of the synaptic memory cells of the synaptic memory array, the first memristor of the first pair of memristors of the synaptic memory cell is connected to and between the first access transistor of the synaptic memory cell and the first sensing line associated with the first memristor column which the first pair of memristors belongs to and the second memristor of the first pair of memristors of the synaptic memory cell is connected to and between the second access transistor of the synaptic memory cell and the first sensing line associated with the first memristor column which the first pair of memristors belongs to, and
for each of the synaptic memory cells of the synaptic memory array and for each additional pair of additional memristors of the one or more additional pairs of additional memristors of the synaptic memory cell, the first additional memristor of the additional pair of additional memristors of the synaptic memory cell is connected to and between the first access transistor of the synaptic memory cell and the additional sensing line associated with the additional memristor column which the additional pair of additional memristors belongs to and the second additional memristor of the additional pair of additional memristors of the synaptic memory cell is connected to and between the second access transistor of the synaptic memory cell and the additional sensing line associated with the additional memristor column which the additional pair of additional memristors belongs to.

8. The neural processing core according to claim 3, wherein
for each of the plurality of memory cell rows, the synaptic memory cells of the memory cell row are each connected to the first input activation line associated with the memory cell row and the first input activation line is configured to receive the first input activation signal for the synaptic memory cells of the memory cell row in a row-wise manner,
for each of the plurality of memory cell columns, the synaptic memory cells of the memory cell column are each connected to the first sensing line associated with the memory cell column, and
for each of the synaptic memory cells of the synaptic memory array, the gate of the first access transistor of the synaptic memory cell connected to the control line is a control gate and the first access transistor further comprises a floating gate, wherein a source of the first access transistor is connected to the first sensing line associated with the memory cell column which the synaptic memory cell belongs to and a drain of the first access transistor is connected to the first input activation line associated with the memory cell row which the synaptic memory cell belongs to.

9. The neural processing core according to claim 4, wherein the neural processing core further comprises a peripheral sensing circuit connected to the plurality of first sensing lines and configured to process the plurality of first analog electrical signals from the plurality of memory cell columns, respectively, based on time multiplexing.

10. The neural processing core according to claim 9, wherein the peripheral sensing circuit configured to process the plurality of first analog electrical signals based on time multiplexing comprises processing the plurality of first analog electrical signals from the plurality of memory cell columns, respectively, in turn.

11. The neural processing core according to claim 9, wherein the plurality of first analog electrical signals from the plurality of memory cell columns are a plurality of first analog current signals and the peripheral sensing circuit comprises:
a current-to-voltage converter configured to convert each of the plurality of first analog currents from the plurality of memory cell columns, in turn, to a first analog voltage signal; and
an analog-to-digital converter (ADC) connected to the current-to-voltage converter and configured to digitize the first analog voltage signal received from the current-to-voltage converter,
wherein the current-to-voltage converter and the ADC are each shared amongst the plurality of memory cell columns for processing the plurality of first analog current signals from the plurality of memory cell columns.

12. The neural processing core according to claim 9, wherein the plurality of first analog electrical signals from the plurality of memory cell columns are a plurality of first analog current signals and the peripheral sensing circuit comprises:
a plurality of current-to-voltage converters, each current-to-voltage converter configured to convert each first analog current from a corresponding group of memory cell columns of the plurality of memory cell columns, in turn, to a first analog voltage signal associated with the corresponding group of memory cell columns;
an analog multiplexer configured to select one output amongst outputs of the plurality of current-to-voltage converters and forward the selected output; and
an ADC connected to the analog multiplexer and configured to digitize the first analog voltage signal from the selected output by the analog multiplexer,
wherein each of the plurality of current-to-voltage converters is shared amongst the corresponding group of memory cell columns for processing the first analog current signals from the corresponding group of memory cell columns, and the ADC is shared amongst the plurality of memory cell columns.

13. The neural processing core according to claim 11, wherein the neural processing core is configured to control the current-to-voltage converter which produced the selected output to continue to operate past a column time-multiplexing cycle period based on the ADC taking longer than the column time-multiplexing cycle period to latch-in the first analog voltage signal from the selected output.

14. The neural processing core according to claim 9, wherein the plurality of first analog electrical signals from the plurality of memory cell columns are a plurality of first analog voltage signals and the peripheral sensing circuit comprises:
an analog-to-digital converter (ADC) configured to digitize each of the plurality of first analog voltage signals from the plurality of memory cell columns, in turn,
wherein the ADC is shared amongst the plurality of memory cell columns for processing the plurality of first analog voltage signals from the plurality of memory cell columns.

15. A method of operating a neural processing core for a neural network, the neural processing core comprising:
a synaptic memory array comprising synaptic memory cells arranged in a plurality of memory cell rows and columns;
a plurality of first input activation lines connected to the plurality of memory cell rows, respectively, of the synaptic memory array and configured to receive a plurality of first input activation signals, respectively, to the plurality of memory cell rows; and
a plurality of first sensing lines connected to the plurality of memory cell columns, respectively, of the synaptic memory array and configured to output a plurality of first analog electrical signals, respectively, from the plurality of memory cell columns, wherein
the neural processing core is configured to control the synaptic memory cells of the synaptic memory array in a column-wise manner, and
for each of the plurality of memory cell columns, the synaptic memory cells of the memory cell column are each connected to a control line associated with the memory cell column and the control line is configured to receive a column-wise control signal for the memory cell column for controlling the synaptic memory cells of the memory cell column in the column-wise manner, and
for performing inference on the synaptic memory array, the method comprises:
sending, for each of the plurality of memory cell columns and in turn, a column-wise control signal to the control line associated with the memory cell column for selecting the memory cell column for inference and controlling the synaptic memory cells of the memory cell column in the column-wise manner.

16. The method according to claim 15, wherein
each of the synaptic memory cells of the synaptic memory array comprises a first access transistor, wherein a gate of the first access transistor of the synaptic memory cell is connected to the control line associated with the memory cell column which the synaptic memory cell belongs to for receiving the column-wise control signal for the memory cell column for controlling an operating state of the first access transistor of the synaptic memory cell, and
said sending the column-wise control signal to the control line associated with the selected memory cell column comprises controlling the operating state of the first access transistor of each synaptic memory cell of the selected memory cell column in the column-wise manner based on the column-wise control signal.

17. The method according to claim 16, wherein
for each of the plurality of memory cell rows, the synaptic memory cells of the memory cell row are each connected to the first input activation line associated with the memory cell row and the first input activation line is configured to receive the first input activation signal for the synaptic memory cells of the memory cell row in a row-wise manner,
for each of the plurality of memory cell columns, the synaptic memory cells of the memory cell column are each connected to the first sensing line associated with the memory cell column,
for each of the synaptic memory cells of the synaptic memory array, the synaptic memory cell further comprises a first memristor connected to and between the first access transistor of the synaptic memory cell and the first sensing line associated with the memory cell column which the synaptic memory cell belongs to or the first input activation line associated with the memory cell row which the synaptic memory cell belongs to,
for said performing inference on the synaptic memory array, the method further comprises:
applying a predetermined ground voltage to the first sensing line connected to the selected memory cell column; and
sending a plurality of first input activation signals to the plurality of input activation lines associated with the plurality of memory cell rows, respectively, and
for performing a write operation on a selected synaptic memory cell of the synaptic memory array, the method further comprises:
sending a column-wise control signal to the control line associated with the memory cell column which the selected synaptic memory cell belongs to;
applying a predetermined ground voltage to the first sensing line associated with the memory cell column which the selected synaptic memory cell belongs to; and
sending a first programming signal as the first input activation signal to the first input activation line associated with the memory cell row which the selected synaptic memory cell belongs to.

18. The method according to claim 17, wherein
for each of the synaptic memory cells of the synaptic memory array, the synaptic memory cell further comprises one or more additional memristors resulting in each memory cell column of the plurality of memory cell columns comprising a first memristor column of the first memristors and one or more additional memristor columns of the additional memristors,
for each memory cell column of the plurality of memory cell columns, the first sensing line associated with the memory cell column is connected to the first memristor column of the memory cell column and the neural processing core further comprises one or more additional sensing lines connected to the one or more additional memristor columns of the additional memristors, respectively, of the memory cell column and configured to output one or more additional analog electrical signals, respectively, from the one or more additional memristor columns of the additional memristors,
for each of the synaptic memory cells of the synaptic memory array, the first memristor of the synaptic memory cell is connected to and between the first access transistor of the synaptic memory cell and the first sensing line associated with the first memristor column of the memory cell column which the first memristor belongs to, and the one or more additional memristors of the synaptic memory cell are each connected to and between the first access transistor of the synaptic memory cell and the additional sensing line associated with the additional memristor column which the additional memristor belongs to,
for said performing inference on the synaptic memory array, the method further comprises:
applying the predetermined ground voltage to the one or more additional sensing lines connected to the one or more additional memristor columns of the additional memristors, respectively, of the selected memory cell column, and
for said performing a write operation on a selected synaptic memory cell of the synaptic memory array, the write operation is on a selected memristor amongst the first memristor and the one or more additional memristors of the selected synaptic memory cell,
said applying a predetermined ground voltage is applying the predetermined ground voltage to a sensing line amongst the first sensing line and the one or more additional sensing lines associated with the memristor column amongst the first memristor column and the one or more additional memristor columns which the selected memristor belongs to, and
the method further comprises applying a non-state changing voltage or floating each of one or more sensing lines amongst the first sensing line and the one or more additional sensing lines associated with one or more memristor columns amongst the first memristor column and the one or more additional memristor columns which non-selected one or more memristors amongst the first memristor and the one or more additional memristors belong to.

19. The method according to claim 17, wherein the neural processing core further comprises:
a plurality of second input activation lines connected to the plurality of memory cell rows, respectively, of the synaptic memory array and configured to receive a plurality of second input activation signals, respectively, to the plurality of memory cell rows, wherein
for each of the plurality of memory cell rows, the synaptic memory cells of the memory cell row are each connected to the second input activation line associated with the memory cell row,
for each of the synaptic memory cells of the synaptic memory array, the synaptic memory cell further comprises a second access transistor and a second memristor, the first memristor and the second memristor forming a first pair of memristors of the synaptic memory cell,
a gate of the second access transistor of the synaptic memory cell is connected to the control line associated with the memory cell column which the synaptic memory cell belongs to for receiving the column-wise control signal for the memory cell column for controlling an operating state of the second access transistor,
the first memristor of the synaptic memory cell is connected to and between the first access transistor of the synaptic memory cell and the first input activation line associated with the memory cell row which the synaptic memory cell belongs to or the first sensing line associated with the memory cell column which the synaptic memory cell belongs to,
the second memristor of the synaptic memory cell is connected to and between the second access transistor of the synaptic memory cell and the second input activation line associated with the memory cell row which the synaptic memory cell belongs to or the first sensing line associated with the memory cell column which the synaptic memory cell belongs to,
for said performing inference on the synaptic memory array, the method further comprises:
sending a plurality of second input activation signals to the plurality of second input activation lines associated with the plurality of memory cell rows, respectively, and
for said performing a write operation on a selected synaptic memory cell of the synaptic memory array, the method further comprises:
sending a second programming signal as the second input activation signal to the second input activation line associated with the memory cell row which the selected synaptic memory cell belongs to,
wherein one of the first and second programming signals is a programming signal for setting a conductance state of the corresponding memristor of the first and second memristors of the selected synaptic memory cell and the other one of the first and second programming signals is the predetermined ground voltage or no signal with the corresponding one of the first and second input activation lines floated, based on a polarity of a synaptic weight value to be stored by the selected synaptic memory cell.

20. The method according to claim 19, wherein
for each of the synaptic memory cells of the synaptic memory array, the synaptic memory cell further comprises one or more additional pairs of additional memristors, each additional pair of additional memristors comprising a first additional memristor and a second additional memristor, resulting in each memory cell column of the plurality of memory cell columns comprising a first memristor column of the first pair of memristors and one or more additional memristor columns of the additional pairs of additional memristors,
for each memory cell column of the plurality of memory cell columns, the first sensing line associated with the memory cell column is connected to the first memristor column of the first pair of memristors of the memory cell column and the neural processing core further comprises one or more additional sensing lines connected to the one or more additional memristor columns of the additional pairs of additional memristors, respectively, of the memory cell column and configured to output one or more additional analog electrical signals, respectively, from the one or more additional memristor columns of the additional pairs of additional memristors,
for each of the synaptic memory cells of the synaptic memory array, the first memristor of the first pair of memristors of the synaptic memory cell is connected to and between the first access transistor of the synaptic memory cell and the first sensing line associated with the first memristor column which the first pair of memristors belongs to and the second memristor of the first pair of memristors of the synaptic memory cell is connected to and between the second access transistor of the synaptic memory cell and the first sensing line associated with the first memristor column which the first pair of memristors belongs to,
for each of the synaptic memory cells of the synaptic memory array and for each additional pair of additional memristors of the one or more additional pairs of additional memristors of the synaptic memory cell, the first additional memristor of the additional pair of additional memristors of the synaptic memory cell is connected to and between the first access transistor of the synaptic memory cell and the additional sensing line associated with the additional memristor column which the additional pair of additional memristors belongs to and the second additional memristor of the additional pair of additional memristors of the synaptic memory cell is connected to and between the second access transistor of the synaptic memory cell and the additional sensing line associated with the additional memristor column which the additional pair of additional memristors belongs to,
for said performing inference on the synaptic memory array, the method further comprises:
applying the predetermined ground voltage to the one or more additional sensing lines connected to the one or more additional memristor columns of the additional pairs of additional memristors, respectively, of the selected memory cell column, and
for said performing a write operation on a selected synaptic memory cell of the synaptic memory array, the write operation is on a selected pair of memristors amongst the first pair of memristors and the one or more additional pairs of additional memristors of the selected synaptic memory cell,
said applying a predetermined ground voltage is applying the predetermined ground voltage to a sensing line amongst the first sensing line and the one or more additional sensing lines associated with the memristor column amongst the first memristor column and the one or more additional memristor columns which the selected pair of memristors belongs to, and
the method further comprises applying a non-state changing voltage to or float each of one or more sensing lines amongst the first sensing line and the one or more additional sensing lines associated with one or more memristor columns amongst the first memristor column and the one or more additional memristor columns which non-selected one or more pairs of memristors amongst the first pair of memristors and the one or more additional pairs of additional memristors belong to.

21. The method according to claim 16, wherein
for each of the plurality of memory cell rows, the synaptic memory cells of the memory cell row are each connected to the first input activation line associated with the memory cell row and the first input activation line is configured to receive the first input activation signal for the synaptic memory cells of the memory cell row in a row-wise manner,
for each of the plurality of memory cell columns, the synaptic memory cells of the memory cell column are each connected to the first sensing line associated with the memory cell column,
for each of the synaptic memory cells of the synaptic memory array, the synaptic memory cell further comprises a first memristor connected to and between the first access transistor of the synaptic memory cell and the first sensing line associated with the memory cell column which the synaptic memory cell belongs to or the first input activation line associated with the memory cell row which the synaptic memory cell belongs to,
for said performing inference on the synaptic memory array, the method further comprises:
floating the first sensing line connected to the selected memory cell column; and
sending a plurality of first input activation signals to the plurality of input activation lines associated with the plurality of memory cell rows, respectively, and
for performing a write operation on a selected synaptic memory cell of the synaptic memory array, the method further comprises:
sending a column-wise control signal to the control line associated with the memory cell column which the selected synaptic memory cell belongs to;
applying a predetermined ground voltage to the first sensing line associated with the memory cell column which the selected synaptic memory cell belongs to; and
sending a first programming signal as the first input activation signal to the first input activation line associated with the memory cell row which the selected synaptic memory cell belongs to.

22. The method according to claim 17, wherein
the neural processing core further comprises a peripheral sensing circuit connected to the plurality of first sensing lines and configured to process the plurality of first analog electrical signals from the plurality of memory cell columns, respectively, based on time multiplexing, and
for said performing inference on the synaptic memory array, the method further comprises processing, using the peripheral sensing circuit, the plurality of first analog electrical signals from the plurality of memory cell columns, respectively, based on time multiplexing.

23. The method according to claim 22, wherein
the plurality of first analog electrical signals from the plurality of memory cell columns are a plurality of first analog current signals,
the peripheral sensing circuit comprises:
a current-to-voltage converter configured to convert each of the plurality of first analog currents from the plurality of memory cell columns, in turn, to a first analog voltage signal; and
an analog-to-digital converter (ADC) connected to the current-to-voltage converter and configured to digitize the first analog voltage signal received from the current-to-voltage converter,
wherein the current-to-voltage converter and the ADC are each shared amongst the plurality of memory cell columns for processing the plurality of first analog current signals from the plurality of memory cell columns, respectively, and
for said performing inference on the synaptic memory array, the method further comprises:
converting, using the current-to-voltage converter, each of the plurality of first analog currents from the plurality of memory cell columns, in turn, to a first analog voltage signal; and
digitizing, using the ADC, the first analog voltage signal received from the current-to-voltage converter.

24. The method according to claim 21, wherein
the neural processing core further comprises a peripheral sensing circuit connected to the plurality of first sensing lines and configured to process the plurality of first analog electrical signals from the plurality of memory cell columns, respectively, based on time multiplexing,
the plurality of first analog electrical signals from the plurality of memory cell columns are a plurality of first analog voltage signals,
the peripheral sensing circuit comprises:
an analog-to-digital converter (ADC) configured to digitize each of the plurality of first analog voltage signals from the plurality of memory cell columns, in turn,
wherein the ADC is shared amongst the plurality of memory cell columns for processing the plurality of first analog voltage signals from the plurality of memory cell columns, and
for said performing inference on the synaptic memory array, the method further comprises:
digitizing, using the ADC, each of the plurality of first analog voltage signals from the plurality of memory cell columns, in turn.
